(19) United States
(12) Patent Application Publication
(10) Pub. No.: US 2005/0088376 A1
(43) Pub. Date: Apr. 28, 2005

(54) Capacitive load driver and plasma display

(75) Inventors: Manabu Inoue, Uji-shi (JP); Koji Yoshida, Ikoma-shi (JP); Satoshi Ikeda, Suita-shi (JP); Yasuhiro Arai, Hirakata-shi (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Osaka (JP)

(21) Appl. No.: 10/973,020

(22) Filed: Oct. 25, 2004

(30) Foreign Application Priority Data
Oct. 28, 2003 (JP) 2003-367794
Dec. 9, 2003 (JP) 2003-410853
Dec. 9, 2003 (JP) 2003-410854

(51) Int. Cl. G09G 3/28; G09G 5/00

(52) U.S. Cl. 345/60

(57) ABSTRACT

Sustain electrodes (X1, X2, . . . ) of a PDP (20) are grounded. A PFC converter (40) converts an alternating voltage into a DC voltage (Vs) and applies it directly across a PDP driver (10). A sustaining pulse generating section (1) converts the DC voltage (Vs) into a primary voltage pulse (VF), and applies it across a primary winding (2a) of a transformer (2). The transformer (2) converts the primary voltage pulse (VF) into a sustaining voltage pulse (Vp), and applies it to scan electrodes (Y1, Y2, . . . ) of the PDP (20) through a reset/scanning pulse generating section (3). An inductor (L) is connected in parallel with a secondary winding (2b) of the transformer (2). The inductor (L) resonates with the panel capacitance of the PDP (20) at the rising and falling edges of the sustain voltage pulse (Vp).

### BACKGROUND OF THE INVENTION

The present invention relates to a driver for a capacitive load such as a plasma display panel (PDP).

A plasma display is a display device that uses a luminous phenomenon caused by gas electric discharge. A plasma display panel (PDP) has advantages in upsizing the screen, slimming down, and widening the viewing angle over other display devices. PDPs are broadly classified into two types; a DC type which works by DC pulses, and an AC type which works by AC pulses. The AC-type PDPs has, in particular, a higher brightness and a simpler structure. Accordingly, the AC-type PDPs are suitable for mass production and increase in pixel density, thereby coming into extensive use.

FIG. 42 is a block diagram that shows a configuration of a conventional plasma display. See for example, Published Japanese patent application Hei 5-191977 gazette, U.S. Pat. No. 4,866,349, and Published Japanese patent application Hei 11-344952 gazette. The conventional plasma display comprises a PDP 20, a power-factor correction (PFC) converter 40, a PDP driver 100, and a control section 30.

The PDP 20 is, for example, an AC type, and has a three-electrode, surface-discharge structure (coplanar structure). Address electrodes A1, A2, A3, . . . , are arranged on the rear substrate of the PDP 20 in the vertical direction of the panel. Sustain electrodes X1, X2, X3, . . . , and scan electrodes Y1, Y2, Y3, . . . , are alternately arranged on the front substrate of the PDP 20 in the horizontal direction of the panel. The sustain electrodes X1, X2, X3, . . . , are connected to each other, thereby held at substantially equal potentials. The address electrodes A1, A2, A3, . . . and the scan electrodes Y1, Y2, Y3, . . . each allow the separate potential changes. A discharge cell is installed at the intersection P (the hatched area shown in FIG. 42) of a pair of a sustain electrode and a scan electrode adjacent to each other (for example, the pair of a sustain electrode X2 and a scan electrode Y2) and an address electrode (for example, A2). The surface of the discharge cell include a layer (dielectric layer) made of a dielectric material, a layer (protection layer) to protect the electrode and the dielectric layer, and a layer (phosphor layer) that includes a phosphor. Gas fills the inside of the discharge cell. Electric discharge occurs in the discharge cell when pulses of predetermined voltages are applied to the sustain, scan, and address electrodes. Then, gas molecules in the discharge cell are ionized, and thereby, ultraviolet rays are emitted. The ultraviolet rays excite the phosphors on the surface of the discharge cell and make them emit fluorescence. Thus, the discharge cell emits visible light.

The PFC converter 40 converts AC power from an external, commercial AC power supply AC into DC power. The PFC converter 40 then holds its power factor substantially equal to 1 for the input from the commercial AC power supply AC.

The PDP driver 100 includes a DC-DC converter 101, a sustain electrode driver section 102, a scan electrode driver section 103, and an address electrode driver section 104.

The DC-DC converter 101 converts the output voltage of the PFC converter 40 into a predetermined DC voltage Vc, and maintains the DC voltage Vc constant. The DC-DC converter 101 is, in general, of an insolating type. That is, the DC-DC converter 101 includes an isolating transformer, and thereby, insulates the PDP 20 on the output side from a high voltage section (the part surrounded by the broken lines shown in FIG. 42) on the input side. Thus, the PDP driver 100 secures high safety.

The sustain electrode driver section 102, the scan electrode driver section 103, and the address electrode driver section 104 each include switching devices, and generate voltage pulses by the switching operations of the switching devices.

The sustain electrode driver section 102 is connected to the sustain electrodes X1, X2, X3, . . . , of the PDP 20, converts the output voltage of the DC-DC converter 101 into a pulse of a predetermined voltage, and applies it to the sustain electrodes X1, X2, X3, . . . , at the same time.

The scan electrode driver section 103 is connected to the scan electrodes Y1, Y2, Y3, . . . , of the PDP 20, converts the output voltage of the DC-DC converter 101 into a pulse of a predetermined voltage, and applies it separately to the scan electrodes Y1, Y2, Y3, . . . , The address electrode driver section 104 is connected to the address electrodes A1, A2, A3, . . . , of the PDP 20 and applies a pulse of a predetermined voltage separately to them.

The control section 30 controls the switching operations of the sustain electrode driver section 102, the scan electrode driver section 103, and the address electrode driver section 104. The switching control is performed in compliance with the ADS (Address, Display-period Separation) scheme. The ADS scheme is a kind of sub-field schemes. Under the sub-field scheme, one field of image data is divided into a plurality of sub-fields. Each sub-field includes reset, address, and sustain periods. Under the ADS scheme, in particular, all the discharge cells of the PDP 20 are provided with the above-mentioned three periods in common.

In the reset period, reset voltage pulses are applied between the sustain electrodes X1, X2, X3, . . . , and the scan electrodes Y1, Y2, Y3, . . . of the PDP 20. Thereby, a uniform amount of wall charge is stored on all the discharge cells.

In the address period, scanning voltage pulses are applied in sequence to the scan electrodes Y1, Y2, Y3, . . . . At the same time, addressing voltage pulses are applied to some of the address electrodes A1, A2, A3, . . . . Here, the address electrodes to which the addressing voltage pulses should be applied are selected on the basis of the video signal received from the outside. Electric discharge occurs in the discharge cell located at the intersection P of a scan electrode Y2 and an address electrode A2 when a scanning voltage pulse is applied to the scan electrode Y2 and a addressing voltage pulse is applied to the address electrode A2. Wall charges accumulate on the surface of the discharge cell P due to the electric discharge.

In the sustain period, sustaining pulse voltages are applied to the sustain electrodes X1, X2, X3, . . . , and to the scan electrodes Y1, Y2, Y3, . . . , simultaneously and periodically. At that time, gas discharges successively occur in the discharge cell P on which the wall charges accumulate during the address period, and accordingly, the discharge cell P emits visible light.

The lengths of the sustain periods vary among sub-fields, and accordingly, the light emission time per field of the discharge cell, or the luminosity of the discharge cell is adjusted by the selection of a sub-field in which light is to be emitted. The control section 30 determines, based on a video signal, an address electrode to which an addressing voltage pulse is to be applied and a sub-field in which the addressing voltage pulse is to be applied. As a result, the image corresponding to the video signal is reproduced on the PDP 20.

The light emission of each discharge cell of the PDP requires the accumulation of wall charges. In other words, the PDP is a capacitive load. The PDP further has many electrodes running on the panel in vertical and horizontal directions with tiny spacings, like the above-described three-electrode surface-discharge type structure. Accordingly, the stray capacitances of the PDP are large. The stray capacitance (hereafter referred to as the panel capacitance) between the sustain electrode and the scan electrode is especially large. The application of a voltage pulse between the sustain and scan electrodes charges or discharges electricity into or from the panel capacitance. The charging and discharging currents cause power consumption at resistances of the circuit devices of the PDP driver, the sustain and scan electrodes of the PDP, and the lead wires. The power consumed at the resistances is reactive power, that is, does not contribute to the light emission of the discharge cells. A PDP of a larger size has a larger panel capacitance since the sustain and scan electrodes are large in length and number. Therefore, reduction of the above-described reactive power is indispensable to the compatibility between the screen upsizing and the power reduction of the PDP.

For example, a PDP driver using a push-pull inverter as its pulse generating section is known as a PDP driver to reduce the above-described reactive power. See, for example, FIG. 10 of Published Japanese patent application Hei 5-191977 gazette. FIG. 43 is an equivalent circuit diagram of the pulse generating section 102 and the PDP 20. This pulse generating section 102 comprises a push-pull inverter section 102a and an inductor L. The sustain electrode X and the scan electrode Y of the PDP 20 are connected to the output side of the pulse generating section 102. Here, the equivalent circuit of the PDP 20 is represented only by its panel capacitance Cp, and paths in the PDP 20 over which currents flow during the discharge in the discharge cells are omitted.

The control section 30 (see FIG. 42) turns on and off two switching devices Q1 and Q2 of the inverter section 102a alternately. Thereby, the polarity of the secondary voltage of the transformer Tr is periodically reversed. As a result, alternating voltage pulses with a fixed period is applied across the panel capacitance Cp. The control section 30, in particular, adjusts the length of the dead time (which is the time interval during the two switching devices Q1 and Q2 are both maintained in the OFF state), and causes the inductor L to resonate with the panel capacitance Cp in that period. The resonance reverses the polarity of the voltage across the panel capacitance Cp with almost no power consumption. In other words, during the resonance, the power consumed at the resistances (not shown in FIG. 43) of the circuit devices of the pulse generating section 102, the sustain electrode X and the scan electrode Y of the PDP 20, and the lead wires is reduced. Thus, the reactive power caused by the charging and discharging of the panel capacitance Cp is reduced.

In this pulse generating section 102, the secondary winding of the transformer Tr, the inductor L, and the panel capacitance Cp are always under the condition of series connection. Accordingly, resonances between the inductor L and the panel capacitance Cp still occur except the above-described resonance period. For example, a discharging current to flow through the PDP 20 at the light emission of the PDP 20 excites the resonance between the inductor L and the panel capacitance Cp. This resonance has an adverse effect on the image reproduced on the PDP 20. In addition, the withstand voltages of the circuit devices of the PDP driver must be high such that the ringing caused by the resonance can be tolerated.

It is desirable that the above-described resonances between the inductor L and the panel capacitance Cp are limited only during the above-described resonance period. Pulse generating sections that include power recovery sections are known as such a pulse generating section. See for example, FIG. 5 of U.S. Pat. No. 4,866,349 and FIG. 2 of Published Japanese patent application Hei 11-344952 gazette. FIG. 44 is an equivalent circuit diagram of the pulse generating section 102 and the PDP 20 that are disclosed in U.S. Pat. No. 4,866,349. This pulse generating section 102 comprises two similar power recovery sections 102b and 102c and a full-bridge inverter section 102a. FIG. 45 is an equivalent circuit diagram of the pulse generating section 102 and the PDP 20 that are disclosed in Published Japanese patent application Hei 11-344952 gazette. This pulse generating section 102 comprises a full-bridge inverter section 102a and a power recovery section 102d. The sustain electrode X and the scan electrode Y of the PDP 20 are connected to the output side of the inverter section 102a in any of the pulse generating sections 102. The equivalent circuit of the PDP 20 is represented only by its panel capacitance Cp.

The control section 30 (see FIG. 42) turns the switching devices of the pulse generating section 102 on and off with predetermined timing. Then, the alternating voltage pulses with a fixed period are applied across the panel capacitance Cp. The control section 30, in particular, maintains the switching device of the power recovery section (102b and 102c, or 102d) in its ON state during the period when the voltage across the panel capacitance Cp changes, and thereby causes the inductor L to resonate with the panel capacitance Cp. The resonance reverses the voltage across the panel capacitance Cp with almost no power consumption. In other words, during the resonance, the power consumed at the resistances (not shown) of the circuit devices of the pulse generating section 102, the sustain electrode X and the scan electrode Y of the PDP 20, and the lead wires is reduced. Thus, the reactive power caused by the charging and discharging of the panel capacitance Cp is reduced. Furthermore, the period of the resonances between the inductor L and the panel capacitance Cp are limited to the above-described resonance period, thus avoiding an adverse effect on the image reproduced on the PDP 20. In addition, the withstand voltages of the circuit devices of the PDP driver can be reduced since the PDP 20 at the light emission requires no consideration to the ringing caused by the above-described resonance.

Screen upsizing, slimming-down, miniaturization, and power reduction of plasma displays are desired. However, the screen upsizing increases the reactive power caused by the charging and discharging of the panel capacitance. Accordingly, the power reduction is hindered. Increase in the reactive power further increases the current capacities or raises the withstand voltages of the circuit devices of the PDP driver. As a result, the circuit devices increase in size, and therefore, the total area in which the PDP driver is to be mounted increases. Thus, the slimming-down and miniaturization are hindered.

For the compatibility among the screen upsizing, slimming-down, miniaturization, and power reduction of plasma displays, it is desirable that a smaller number of components should make up a PDP driver that can effectively suppress the above-described reactive power.

### SUMMARY OF THE INVENTION

An object of the present invention is to provide a driver of a capacitive load like a PDP; the driver can effectively suppress the reactive power caused by the charging and discharging of the capacitive load, using a smaller number of its components than those of a conventional driver and avoiding adverse effects on the other circuit parts, and can further reduce the total power consumptions of the system including the load.

A capacitive load driver according to the invention is a device for applying a pulse of a predetermined voltage across a capacitive load, which comprises:
a pulse generating section including a switching device and converting a predetermined DC voltage into a primary voltage pulse by the switching operation of said switching device; and
a transformer including a primary winding connected to the pulse generating section and a secondary winding connected to the capacitive load, and converting the primary voltage pulse into the voltage pulse and causing its magnetizing inductance to resonate with the capacitive load.

The invention is further defined from the following three aspects related to the means of power recovery.

According to the first aspect of the invention, the transformer includes magnetizing inductance that resonates with the capacitive load.

According to the second aspect of the invention, the capacitive load driver further comprises:
a pulse generating section including a switching device and converting a predetermined DC voltage into a primary voltage pulse by the switching operation of the switching device;
a transformer including a primary winding connected to the pulse generating section and a secondary winding connected to the capacitive load, and converting the primary voltage pulse into the voltage pulse; and
an auxiliary inductor that is connected in parallel with the secondary winding of said transformer and resonates with the capacitive load.

According to the third aspect of the invention, the capacitive load driver further comprises:
a pulse generating section including a switching device and converting a predetermined DC voltage into a primary voltage pulse by the switching operation of the switching device;
an power recovery section including an inductor and a switching section that passes a current caused by the resonance between the inductor and the capacitive load during its ON time; and
a transformer including a primary winding connected to the pulse generating section and a secondary winding connected to the capacitive load, and converting the primary voltage pulse into the voltage pulse.

The above-described capacitive load is preferably a plasma display panel (PDP). At that time, the above-described capacitive load driver according to the invention is installed in the following plasma display as a PDP driver. The plasma display comprises:
a rectifier section converting an alternating voltage from an external power supply into a predetermined DC voltage;
a PDP driver converting the DC voltage into a pulse of a predetermined voltage; and
a PDP including a discharge cell emitting light by electric discharge of gas with which the discharge cell is filled, and a plurality of electrodes applying the voltage pulse across the discharge cell.

The above-described capacitive load driver according to the invention comprises a transformer on the output side of the pulse generating section. The transformer adjusts a proper level of the voltage pulse and applies the pulse to the capacitive load. Accordingly, the above-described capacitive load driver according to the invention may include no DC-DC converter on the input side of the pulse generating section, in contrast to the conventional driver. Thereby, the component counts of the driver and the area for mounting the driver are small.

Furthermore, the power consumption is low since the power loss by the DC-DC converter is eliminated. In addition, a high voltage from the external power supply may be applied directly to the pulse generating section. At that time, the current in the pulse generating section is smaller than the current in the conventional device. Therefore, the current capacities of the circuit devices can be smaller than those of the conventional devices. As a result, the above-described capacitive load driver according to the invention is easier to miniaturize than the conventional device.

The above-described transformer insulates the capacitive load on the secondary side from the higher voltage section on the primary side. Thereby, the above-described capacitive load driver according to the invention can secure sufficiently high safety.

In the above-described capacitive load driver according to the invention, the magnetizing inductance of the transformer, the auxiliary inductor connected in parallel to the secondary winding of the transformer, or the inductor of the power recovery section resonates with the above-described capacitive load. The resonance changes the voltage pulse with almost no power consumption. Thus, the reactive power caused by the charging and discharging of the capacitive load is effectively suppressed.

According to the first or second aspect of the invention, the magnetizing inductance of the transformer or the auxiliary inductor resonates with the capacitive load. They are equivalent to an inductor connected in parallel to the secondary winding of the transformer. Accordingly, the resonance period is limited to the pulse rise and fall times of the voltage pulse or the primary voltage pulse.

When the capacitive load is a PDP, in particular, no discharging current of the PDP flow through the magnetizing inductance of the transformer and the auxiliary inductor. Accordingly, the above-described resonance has no adverse effects on the image reproduced on the PDP. Furthermore, the PDP at the light emission requires no consideration to the ringing caused by the above-described resonance. Therefore, the withstand voltages of the circuit devices can be low.

As a result, no power recovery section may be included when the magnetizing inductance of the transformer or the auxiliary inductor resonates with the capacitive load. Thereby, the component counts of the above-described capacitive load driver according to the invention and the area for mounting it are still smaller.

According to the first or second aspect of the invention, a current has already flowed through the magnetizing inductance of the transformer or the auxiliary inductor at the start of the resonance with the capacitive load. Therefore, the voltage pulse quickly rises and falls. As a result, the maximum number of the pulses that can be applied to the capacitive load during a fixed period increases.

When the capacitive load is a PDP, the shortening of the pulse rise and fall times of the voltage pulse leads, in particular, the shortening of the sustain period. Accordingly, the number of sub-fields per field is easy to increase. Thus, the level number of gray scale of the PDP is easy to increase, that is, the high image quality is easy to improve, when using the above-described capacitive load driver according to the invention as the PDP driver.

According to the second aspect of the invention, the auxiliary inductor resonates with the capacitive load. Preferably, the inductance of the auxiliary inductor is set sufficiently smaller than the magnetizing inductance of the transformer. Thereby, the resonance current flows mainly through the auxiliary inductor, and hardly flows through the transformer. Accordingly, the copper loss of the transformer is reduced. Thus, the power consumption is further reduced.

According to the third aspect of the invention, the inductor of the power recovery section resonates with the capacitive load. Furthermore, the ON-OFF operation of the switching section accurately controls the resonance period. Preferably, the switching section makes its ON times coincide with the pulse rise and fall times of the above-described voltage pulse or primary voltage pulse. In the power recovery section, further preferably, the inductor and the switching section are connected in series. At that time, no current flows through the inductor during the OFF times of the switching section. Thus, the periods of the resonance between the inductor and the capacitive load are reliably restricted to the desired periods. Accordingly, the power recovery section operates with especially lower power losses among means for power recovery.

According to the third aspect of the invention, the power recovery section may be connected to either the primary or secondary winding of the above-described transformer. When the power recovery section is connected to, in particular, the secondary winding of the transformer, the resonance current does not flow through the secondary winding of the transformer actually. Accordingly, no copper loss of the transformer is produced during the above-described resonance period. As a result, the power consumption is reduced.

Furthermore, the effective value of the current flowing through the transformer is reduced, and thereby, the current capacities of the circuit devices of the pulse generating section and the transformer can be small. Therefore, the above-described capacitive load driver according to the invention is easy to miniaturize. In addition, the iron loss of the transformer is reduced by its miniaturization. Thus, the power consumption is further reduced.

Besides that, the withstand voltages of all the switching sections of the power recovery section are reduced. As a result, the circuit devices are easy to miniaturize, and therefore, the area for mounting the above-described capacitive load driver according to the invention is easy to reduce.

The above-described capacitive load driver according to the invention may comprise first and second driver sections each including the pulse generating section and the transformer.

At that time, the secondary windings of the two transformers and the capacitive load may be connected in series or parallel. Over any of the connections, the power required for the charging and discharging of the capacitive load is supplied to the capacitive load through both of the two pulse generating sections. In particular, the current flowing through each of the two pulse generating sections is suppressed. Accordingly, the current capacities of the circuit devices of the two pulse generating sections can be small. As a result, the above-described capacitive load driver according to the invention is easy to miniaturize.

The secondary voltages of the two transformers are further lower when the two transformers and the capacitive load are connected in series. Accordingly, the withstand voltages of the transformers can be low. In addition, the primary currents are reduced for fixed primary voltages. Therefore, the current capacities of the circuit devices of the pulse generating sections can be further reduced. As a result, the above-described capacitive load driver according to the invention is still easier to miniaturize.

According to the first aspect of the invention, the transformer included in each of the first and second driver sections has the magnetizing inductance resonating with the capacitive load. On the other hand, according to the second or third aspect of the invention, at least the first driver section comprises the above-described auxiliary inductor or power recovery section. In such a manner, the special circuit device to resonate with the capacitive load may be installed at least in one of the two driver sections. Of course, together with the first driver section, the second driver section may have the above-described auxiliary inductor or power recovery section.

The above-described capacitive load driver according to the invention may comprise a control section that maintains the switching operations of the first and second driver sections in phase or opposite phase. Here, the polarities of the transformers determine the phases of the switching operations so that the voltage pulses applied to the capacitive load are of the same polarity.

According to the first aspect of the invention, the magnetizing inductances of the transformers included in the first and second driver sections simultaneously resonate with the capacitive load. According to the second or third aspect of this invention, when the first and second driver sections both include the auxiliary inductors or power recovery sections, the auxiliary inductors or power recovery sections simultaneously resonate with the capacitive load. The resonance effectively reduces the reactive power caused by the charging and discharging of the capacitive load.

Alternatively, the above-described capacitive load driver according to the invention may comprise a control section to set the phase difference between the switching operations of the first and second driver sections within the range from 0° to 180°, when the secondary windings of the transformers are connected to the capacitive load in series. Here, either phase of the switching operations of the first and second driver sections may be used as the reference.

According to the first aspect of the invention, the magnetizing inductances of the transformers included in the first and second driver sections alternately and separately resonate with the capacitive load. According to the second or third aspect of this invention, when the first and second driver sections both include the auxiliary inductors or power recovery sections, the auxiliary inductors or power recovery sections alternately and separately resonate with the capacitive load. Such resonances can reduce the reactive power caused by the charging and discharging of the capacitive load.

Furthermore, according to the second or third aspect of the invention, the second driver section may include neither the auxiliary inductor nor the power recovery section. According to the third aspect of the invention, alternatively, the switching section of the power recovery section may pass the current caused by the resonance between the inductor and the capacitive load in one direction. Thereby, the component counts of the driver and the area for mounting it are further reduced.

In the above-described capacitive load driver according to the invention, preferably, the switching device of the pulse generating section is a wide band-gap semiconductor switching device. Here, a wide band-gap semiconductor includes, for example, silicone carbide (SiC), diamond, gallium nitride (GaN), or zinc oxide (ZnO). The ON resistance of the wide band-gap semiconductor switching device less increases with rise in withstand voltage than that of a conventional Si semiconductor switching device. In other words, the wide band-gap semiconductor switching device has a higher withstand voltage and a lower ON resistance, and accordingly, it is very suitable for the use as a switching device of the pulse generating section. Especially in the case where the capacitive load is a PDP, large and momentary currents flow in the pulse generating section due to the application of high voltage pulses across the PDP. Therefore, the use of the wide band-gap semiconductor switching device is very effective for the compatibility between the miniaturization of the devices due to the high withstand voltages and the reduction of conduction losses due to the low ON resistances.

In the above-described capacitive load driver according to the invention, preferably,
the pulse generating section includes high-side and low-side switching devices which are used as the switching devices, the high-side and low-side switching devices are connected in series to each other; and
the primary winding of the transformer is connected to the node of the high-side and low-side switching devices.

In other words, the pulse generating section is a full- or half-bridge inverter. In that case, the switching device has lower withstand voltage than that of the push-pull inverter.

In the above-described capacitive load driver according to the invention, preferably, the pulse generating section regenerates power in the source of the DC voltage by the switching operation of the switching device. Here, the source of the DC voltage corresponds, for example, to the rectifier section in the above-described plasma display. For example, one of the high-side and low-side switching devices is turned on and allows a regenerating current to flow into the source of the DC voltage at the end of the application of the voltage pulse. At the end of the application of a series of the voltage pulses to the capacitive load, such as the end of the sustain period in the plasma display, a current still remains in the magnetizing inductance of the transformer or the auxiliary inductor in the case according to the first or second aspect of the invention. In other words, the resonance energy accumulated still remains in the magnetizing inductance or the auxiliary inductor at that time. The above-described capacitive load driver according to the invention regenerates the resonance energy remaining in the source of the DC voltage. Accordingly, the reactive power is still reduced, and then, the efficiency of the capacitive load driver is further improved.

The above-described capacitive load driver according to the invention comprises the transformer on the output side of the pulse generating section. Accordingly, in contrast to the conventional driver, no DC-DC converter is required on the input side of the pulse generating section. Thereby, the component counts of the above-described capacitive load driver according to the invention and the area for mounting it are still smaller. Furthermore, the power consumption is low since the power loss by the DC-DC converter is eliminated. In addition, as a result of applying the high voltage from the external power supply directly to the pulse generating section, the circuit devices can have smaller current capacities than the conventional devices, and therefore, the whole of the driver is easier to miniaturize.

According to the first or second aspect of the invention, the magnetizing inductance of the transformer or the auxiliary inductor resonates with the capacitive load. The resonance reduces the reactive power caused by the charging and discharging of the capacitive load. In contrast to the conventional driver, in particular, the inductor that resonates with the capacitive load, that is, the magnetizing inductance of the transformer or the auxiliary inductor is in parallel to the secondary winding of the above-described transformer. When the capacitive load is a PDP, in particular, the above-described resonance has no adverse effects on the image reproduced on the PDP. In addition, the withstand voltages of the circuit devices of the capacitive load driver can be low since the PDP at the light emission requires no consideration to the ringing caused by the above-described resonance. As a result, no power recovery section is required according to the first and second aspects of the invention. Thereby, the above-described capacitive load driver according to the invention has smaller number of components and smaller mounted area than the conventional driver. Accordingly, the whole of the driver is easy to miniaturize.

Furthermore, according to the first or second aspect of the invention, a current has already flowed through the magnetizing inductance of the transformer or the auxiliary inductor at the start of the resonance with the capacitive load. Therefore, the voltage pulses quickly rise and fall than those in the conventional driver. As a result, the maximum number of the pulses that can be applied to the capacitive load during the constant period is easier to increase than the maximum number of the pulses in the conventional driver. When the capacitive load is a PDP, the shortening of the pulse rise and fall times of the voltage pulse leads the shortening of the sub-field, in particular, the sustain period. Accordingly, the number of sub-fields per field is easy to increase. Thus, the level number of gray scale of the PDP is easy to increase, that is, the high image quality is easy to improve, when using the above-described capacitive load driver according to the invention as the PDP driver.

According to the third aspect of the invention, the inductor of the power recovery section resonates with the capacitive load. The resonance periods are reliably restricted to the desired periods by the ON-OFF operation of the switching section. In other words, no current flows through the inductor during the periods other than the resonance periods. Thus, the power recovery section operates with especially lower power losses among means for power recovery.

Furthermore, when the power recovery section is connected to the secondary winding of the transformer, the current caused by the resonance between the inductor of the power recovery section and the capacitive load does not flow through the secondary winding of the transformer actually, in contrast to the conventional driver. Accordingly, no copper loss of the transformer is produced during the resonance period. As a result, the power consumptions are reduced. In addition, the effective value of the current flowing through the transformer is reduced, and thereby, the current capacities of the circuit devices of the pulse generating section and the transformer can be small. Therefore, the above-described capacitive load driver according to the invention is easy to miniaturize. In particular, the iron loss of the transformer is reduced by its miniaturization. As a result, the power consumption is further reduced. Besides that, the withstand voltages of all the switching sections of the power recovery section are-reduced, and therefore, the miniaturization of the power recovery section and the reduction of the mounted area are easily attained.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a block diagram which shows a configuration of a plasma display according to Embodiment 1 of the invention;

FIG. 2 is an equivalent circuit diagram of a sustaining pulse generating section 1, a transformer 2, and an inductor L according to Embodiment 1 of the invention, and a PDP 20;

FIG. 3 is an equivalent circuit diagram of a reset/scanning pulse generating section 3 according to Embodiment of the invention, and in particular, shows a first-pattern connection between the reset/scanning pulse generating section 3 and the secondary winding 2b of the transformer 2;

FIG. 4 is an equivalent circuit diagram of the reset/scanning pulse generating section 3 according to Embodiment of the invention, and in particular, shows a second-pattern connection between the reset/scanning pulse generating section 3 and the secondary winding 2b of the transformer 2;

FIG. 5 is a waveform chart about Embodiment 1 of the invention, which shows the potential of a scan electrode Y of the PDP 20, and ON times of switching devices and sections Q5, Q6, Q7, Q8, Q9, Q10, Q11, QR1, QR2, QB, QS1, QS2, QS3, QS4, and QS5 included in the reset/scanning pulse generating section 3 and main switching devices Q1-Q4 included in the sustaining pulse generating section 1, during reset, address, and sustain periods;

FIG. 6 is a block diagram which shows a configuration of a plasma display according to Embodiment 2 of the invention;

FIG. 7 is an equivalent circuit diagram of two driver sections of a PDP driver according to Embodiment 2 of the invention and a PDP 20;

FIG. 8 is a waveform chart about Embodiment 2 of the invention, which shows the potentials of a scan electrode Y and a sustain electrode X of the PDP 20, and ON times of main switching devices Q1Y-Q4Y, Q1X-Q4X included in the sustaining pulse generating sections 1Y, 1X, and switching sections Q12, Q13, and QS6 included in the reset pulse generating section 3X, during reset, address, and sustain periods;

FIG. 9 is a waveform chart about Embodiment 2 of the invention, which shows the potentials of a scan electrode Y and a sustain electrode X of the PDP 20, and ON times of the main switching devices Q1Y-Q4Y, Q1X-Q4X included in the sustaining pulse generating sections 1Y, 1X, during a sustain period, in the case of setting a predetermined phase difference between the switching operations of the two sustaining pulse generating sections;

FIG. 10 is a block diagram which shows a configuration of a plasma display according to Embodiment 3 of the invention;

FIG. 11 is an equivalent circuit diagram of two driver sections of a PDP driver according to Embodiment 3 of the invention and a PDP 20;

FIG. 12 is a block diagram which shows a configuration of a plasma display according to Embodiment 4 of the invention;

FIG. 13 is an equivalent circuit diagram of a PDP driver according to Embodiment 4 of the invention and a PDP 20;

FIG. 14 is a block diagram which shows a configuration of a plasma display according to Embodiment 5 of the invention;

FIG. 15 is an equivalent circuit diagram of two driver sections of a PDP driver according to Embodiment 5 of the invention and a PDP 20;

FIG. 16 is a waveform chart about Embodiment 5 of the invention, which shows ON times of main switching devices Q1-Q4 included in the sustaining pulse generating sections 1Y, 1X, and recovery switching devices Q5, Q6 included in the power recovery sections 4Y, 4X, a sustaining voltage pulse Vp, and resonance currents IL flowing through inductors L of the power recovery sections 4Y, 4X, in the case of setting a predetermined phase difference between the switching operations of the two sustaining pulse generating sections 1Y, 1X, during a sustain period;

FIG. 17 is a block diagram which shows a configuration of a plasma display according to Embodiment 6 of the invention;

FIG. 18 is an equivalent circuit diagram of two driver sections of a PDP driver according to Embodiment 6 of the invention and a PDP 20;

FIG. 19 is an equivalent circuit diagram of a PDP driver according to Embodiment 7 of the invention and a PDP 20;

FIG. 20 is an equivalent circuit diagram of two driver sections of a PDP driver according to Embodiment 8 of the invention and a PDP 20;

FIG. 21 is an equivalent circuit diagram of two driver sections of a PDP driver according to Embodiment 9 of the invention and a PDP 20;

FIG. 22 is an equivalent circuit diagram of two driver sections of a PDP driver according to Embodiment 10 of the invention and a PDP 20;

FIG. 23 is an equivalent circuit diagram of a PDP driver according to Embodiment 11 of the invention and a PDP 20;

FIG. 24 is an equivalent circuit diagram of two driver sections of a PDP driver according to Embodiment 12 of the invention and a PDP 20;

FIG. 25 is an equivalent circuit diagram of a PDP driver according to Embodiment 13 of the invention and a PDP 20;

FIG. 26 is an equivalent circuit diagram of two driver sections of a PDP driver according to Embodiment 14 of the invention and a PDP 20;

FIG. 27 is an equivalent circuit diagram of two driver sections of a PDP driver according to Embodiment 15 of the invention and a PDP 20;

FIG. 28 is an equivalent circuit diagram of two driver sections of a PDP driver according to Embodiment 16 of the invention and a PDP 20;

FIG. 29 is a block diagram which shows a configuration of a plasma display according to Embodiment 17 of the invention;

FIG. 30 is an equivalent circuit diagram of a PDP driver according to Embodiment 17 of the invention and a PDP 20;

FIG. 31 is a block diagram which shows a configuration of a plasma display according to Embodiment 18 of the invention;

FIG. 32 is an equivalent circuit diagram of two driver sections of a PDP driver according to Embodiment 18 of the invention and a PDP 20;

FIG. 33 is a block diagram which shows a configuration of a plasma display according to Embodiment 19 of the invention;

FIG. 34 is an equivalent circuit diagram of two driver sections of a PDP driver according to Embodiment 19 of the invention and a PDP 20;

FIG. 35 is a block diagram which shows a configuration of a plasma display according to Embodiment 20 of the invention;

FIG. 36 is an equivalent circuit diagram of a PDP driver according to Embodiment 20 of the invention and a PDP 20;

FIG. 37 is an equivalent circuit diagram of two driver sections of a PDP driver according to Embodiment 21 of the invention and a PDP 20;

FIG. 38 is a block diagram which shows a configuration of a plasma display according to Embodiment 22 of the invention;

FIG. 39 is an equivalent circuit diagram of two driver sections of a PDP driver according to Embodiment 22 of the invention and a PDP 20;

FIG. 40 is an equivalent circuit diagram of two driver sections of a PDP driver according to Embodiment 23 of the invention and a PDP 20;

FIG. 41 is an equivalent circuit diagram of two driver sections of a PDP driver according to Embodiment 24 of the invention and a PDP 20;

FIG. 42 is the block diagram which shows the configuration of the conventional plasma display;

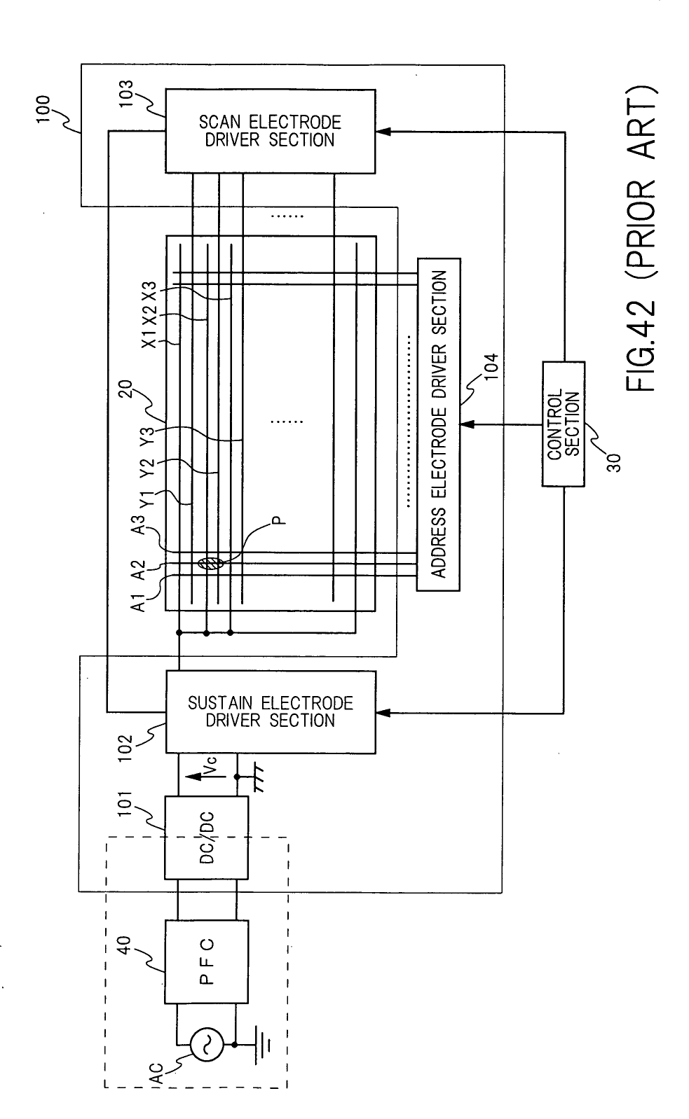

FIG. 43 is the equivalent circuit diagram of the conventional sustaining pulse generating section 102 which includes the push-pull inverter, and the PDP 20;

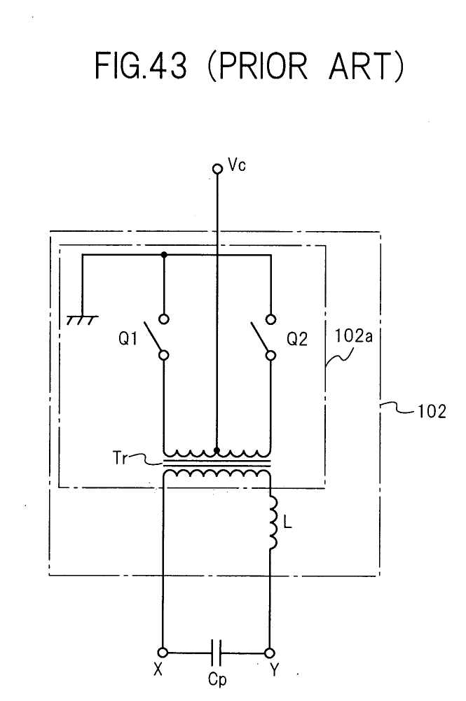

FIG. 44 is the equivalent circuit diagram of the conventional sustaining pulse generating section 102 which includes the full-bridge inverter section 102a and the two similar power recovery sections 102b and 102c, and the PDP 20;

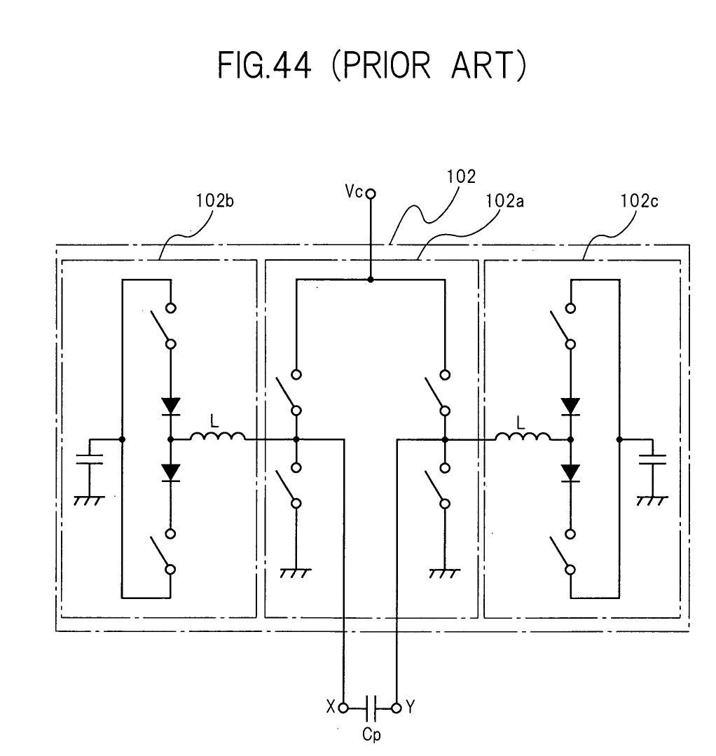

FIG. 45 is the equivalent circuit diagram of the conventional sustaining pulse generating section 102 which includes the full-bridge inverter section 102a and another power recovery section 102d, and the PDP 20.

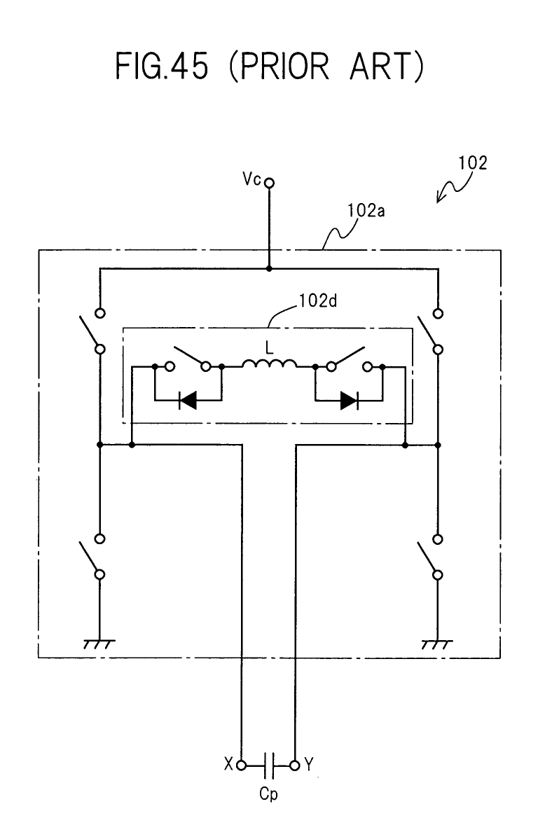

It will be recognized that some or all of the Figures are schematic representations for purposes of illustration and do not necessarily depict the actual relative sizes or locations of the elements shown.

### DETAILED DESCRIPTION OF THE INVENTION

The following explains the best embodiments of the present invention, referring to the figures.

### EMBODIMENT 1

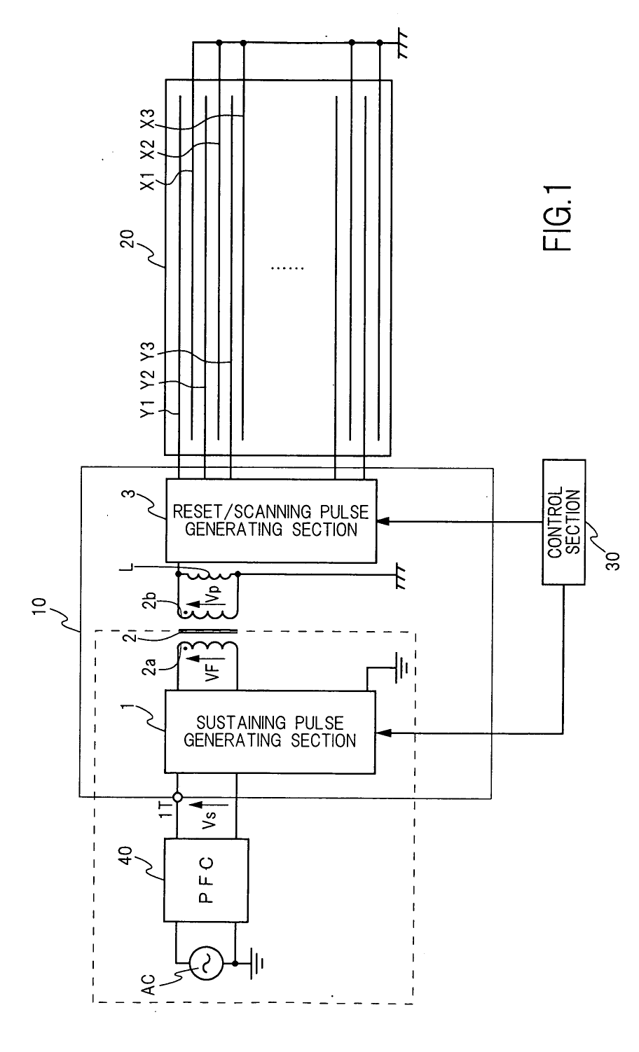

FIG. 1 is the block diagram which shows the configuration of the plasma display according to Embodiment 1 of the invention.

The plasma display comprises a PDP 20, a PFC converter 40, a PDP driver 10, and a control section 30.

The PDP 20 is preferably an AC type and comprises a three-electrode surface-discharge type structure. Address electrodes (not shown) are arranged on the rear substrate of the PDP 20 in the vertical direction of the panel. Sustain electrodes X1, X2, X3, . . . and scan electrodes Y1, Y2, Y3, . . . are alternately arranged on the front substrate of the PDP 20 in the horizontal direction of the panel. The sustain electrodes X1, X2, X3, . . . , are connected to each other, and thereby, maintained at a substantially equal potential. The address electrodes and the scan electrodes Y1, Y2, Y3, . . . each allow the separate potential changes.

A discharge cell (not shown) is installed at the intersection of a pair of sustain and scan electrodes adjacent to each other and an address electrode. Electric discharge occurs in the discharge cell when pulses of predetermined voltages are applied to the sustain, scan, and address electrodes. As a result, the discharge cell emits visible light.

The ADS scheme is preferably adopted as the display scheme of the PDP 20. Under the ADS scheme, one field of image data (of, for example, 1/60 sec=about 16.7 msec in the Japanese television broadcasts) is divided into plural (for example, 8-12) sub-fields. In each sub-field, all the discharge cells of the PDP 20 are provided with reset, address, and sustain periods in common.

In the reset period, reset voltage pulses are applied between the sustain electrodes X1, X2, X3, . . . and the scan electrodes Y1, Y2, Y3, . . . . Thereby, a uniform amount of wall charge is stored on every discharge cell.

In the address period, scanning voltage pulses are applied in sequence to the scan electrodes Y1, Y2, Y3, . . . . At the same time, addressing voltage pulses are applied to some of the address electrodes A1, A2, A3, . . . . Here, the address electrodes to which the addressing voltage pulses should be applied are selected on the basis of the video signal received from the outside. In the discharge cell located at the intersection of the scan and address electrodes to which the scanning and addressing voltage pulses are applied, respectively, electric discharge occurs and then, wall charges accumulates on the surface.

In the sustain period, sustaining pulse voltages are applied to the sustain electrodes X1, X2, X3, . . . and the scan electrodes Y1, Y2, Y3, simultaneously and periodically. At that time, in the discharge cell on which the wall charges accumulate during the address period, gas discharges successively occur and then, visible light is emitted. The lengths of the sustain periods vary among sub-fields, and accordingly, the light emission time per field of the discharge cell, or the luminosity of the discharge cell is adjusted by the selection of a sub-field in which light is to be emitted.

The PFC converter 40 is connected to an external, commercial AC power supply AC. The PFC converter 40 receives the AC power (whose rms value of voltage falls, in general, within 85-265V) from the commercial AC power supply AC, and converts the AC power into a DC power (whose average value of voltage Vs is, for example, about 400V). The PFC converter 40 then holds its power factor substantially equal to 1 by its switching operation, for the input from the commercial AC power supply AC.

The plasma display may substitute for the PFC converter 40, a full-wave rectification type AC-DC converter which performs no power-factor correction. Alternatively, the display may comprise only a full-wave rectifier circuit composed of a diode bridge and capacitors.

The PDP driver 10 includes a sustaining pulse generating section 1, a transformer 2, an inductor L, a reset/scanning pulse generating section 3, and an address electrode driver section (not shown). The input terminals of the sustaining pulse generating section 1 are connected to the PFC converter 40, and the output terminals of it are connected to both ends of the primary winding 2a of the transformer 2. The sustaining pulse generating section 1 includes a switching inverter, and generates primary voltage pulses VF by using the DC power received from the PFC converter 40.

The one end of the secondary winding 2b of the transformer 2 is connected to the reset/scanning pulse generating section 3, and the other end of the secondary winding 2b is grounded. In that case, the sustain electrodes X1, X2, X3, . . . of the PDP 20 are grounded. For example, a frame of the PDP 20 (not shown) is used as the ground conductor. In FIG. 1, the ground terminals on the secondary side of the transformer 2 are represented by a symbol different from the symbol representing the ground terminals of the higher voltage section (the part surrounded by the broken lines shown in FIG. 1) on the primary side of the transformer 2. The sustain electrodes X1, X2, X3, . . . are connected to the secondary winding 2b of the transformer 2 through the ground conductor (the frame of the PDP 20). Alternatively, the sustain electrodes X1, X2, X3, . . . may be connected directly to the secondary winding 2b of the transformer 2 with lead wires. The transformer 2 converts the primary voltage pulse VF into the voltage pulse which has a predetermined level (for example, about 175V), that is, the sustaining pulse voltage Vp. The sustaining pulse voltage Vp is applied to the sustain electrodes X1, X2, X3, . . . and the scan electrodes Y1, Y2, Y3, . . . at the same time.

The inductor L is connected in parallel to the secondary winding 2b of the transformer 2. Here, the inductor L is preferably the magnetizing inductance of the transformer 2. The inductor L may be alternatively an element (auxiliary inductor) separate from the transformer 2. In that case, the inductance of the auxiliary inductor L is, preferably, sufficiently smaller than the magnetizing inductance of the transformer 2.

The reset/scanning pulse generating section 3 is connected to the scan electrodes Y1, Y2, Y3, . . . of the PDP 20. The reset/scanning pulse generating section 3 includes a switching inverter, and applies reset and scanning voltage pulses to the scan electrodes Y1, Y2, Y3, . . . separately. Furthermore, the reset/scanning pulse generating section 3 separates the secondary winding 2b of the transformer 2 from the scan electrodes Y1, Y2, Y3, . . . during the reset and address periods, and connects the secondary winding 2b to the scan electrodes Y1, Y2, Y3, . . . during the sustain period.

The sustaining pulse generating section 1, the transformer 2, and the reset/scanning pulse generating section 3 are put together on the same side with respect to the PDP 20 as shown in FIG. 1. In that case, for example, effective heat and noise control measures are easier since the heat and noise sources included in the PDP driver 10 are placed within the limited range.

The one end of the secondary winding 2b of the transformer 2 may be connected through a separation switch to the sustain electrodes X1, X2, X3, . . . , of the PDP 20 and the other end of the secondary winding 2b may be grounded, in contrast to FIG. 1. In that case, the separation switch connects the sustain electrodes X1, X2, X3, . . . to the secondary winding 2b of the transformer 2 during the sustain period, and separates them from the secondary winding 2b of the transformer 2 and grounds them during the reset and address periods. On the other hand, the reset/scanning pulse generating section 3 grounds the scan electrodes Y1, Y2, Y3, . . . during the sustain period.

The control section 30 controls the switching operations of the sustaining pulse generating section 1, the reset/scanning pulse generating section 3, and the address electrode driver section (not shown) in accordance with the ADS scheme. The control section 30 in particular determines the address electrode to which the addressing voltage pulse is to be applied and a sub-field in which the addressing voltage pulse is to be applied, on the basis of the video signal. As a result, the image corresponding to the video signal is reproduced on the PDP 20.

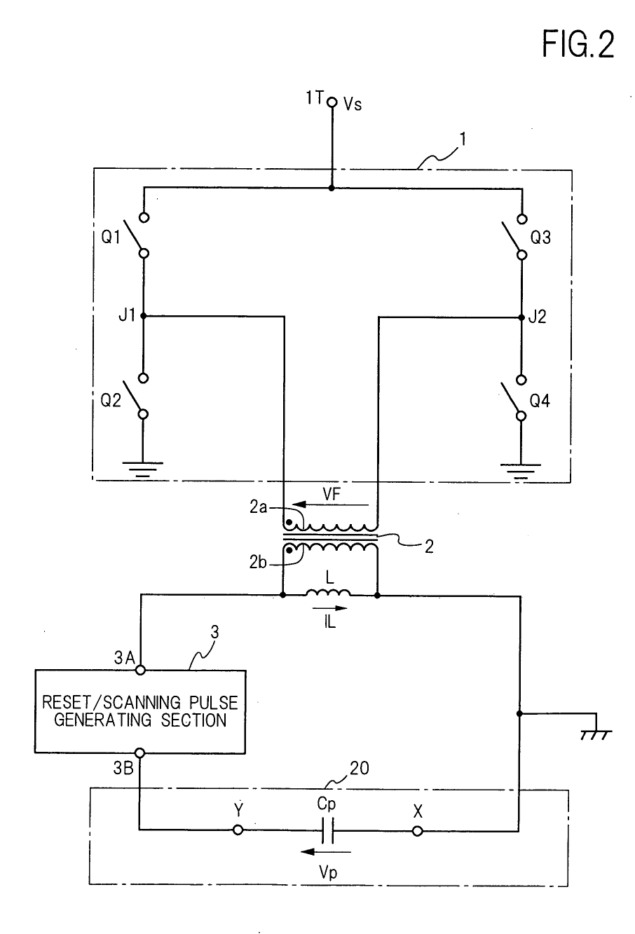

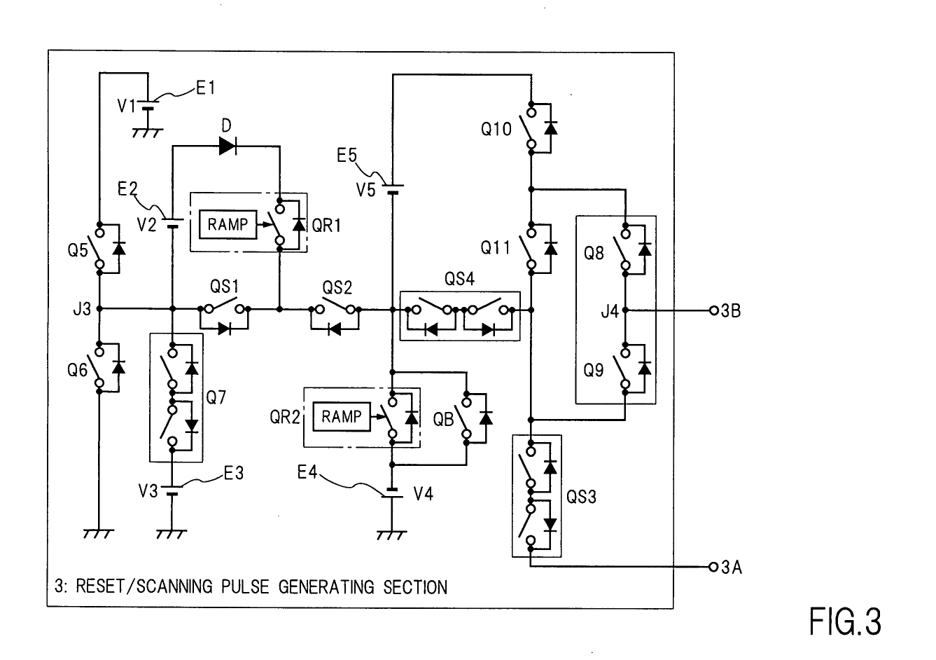

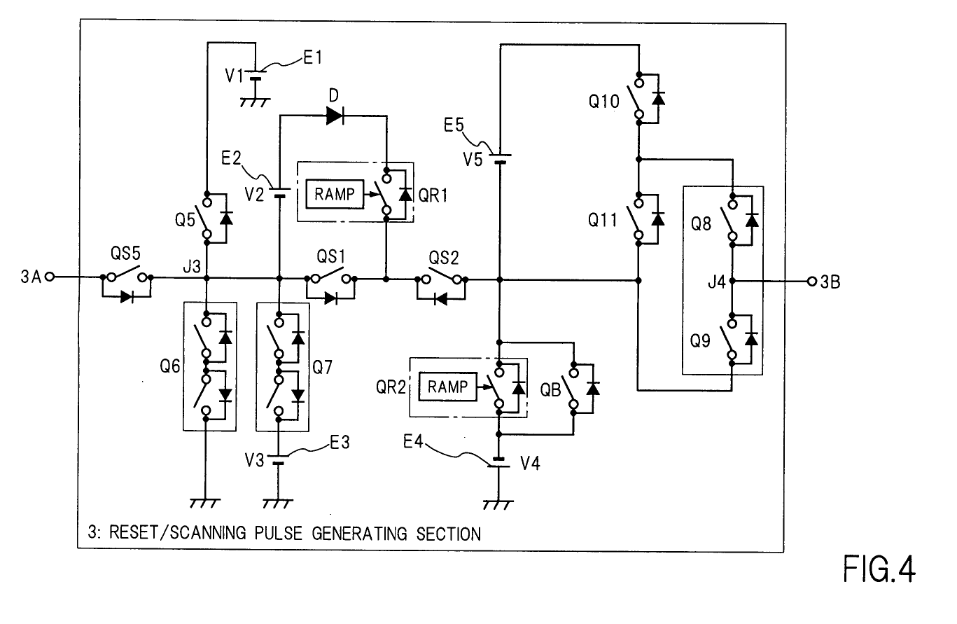

FIG. 2 is the equivalent circuit diagram of the sustaining pulse generating section 1, the transformer 2, the inductor L, and the PDP 20. FIGS. 3 and 4 are the equivalent circuit diagrams of the reset/scanning pulse generating section 3. Here, the equivalent circuit of the PDP 20 is represented by a sustain electrode X, a scan electrode Y, and the capacitance between the electrodes, that is, the panel capacitance Cp. The path of the current flowing through the PDP 20 at the discharge in the discharge cells is omitted.

The sustaining pulse generating section 1 is a full-bridge inverter, and includes four main switching devices Q1-Q4. See FIG. 2. Each of the main switching devices Q1-Q4 is, preferably, a MOSFET, and further preferably, a wide band-gap semiconductor switching device. Here, the wide band-gap semiconductor includes, for example, SiC, diamond, GaN, or ZnO. The wide band-gap semiconductor switching device has a higher withstand voltage and a lower ON resistance. At the application of the sustaining voltage pulses, large and momentary currents flow through the main switching devices Q1-Q4 of the sustaining pulse generating section 1, caused by the discharges in the PDP 20 and the charging and discharging of the panel capacitance Cp. Accordingly, the use of the wide band-gap semiconductor switching device is very effective for the compatibility between the reductions in size and conduction loss of the sustaining pulse generating section 1. Each of the four main switching devices Q1-Q4 may, alternatively, be an IGBT or a bipolar transistor.

The DC voltage Vs is applied from the PFC converter 40 to the input terminal 1T of the sustaining pulse generating section L. The series connection of the first high- and low-side main switching devices Q1 and Q2 and the series connection of the second high- and low-side main switching devices Q3 and Q4 are each connected between the input terminal 1T and the ground terminal. The primary winding 2a of the transformer 2 is connected between both nodes J1 and J2 of the two series connections.

The one end of the secondary winding 2b of the transformer 2 is connected through the two terminals 3A and 3B of the reset/scanning pulse generating section 3 to the scan electrode Y of the PDP 20, and the other end of the secondary winding 2b is connected to the sustain electrode X of the PDP 20. The sustain electrode X is grounded in FIG. 2. Alternatively, the scan electrode Y may be grounded.

The connections between the secondary winding 2b of the transformer 2 and the reset/scanning pulse generating section 3 include two patterns. See FIGS. 3 and 4. The reset/scanning pulse generating section 3 includes, as common components of the two patterns, five constant-voltage sources E1-E5, two switching devices Q5, Q6, a two-way switching section Q7, two separation switching devices QS1, QS2, a blocking diode D, two ramp-wave generating sections QR1, QR2, a bypass switching device QB, two scan switching devices Q8, Q9, and two auxiliary switching devices Q10 and Q11.

The five constant-voltage sources E1, E2, E3, E4, and E5 maintain the positive electrodes at the potentials higher than the potentials of the negative electrodes by constant voltages V1, V2, V3, V4, and V5 (for example, about 175V, about 220V, about 25V, about 240V, and about 120V), respectively.

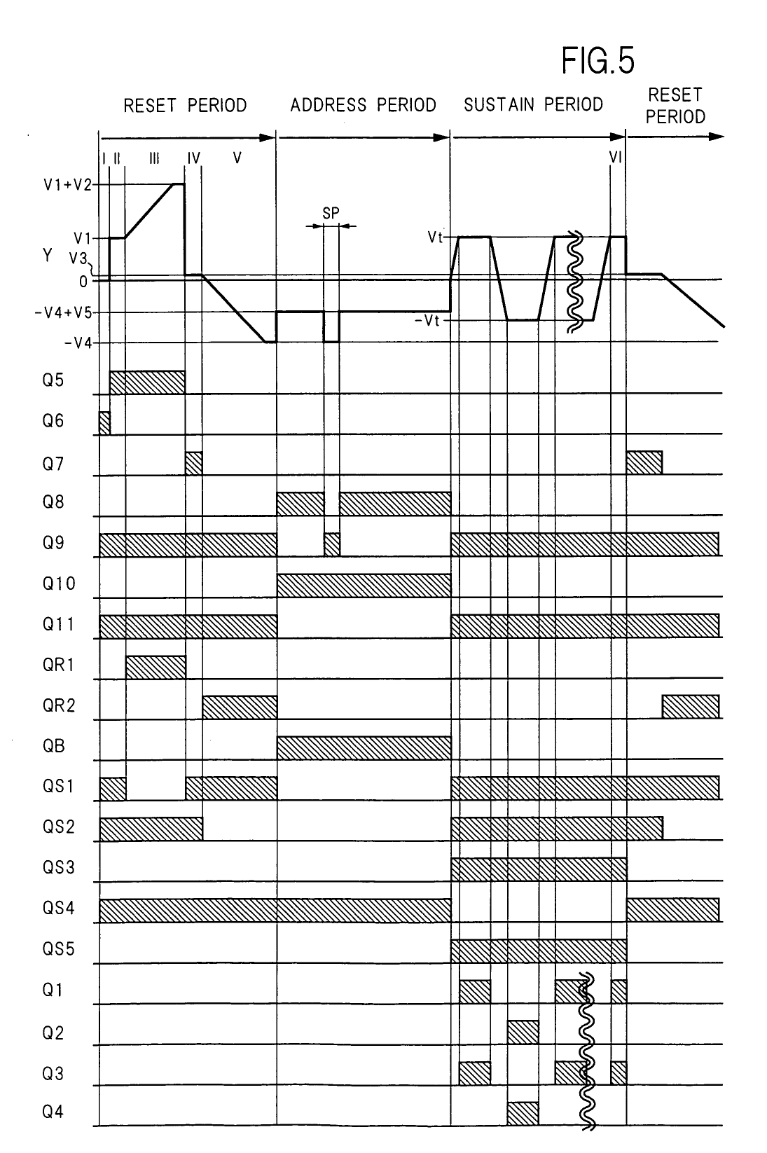

The two switching devices Q5, Q6, the two separation switching devices QS1, QS2, the bypass switching device QB, the two scan switching devices Q8, Q9, and the two auxiliary switching devices Q10 and Q11 are preferably MOSFETs. In particular, the bypass switching device QB is more preferably a wide band-gap semiconductor switching device. During the address period, in general, large currents flow through the bypass switching devices QB. See FIG. 5. Accordingly, the use of the wide band-gap semiconductor switching device is very effective for the compatibility between the reductions in size and conduction loss of the bypass switching device QB. Alternatively, the bypass switching device may be an IGBT or a bipolar transistor. Any of the switching devices Q5, Q6, QS1, QS2, QB, Q8, Q9, Q10, and Q11 has polarity since it has a body diode in parallel. Hereafter, anode and cathode refer to the terminals of the switching device corresponding to the anode and cathode of the body diode, respectively.

The two-way switching section Q7 includes two switching devices, and the switching devices are preferably MOSFETs, or alternatively, may be IGBTs or bipolar transistors. The two switching devices have polarities since they have body diodes in parallel. The anodes of the two switching devices are connected to each other, and their ON/OFF states are controlled to be always equal.

The ramp-wave generating sections QR1 and QR2 preferably include an N-channel MOSFET (NMOS). Each NMOS is further preferably a wide band-gap semiconductor switching device. During the reset period, large currents flow through the ramp-wave generating sections QR1 and QR2. See FIG. 5. Accordingly, the use of the wide band-gap semiconductor switching device is very effective for the compatibility between the reductions in size and conduction loss of the ramp-wave generating sections QR1 and QR2. The gate and drain of each NMOS are connected across a capacitor. When the ramp-wave generating sections QR1 and QR2 are turned on, the voltages across them change to zero at a substantially constant speed due to the charging of the capacitors. The ramp-wave generating sections QR1 and QR2 have polarities since each NMOS has a body diode in parallel.

The negative electrode of the first constant-voltage source E1 is grounded, and its positive electrode is connected to the cathode of the high-side switching device Q5. The anode of the high-side switching device Q5 is connected to the cathode of the low-side switching device Q6. The anode of the low-side switching device Q6 is grounded. The node J3 of the high- and low-side switching devices Q5 and Q6 is connected to the anode of the first separation switching device QS1. The cathode of the first separation switching device QS1 is connected to the cathode of the second separation switching device QS2. The anode of the second separation switching device QS2 is connected to the anode of the low-side scan switching device Q9 through the second separation switching section QS4 or directly.

The negative electrode of the second constant-voltage source E2 is connected to the anode of the first separation switching device QS1, and the positive electrode of the source E2 is connected to the anode of the blocking diode D. The cathode of the blocking diode D is connected to the cathode of the high-side ramp-wave generating section QR1. The anode of the high-side ramp-wave generating section QR1 is connected to the cathode of the first separation switching device QS1.

The negative electrode of the third constant-voltage source E3 is grounded, and its positive electrode is connected to the anode of the first separation switching device QS1 through the two-way switching section Q7.

The positive electrode of the fourth constant-voltage source E4 is grounded, and its negative electrode is connected to the anode of the low-side ramp-wave generating section QR2 and the anode of the bypass switching device QB. The cathode of the low-side ramp-wave generating section QR2 and the cathode of the bypass switching device QB are connected to the anode of the second separation switching device QS2.

The negative electrode of the fifth constant-voltage source E5 is connected to the anode of the second separation switching device QS2, and the positive electrode of the source E5 is connected to the cathode of the high-side auxiliary switching device Q10. The anode of the high-side auxiliary switching device Q10 is connected to the cathode of the high-side scan switching device Q8 and the cathode of the low-side auxiliary switching device Q11. The anode of the low-side auxiliary switching device Q11 is connected to the anode of the low-side scan switching device Q9.

The anode of the high-side scan switching device Q8 is connected to the cathode of the low-side scan switching device Q9. Their node J4 is connected to a scan electrode Y of the PDP 20 through the output terminal 3B. See FIG. 2. Here, the number of the series connections of the two scan switching devices Q8 and Q9 actually provided is equal to the number of plural scan electrodes Y1, Y2, and . . . . See FIG. 1. Each of the series connections is connected to one of the scan electrodes Y1, Y2, . . . .

The installation of the two auxiliary switching devices Q10 and Q11 aims at the overvoltage protection of the two scan switching devices Q8 and Q9. Thereby, malfunctions of the two scan switching devices Q8 and Q9 are avoided. When there is a little fear of the malfunctions, the installation of the auxiliary switching devices Q10 and Q11 may not be required. In that case, the positive electrode of the fifth constant-voltage source E5 and the cathode of the high-side scan switching device Q8 is short-circuited, and the cathode of the high-side scan switching device Q8 is separated from the anode of the low-side scanning switching device Q9.

According to a first pattern of the connection between the secondary winding 2b of the transformer 2 and the reset/scanning pulse generating section 3, the reset/scanning pulse generating section 3 includes two separation switching sections QS3 and QS4. See FIG. 3. The first separation switching section QS3 is inserted between an input terminal 3A of the reset/scanning pulse generating section 3 and the anode of the low-side scan switching device Q9. The second separation switching section QS4 is inserted between the anode of the second separation switching device QS2 and the anode of the low-side scan switching device Q9. Both the two separation switching sections QS3 and QS4 are two-way switches and each include two switching devices. These switching devices are preferably MOSFETs, or alternatively, may be IGBTs or bipolar transistors. The two switching devices have polarities since they each include body diodes in parallel. The anodes of the two switching devices are connected to each other, and their ON/OFF states are controlled to be always equal.

For the first pattern, further preferably, the second separation switching device QS2, the high-side auxiliary switching device Q10, the input-terminal-3A-side switching device included in the first separation switching section QS3, and the low-side-scan-switching-device-Q9-side switching device included in the second separation switching section QS4 are wide band-gap semiconductor switching devices. Especially, both of higher withstand voltages and lower ON resistances are strongly required of these switching devices.

According to a second pattern of the connection between the secondary winding 2b of the transformer 2 and the reset/scanning pulse generating section 3, the reset/scanning pulse generating section 3 includes a third separation switching device QS5. See FIG. 4. The third separation switching device QS5 is preferably a MOSFET, or alternatively, may be an IGBT or a bipolar transistor. This switching device has polarity since it includes a body diode in parallel. The anode of the third separation switching device QS5 is connected to the input terminal 3A of the reset/scanning pulse generating section 3, and the cathode of the switching device QS5 is connected to the node J3 of the two switching devices Q5 and Q6.

FIG. 5 is the waveform chart which shows the potential of a scan electrode Y of the PDP 20, and ON times of the switching devices and sections Q5, Q6, Q7, Q8, Q9, Q10, Q11, QR1, QR2, QB, QS1, QS2, QS3, QS4, and QS5 included in the reset/scanning pulse generating section 3 and the main switching devices Q1-Q4 included in the sustaining pulse generating section 1, during reset, address, and sustain periods. In FIG. 5, hatched areas represent the ON times of the switching devices and sections.

During the reset period, the first separation switching section QS3 maintains the OFF state, and the second separation switching section QS4 maintains the ON state, in the case of the first pattern. The third separation switching device QS5 maintains the OFF state in the case of the second pattern. Thereby, the secondary winding 2b of the transformer 2 is separated from the scan electrode Y, and the reset/scanning pulse generating section 3 is connected to the scan electrode Y. At that time, the potential of the scan electrode Y changes due to the application of the reset voltage pulse. The potential changes are divided into the following five modes I-V.

<Mode I>

The low-side switching device Q6, the low-side scan switching device Q9, the low-side auxiliary switching devices Q11, the two separation switching devices QS1 and QS2, and the second separation switching section QS4 maintain the ON states. The other switching devices and sections maintain the OFF states. Thereby, the scan electrode Y is maintained at the ground potential (nearly equal to 0).

<Mode II>

The low-side switching device Q6 is turned off and the high-side switching device Q5 is turned on. The states of the other switching devices and sections are maintained as they are. Thereby, the potential of the scan electrode Y rises from the ground potential by the voltage V1 of the first constant-voltage source E1.

<Mode III>

The first separation switching device QS1 is turned off and the high-side ramp wave generating section QR1 is turned on. The states of the other switching devices and sections are maintained as they are. Thereby, the potential of the scan electrode Y rises at a fixed rate from the potential V1 in the mode II by the voltage V2 of the second constant-voltage source E2. Thus, in all the discharge cells of the PDP 20, the applied voltages rise at a uniform and relatively slow pace to the upper limit V1+V2 of the reset voltage pulses. Then, a uniform wall charge accumulates in every discharge cell of the PDP 20. Here, the rise rates of the applied voltages are low, and accordingly, the light emitted from the discharge cells is suppressed such that it is faint.

<Mode IV>

The high-side switching device Q5 is turned off and the two-way switching section Q7 and the first separation switching device QS1 are turned on. The states of the other switching devices and sections are maintained as they are. Thereby, the potential of the scan electrode Y abruptly drops from the upper limit V1+V2 of the sustaining pulse voltages to a potential higher than the ground potential by the voltage V3 of the third constant-voltage source E3.

<Mode V>

The two-way switching section Q7 and the second separation switching device QS2 are turned off and the low-side ramp wave generating section QR2 is turned on. The states of the other switching devices and sections are maintained as they are. Thereby, the potential of the scan electrode Y falls at a fixed rate from the potential V3 in the mode IV to a potential −V4 lower than the ground potential by the voltage V4 of the fourth constant-voltage source E4. Thus, the uniform voltage of the polarity opposite to that of the applied voltages in the modes II-IV is applied to all the discharge cells of the PDP 20. The applied voltage falls, in particular, at a relatively slow pace. Then, the wall charges of all the discharge cells are uniformly eliminated and become uniform. Here, the fall rates of the applied voltages are low, and accordingly, the light emitted from the discharge cells are suppressed such that it is faint.

During the address period, the first separation switching section QS3 maintains its OFF state, and the second separation switching section QS4 maintains its ON state, in the case of the first pattern. The third separation switching device QS5 maintains its OFF state in the case of the second pattern. Thereby, the secondary winding 2b of the transformer 2 is separated from the scan electrode Y. Furthermore, the bypass switching device QB maintains its ON state. Accordingly, the anode of the low-side scan switching device Q9 is maintained at the potential −V4 (hereafter referred to as the lower limit of the scanning voltage pulses) lower than the ground potential by the voltage V4 of the fourth constant-voltage source E4. On the other hand, the high-side auxiliary switching device Q10 maintains its ON state and the low-side auxiliary switching device Q11 maintains its OFF state. Thereby, the cathode of the high-side scan switching device Q8 is maintained at a potential −V4+V5 (hereafter referred to as the upper limit of the scanning voltage pulses) higher than the lower limit −V4 of the scanning voltage pulses by the voltage V5 of the fifth constant-voltage source E5.

At the start of the address period, for all the scan electrodes Y1, Y2, Y3, . . . (cf. FIG. 1), the high-side scanning switching devices Q8 maintains the ON state and the low-side scan switching devices Q9 maintains the OFF state. Thereby, the potentials of all the scan electrodes Y are maintained uniformly at the upper limit −V4+V5 of the scanning voltage pulses.

The reset/scanning pulse generating section 3 next changes the potentials of the scan electrodes Y1, Y2, Y3, . . . in sequence as follows. See the scanning voltage pulse SP shown in FIG. 5. When a scan electrode Y is selected, of the two scan switching devices connected to the scan electrode Y, the high-side one Q8 is turned off and the low-side one Q9 is turned on. Thereby, the potential of the scan electrode Y falls to the lower limit −V4 of the scanning voltage pulses. After the lapse of a predetermined time, of the two scanning switching devices connected to the scan electrode Y, the low-side one Q9 is turned off and the high-side one Q8 is turned on. Accordingly, the potential of the scan electrode Y returns to the upper limit −V4+V5 of the scanning voltage pulses. The pairs of the scanning switching devices Q8 and Q9 connected to the respective scan electrodes Y1, Y2, Y3, . . . , perform a similar switching operation in sequence. Thus, the scanning voltage pulses SP are applied to the scan electrodes Y1, Y2, Y3, . . . , in sequence.

The scanning voltage pulse is applied to one of the scan electrodes, and at the same time, the addressing voltage pulse is applied to one of the address electrodes. At that time, the voltage between the scan and address electrodes is higher than the voltages between other electrodes. Accordingly, in the discharge cell located in the intersection of the scan and address electrodes, electric discharge occurs and new wall charges accumulate on the surfaces.

During the sustain period, the first separation switching section QS3 maintains its ON state, and the second separation switching section QS4 maintains its OFF state, in the case of the first pattern. The first, second, and third separation switching devices QS1, QS2, and QS5 maintain the ON states in the case of the second pattern. Furthermore, in the reset/scanning pulse generating section 3, the low-side scan switching device Q9 and the low-side auxiliary switching device Q11 maintain the ON states and the other switching devices and sections maintain the OFF states. Thereby, the secondary winding 2b of the transformer 2 is connected to the scan electrode Y. On the other hand, the reset/scanning pulse generating section 3 substantially stops.

During the sustain period, the sustaining pulse generating section 1 applies sustaining pulse voltages Vp between the scan electrode Y and the sustain electrode X as follows. See FIG. 2. At that time, in the discharge cells on which the wall charges accumulate during the address period, discharges successively occur and then, visible light is emitted.

At the start of the sustain period, the first high-side main switching device Q1 and the second low-side main switching device Q4 are turned on. Thereby, a primary voltage pulse VF is applied across the primary winding 2a of the transformer 2 and a secondary voltage pulse is induced across the secondary winding 2b of the transformer 2. At that time, the inductor L resonates with the panel capacitance Cp. Accordingly, the potential of the scan electrode Y, that is, the sustaining pulse voltage Vp rises.

Until after the lapse of a predetermined time equivalent to the pulse width of the sustaining pulse voltage, the control section 30 maintains the first high-side main switching device Q1 and the second low-side main switching device Q4 in the ON states and the other main switching devices Q2 and Q3 in the OFF states. At that time, the sustaining pulse voltage Vp is maintained at its positive peak value. See FIG. 5. That peak value depends on the potential Vs of the input terminal 1T of the sustaining pulse generating section 1 and the winding ratio of the transformer 2. When discharges successively occur in the discharge cell of the PDP 20, the power required for maintenance of a discharging current is supplied to the discharge cell through the input terminal 1T. On the other hand, the voltage Vp across the inductor L is maintained at a fixed level, and accordingly, the current IL flowing through the inductor L linearly increases in the direction of the arrow shown in FIG. 2.

After the lapse of the above-described predetermined time, the control section 30 turns off the first high-side main switching device Q1 and the second low-side main switching device Q4. See FIG. 5. At that time, the resonance occurs between the inductor L and the panel capacitance Cp. At the start of the resonance, due to the flow of the current IL through the inductor L, electricity is promptly discharged from the panel capacitance Cp, and further charged into the capacitance with the opposite polarity. Accordingly, the sustaining pulse voltage Vp promptly falls and its polarity promptly changes from the positive to the negative. See FIG. 5.

When the sustaining voltage pulse Vp reaches its negative peak value, the control section 30 turns on the first low-side main switching device Q2 and the second high-side main switching device Q3. At that time, the voltages across the two main switching devices Q2 and Q3 are substantially equal to zero, and thereby, no switching losses occur. The switching operations maintain the sustaining voltage pulse Vp at the negative peak value. When discharges successively occur in the discharge cell of the PDP 20, the power required for maintenance of the discharging current is supplied to the discharge cell through the input terminal 1T. On the other hand, the voltage Vp across the inductor L is maintained at a fixed level, and accordingly, the current IL flowing through the inductor L linearly increases in the direction opposite to that of the arrow shown in FIG. 2.

After that state is maintained for the above-described predetermined time, the control section 30 turns off the first low-side main switching device Q2 and the second high-side main switching device Q3. At that time, the resonance occurs between the inductor L and the panel capacitance Cp. At the start of the resonance, due to the flow of the current IL through the inductor L, electricity is promptly discharged from the panel capacitance Cp, and further charged into the capacitance with the opposite polarity. Accordingly, the sustaining pulse voltage Vp promptly rises and its polarity promptly changes from the negative to the positive.

During the sustain time, the control section 30 repeats the above-described ON-OFF control over the main switching devices Q1-Q4. Thereby, the sustaining pulse voltage Vp repeats the above-described reversal of polarity. In particular, during the pulse rise and fall times of the sustaining voltage pulse Vp, the inductor L resonates with the panel capacitance Cp in the above-described manner. The resonance reverses the polarity of the sustaining voltage pulse Vp promptly and smoothly. Then, power is exchanged between the inductor L and the panel capacitance Cp with almost no dissipation. In other words, during the resonance periods, the power consumptions are suppressed at resistances (not shown) of the main switching devices Q1-Q4, the sustain electrode X and the scan electrode Y of the PDP 20, and lead wires. Thus, the reactive power caused by the charging and discharging of the panel capacitance Cp is reduced during the sustain period.

At the end of the sustain period, the control section 30 temporarily turns off the two main switching devices that have been in the ON states, (for example, the first low-side main switching device Q2 and the second high-side main switching device Q3,) concurrently with the fall of the last sustaining voltage pulse Vp (of, for example, a negative polarity). At that time, the resonance occurs between the inductor L and the panel capacitance Cp. At the start of the resonance, due to the flow of the current IL through the inductor L, electricity is promptly discharged from the panel capacitance Cp. Accordingly, the potential of the scan electrode Y, i.e. the sustaining pulse voltage Vp, promptly rises. When the sustaining voltage pulse Vp reaches its positive peak value, the control section 30 turns on the first high-side main switching device Q1 and the second low-side main switching device Q4. See the interval VI shown in FIG. 5. Then, a regeneration current flows through the primary winding 2a of the transformer 2 into the input terminal 1T due to the current IL flowing through the inductor L. Immediately before the current IL flowing through the inductor L will be reduced substantially to zero, the control section 30 turns off the first high-side switching device Q1 and the second low-side switching device Q4. Thereby, all the energy left in the inductor L regenerates in the PFC converter 40. The voltage applied during the regeneration period VI immediately after the sustain period, that is, the period when the scan electrode Y is maintained at a high potential, is preferably used as a part of the reset voltage pulse in the next reset period. Thus, at the end of the sustain period, the energy remaining in the inductor L avoids dissipation. Accordingly, the efficiency of the application of the sustaining voltage pulse is improved.

Aside from the above-described, the control section 30 may maintain both the first high-side switching device Q1 and the second low-side switching device Q4 in the OFF states at the end of the sustain period. The discharging current is interrupted during the OFF time, and thereby, no new wall charges are allowed to accumulate in the discharge cells of the PDP 20. Accordingly, a switchover to the next reset period is smooth. Preferably, the voltage changes during the OFF time are used as a part of the reset voltage pulse in the next reset period.

As described above, the PDP driver 10 according to Embodiment 1 of the invention comprises the transformer 2 on the output side of the sustaining pulse generating section 1. The transformer 2 adjusts the proper level of the sustaining voltage pulse Vp and applies the pulse between the sustain electrode X and the scan electrode Y of the PDP 20. Accordingly, no DC-DC converter is required of the PDP driver 10 on the input side of the sustaining pulse generating section 1. Thereby, the component counts of the PDP driver 10 and the area for mounting it are small. Furthermore, the power consumption is low since the power loss by the DC-DC converter is eliminated. In addition, the high voltage Vs sent from the PFC converter 40 is directly applied to the sustaining pulse generating section 1. At that time, the currents inside the sustaining pulse generating section 1 are small. Therefore, the circuit devices can have smaller current capacities. As a result, the sustaining pulse generating section 1 is easy to miniaturize.

The transformer 2 further insulates the PDP 20 on the secondary side from the higher voltage section on the primary side (the part surrounded by the broken lines shown in FIG. 1). Thereby, the PDP driver 10 secures sufficiently high safety.

The inductor L (the magnetizing inductance of the transformer 2 or the auxiliary inductor) resonates with the panel capacitance Cp of the PDP 20 during the pulse rise and fall times of the sustaining voltage pulse Vp as described above, in the PDP driver 10 according to Embodiment 1 of the invention. The resonance reverses the polarity of the voltage Vp across the panel capacitance Cp with almost no power consumption. In other words, during the resonance periods, the power consumptions are suppressed at resistances of the circuit devices of the sustaining pulse generating section 1, the sustain and scan electrodes of the PDP 20, and lead wires. Thus, the reactive power caused by the charging and discharging of the panel capacitance Cp of the PDP 20 is reduced. Furthermore, the inductor L is connected in parallel to the secondary winding 2b of the transformer 2, and thereby, the above-described resonance periods are limited to the pulse rise and fall times of the sustaining voltage pulses Vp. Accordingly, the above-described resonances have no adverse effects on the image reproduced on the PDP 20. In addition, the PDP at the light emission requires no consideration to the ringing caused by the above-described resonance, and therefore, the withstand voltages of the circuit devices of the PDP driver 10 can be low. As a result, no power recovery section is required of the sustaining pulse generating section 1 in the PDP driver 10 according to Embodiment 1 of the invention. Thus, the component counts of the PDP driver 10 and the area for mounting it are still smaller.

The use of the magnetizing inductance of the transformer 2 as the inductor L can eliminate specialized components used as the power recovery means. Accordingly, the component counts of the PDP driver 10 and the area for mounting it are further reduced.

When the auxiliary inductor is used as the inductor L and its inductance is adjusted smaller enough than the magnetizing inductance of the transformer 2, the resonance current mainly flows through the auxiliary inductor and hardly flows to the transformer 2. Accordingly, the copper loss of the transformer 2 is reduced, and therefore, the power consumption of the PDP driver 10 is low.

A current has already flowed through the inductor L (the magnetizing inductance of the transformer 2 or the auxiliary inductor) at the start of the resonance with the panel capacitance Cp of the PDP 20. Therefore, the sustaining voltage pulse Vp quickly rises and falls. In other words, the pulse rise and fall times of the sustaining voltage pulse Vp are shortened. As a result, the number of sub-fields per field is easy to increase, since the sustain period is shortened. Thus, the level number of gray scale of the PDP 20 is easy to increase, that is, the high image quality is easy to improve for the plasma display according to Embodiment 1 of the invention.

The sustaining pulse generating section 1 according to Embodiment 1 of the invention includes the full-bridge inverter shown in FIG. 2. The sustaining pulse generating section may alternatively include a half-bridge inverter, in which a series connection of two capacitors substitutes for one of the series connections of the two main switching devices (for example, Q3 and Q4). In that case, preferably, the turn ratio of the transformer 2 is adjusted to be twice as high as the turn ratio of the transformer 2 included in the full-bridge inverter. Thereby, the effective value of the primary voltage VF of the transformer 2 is cut by half with the output voltage Vs of the PFC converter 40 and the sustaining voltage pulse Vp both maintaining the effective values substantially equal to those for the full-bridge inverter. As a result, the iron loss of the transformer 2 is reduced, and therefore, the power consumption of the PDP driver 10 is low.

### EMBODIMENT 2

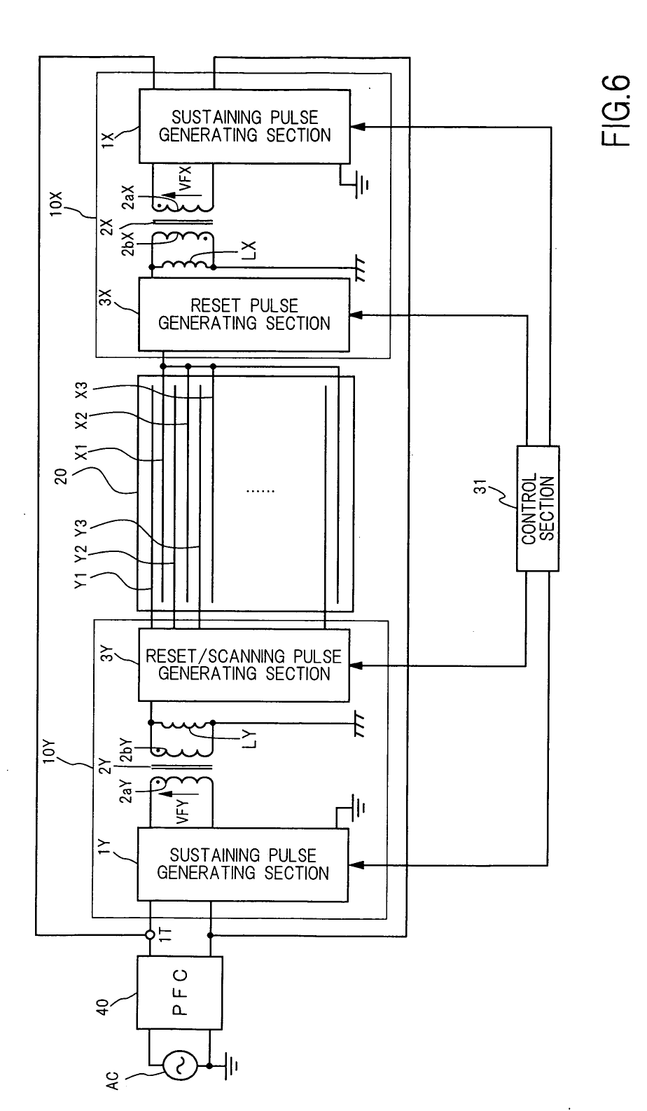

FIG. 6 is the block diagram which shows the configuration of the plasma display according to Embodiment 2 of the invention. In FIG. 6, the components similar to the components shown in FIG. 1 are marked with the same reference symbols as the reference symbols shown in FIG. 1. Furthermore, for the details of the similar components, the explanation about Embodiment 1 is cited.

This plasma display comprises a PFC converter 40, a PDP driver, a PDP 20, and a control section 31. The PDP driver includes a first driver section 10Y and a second driver section 10X.

The first driver section 10Y includes a first sustaining pulse generating section 1Y, a first transformer 2Y, a first inductor LY, and a reset/scanning pulse generating section 3Y. The second driver section 10X includes a second sustaining pulse generating section 1X, a second transformer 2X, a second inductor LX, and a reset pulse generating section 3X. Here, the reset pulse generating section may be included only in either of the first and second driver sections 10Y and 10X.

The input terminal IT of the first sustaining pulse generating section 1Y is connected to the PFC converter 40, and the output terminals of the section 1Y are connected to both ends of the primary winding 2aY of the first transformer 2Y. The first sustaining pulse generating section 1Y includes a switching inverter, and generates a first primary voltage pulse VFY by using the DC power received from the PFC converter 40.

The one end of the secondary winding 2bY of the first transformer 2Y is connected to the reset/scanning pulse generating section 3Y, and the other end of the secondary winding 2bY is grounded. For example, the frame of the PDP 20 (not shown) is used as the ground conductor.

The reset/scanning pulse generating section 3Y is connected to the scan electrodes Y1, Y2, Y3, . . . of the PDP 20. The reset/scanning pulse generating section 3Y includes a switching inverter, and applies reset and scanning voltage pulses to the scan electrodes Y1, Y2, Y3, . . . separately. Furthermore, the reset/scanning pulse generating section 3Y separates the secondary winding 2bY of the first transformer 2Y from the scan electrodes Y1, Y2, Y3, . . . during the reset and address periods, and connects the secondary winding 2bY to the scan electrodes Y1, Y2, Y3, . . . during the sustain period.

The input terminal 1T of the second sustaining pulse generating section 1X is connected to the PFC converter 40, and the output terminals of the section 1X are connected on both ends of the primary winding 2aX of the second transformer 2X. The second sustaining pulse generating section 1X includes a switching inverter and generates a second primary voltage pulse VFX by using the DC power received from the PFC converter 40.

The one end of the secondary winding 2bX of the second transformer 2X is connected to the reset pulse generating section 3X and the other end of the secondary winding 2bX is grounded. As the ground conductor, the ground conductor to which the secondary winding 2bY of the first transformer 2Y is connected, for example, the frame of the PDP 20 is used. Thereby, the secondary winding 2bX of the second transformer 2X is connected to the secondary winding 2bY of the first transformer 2Y through the ground conductor, for example, the frame of the PDP 20. Alternatively, the secondary windings 2bY and 2bX may be connected directly to each other with lead wires.

The reset pulse generating section 3X is connected to the sustain electrodes X1, X2, X3, . . . of the PDP 20. The reset pulse generating-section 3X includes a switching inverter and applies reset voltage pulses to the sustain electrodes X1, X2, X3, . . . at the same time. Furthermore, the reset pulse generating section 3X separates the secondary winding 2bX of the second transformer 2X from the sustain electrodes X1, X2, X3, . . . during the reset and address periods, and connects the secondary winding 2bX to the sustain electrodes X1, X2, X3, . . . during the sustain period.

The two inductors LY and LX are connected in parallel to the secondary windings 2bY and 2bX of the transformers 2Y and 2X, respectively. The inductors LY and LX are preferably the magnetizing inductances of the transformers 2Y and 2X to be connected, respectively. Alternatively, the inductors LY and LX may be elements (auxiliary inductors) separate from the transformers 2Y and 2X, respectively. In that case, the inductances of the auxiliary inductors are preferably smaller enough than the magnetizing inductances of the transformers 2Y and 2X, respectively.

The control section 31 controls the switching operations of the two sustaining pulse generating sections 1Y and 1X, the reset/scanning pulse generating section 3Y, the reset pulse generating section 3X, and the address electrode driver section (not shown) in accordance with the ADS scheme. The control section 31 in particular synchronizes the two primary voltage pulses VFY and VFX. The control section 31 further determines address electrodes to which the addressing voltage pulses are to be applied and sub-fields in which the addressing voltage pulses are to be applied, on the basis of the video signal. As a result, the image corresponding to the video signal is reproduced on the PDP 20.

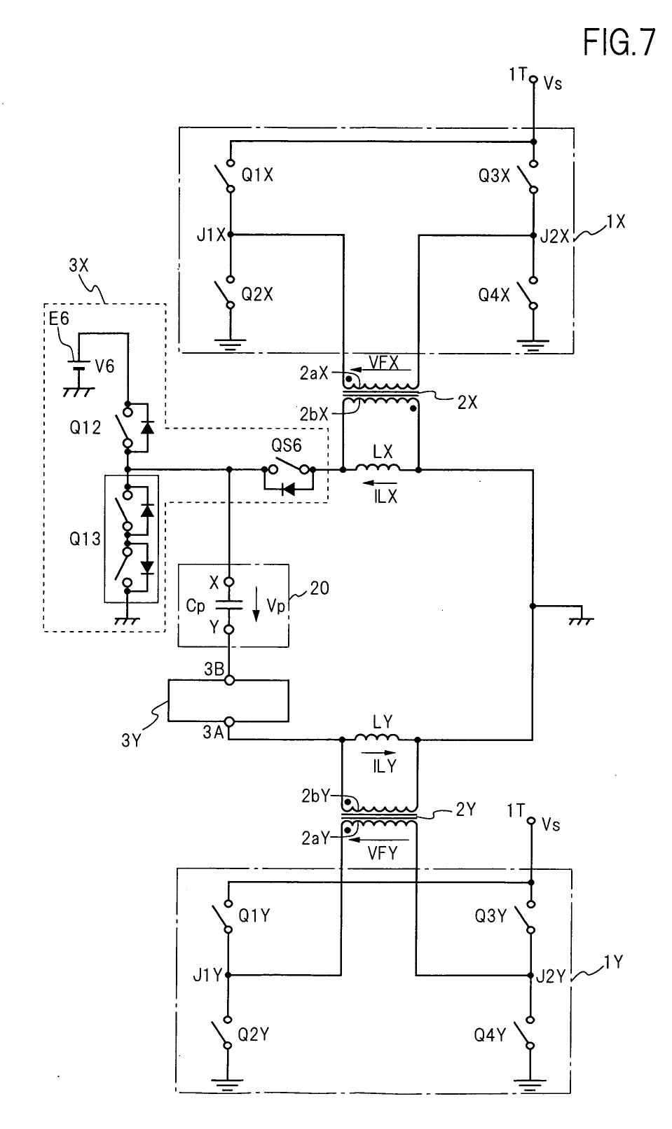

FIG. 7 is the equivalent circuit diagram of the first and second driver sections 10Y and 10X, and the PDP 20. Here, the equivalent circuits of the PDP 20 are represented by a sustain electrode X, a scan electrode Y, and the capacitance between the electrodes X and Y, that is, the panel capacitance Cp in a manner similar to that of FIG. 2. The path of the current flowing through the PDP 20 at the discharge in the discharge cells is omitted.

The two sustaining pulse generating sections 1Y and 1X each have the circuitry in common with the sustaining pulse generating section 1 according to Embodiment 1 and in particular, includes a full-bridge inverter. See FIG. 2. In particular, the characteristics of the common circuit elements are substantially equal between the two sustaining pulse generating sections 1Y and 1X. Similarly, the two transformers 2Y and 2X, and the two inductors LY and LX have substantially equal characteristics. Each of the sustaining pulse generating sections may alternatively include a half-bridge inverter in a manner similar to that of the sustaining pulse generating section according to Embodiment 1.

In FIG. 7, the circuit elements similar to the circuit elements shown in FIG. 2 are marked with the same reference symbols as the reference symbols shown in FIG. 2. In particular, the similar circuit elements of the first and second driver sections 10Y and 10X are marked with the reference symbols shown in FIG. 2 with the addition of the letters “Y” and “X”, respectively. Furthermore, for the details of the similar circuit elements, the explanation about Embodiment 1 is cited.

The reset/scanning pulse generating section 3Y has the circuitry in common with the reset/scanning pulse generating section 3 according to Embodiment 1. See FIGS. 3 and 4. Accordingly, for the details, the explanation about FIGS. 3 and 4 and Embodiment 1 is cited.

The reset pulse generating section 3X includes a sixth constant-voltage source E6, a high-side switching device Q12, a low-side switching section Q13, and a fourth separation switching device QS6.

The sixth constant-voltage source E6 maintains the positive electrode at the potential higher than the potential of the negative electrode by constant voltage V6 (for example, about 150V).

The high-side switching device Q12 and the fourth separation switching device QS6 are preferably MOSFETs, or alternatively, may be IGBTs or bipolar transistors. The switching devices have polarities since they include body diodes in parallel.

The low-side switching section Q13 is a two-way switching section and includes two switching devices. These switching devices are preferably MOSFETs, or alternatively, may be IGBTs or bipolar transistors. The two switching devices have polarities since they include body diodes in parallel. The anodes of the two switching devices are connected to each other and the ON/OFF states are controlled to be always equal.

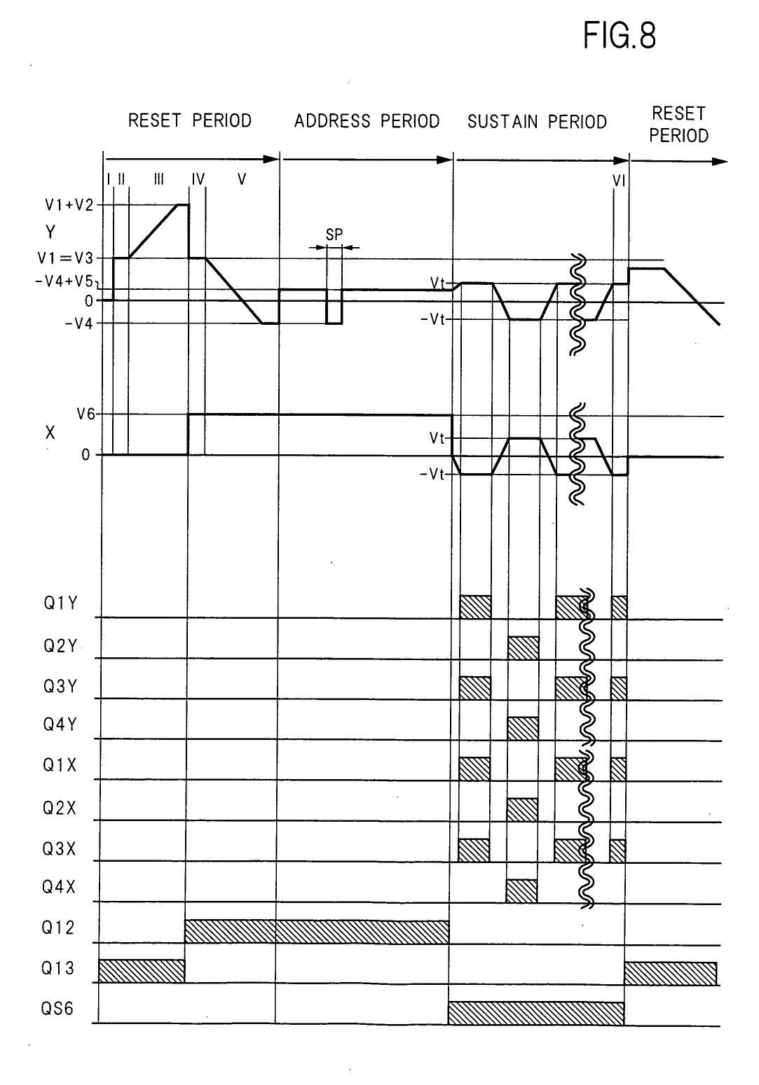

FIG. 8 is the waveform chart which shows the potentials of a scan electrode Y and a sustain electrode X of the PDP 20, and ON times of the main switching devices Q1Y-Q4Y, Q1X-Q4X included in the sustaining pulse generating sections 1Y, 1X, and the switching sections Q12, Q13, and QS6 included in the reset pulse generating section 3X, during reset, address, and sustain periods. In FIG. 8, hatched areas represent the ON times of the switching devices and sections.

The fourth separation switching device QS6 maintains its OFF state over the reset and address period. Thereby, the secondary winding 2bX of the second transformer 2X is separated from the sustain electrode X of the PDP 20. The reset pulse generating section 3X then changes the potential of the sustain electrode X by the application of the reset voltage pulses. The potential is changed in synchronization with the above-described potential changes of the scan electrode Y as follows.

<Modes I-III>

The high-side switching device Q12 maintains its OFF state and the low-side switching section Q13 maintains its ON state. Thereby, the sustain electrode X is maintained at the ground potential (nearly equal to 0).

<Modes IV-V and Address Period>

The high-side switching device Q12 maintains its ON state and the low-side switching section Q13 maintains its OFF state. Thereby, the sustain electrode X is maintained at the potential higher than the ground potential by the voltage V6 of the sixth constant-voltage source E6. When the potential of the sustain electrode X is maintained high during the modes IV-V of the reset period and the address period in such a manner, the voltages V3, V4, and V5 of the third, fourth, and fifth constant-voltage sources E3, E4, and E5 included in the reset/scanning pulse generating section 3Y are, in general, set to be the values different from the values for Embodiment 1, for example, about 175V, about 90V, and about 120V, respectively. Thus, during the modes IV-V of the reset period and the address period, the voltage between the scan and sustain electrodes Y and X changes in a manner similar to that of the voltage for Embodiment 1.

During the sustain time, the fourth separation switching device QS6 maintains its ON state. On the other hand, the high-side switching device Q12 and the low-side switching section Q13 maintain the OFF states. Thereby, the secondary winding 2bX of the second transformer 2X is connected to the sustain electrode X of the PDP 20. On the other hand, the reset pulse generating section 3X substantially stops.

The secondary winding 2bY and 2bX of the two transformers 2Y and 2X are connected to each other, for example, with opposite polarities as shown in FIG. 7. In that case, the control section 31 maintains the switching operations of the two sustaining pulse generating sections 1Y and 1X substantially in phase. In other words, the control section 31 makes the ON and OFF states of the main switching devices of the first sustaining pulse generating section 1Y, for example, Q1Y, coincide with the ON and OFF states of the equivalents of the second sustaining pulse generating section 1X, for example, Q1X. See FIG. 8.

Aside from the example shown in FIG. 7, the secondary windings 2bY and 2bX of the two transformers 2Y and 2X may be connected to each other with the same polarities. The control section 31 maintains the switching operations of the two sustaining pulse generating sections 1Y and 1X substantially in opposite phase.

Each of the switching operations of the two sustaining pulse generating sections 1Y and 1X is common with the switching operation of the sustaining pulse generating section 1 according to Embodiment 1. Accordingly, the potential changes of the scan and sustain electrodes Y and X of the PDP 20 are maintained in opposite phase. Therefore, the sustaining voltage pulse Vp applied between the scan and sustain electrodes Y and X is similar to that according to Embodiment 1. At the rise and fall of the sustaining voltage pulses Vp, in particular, the two inductors LY and LX simultaneously resonate with the panel capacitance Cp of the PDP 20. Power is efficiently exchanged between the panel capacitance Cp and the two inductors LY and LX due to the resonances. As a result, the reactive power caused by the charging and discharging of the panel capacitance Cp is reduced.

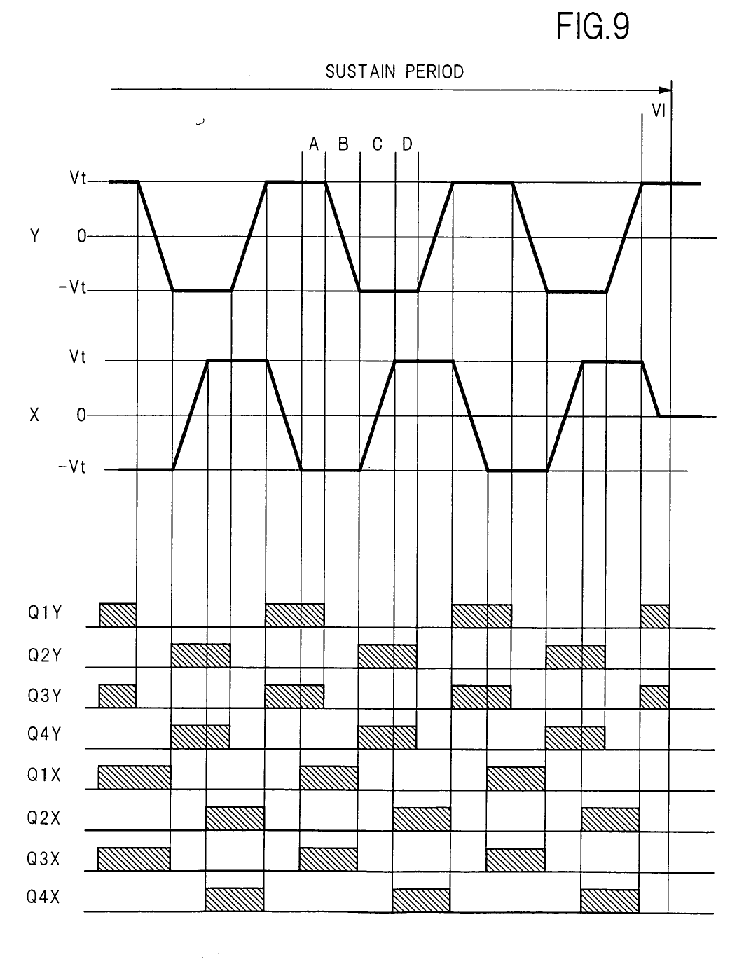

Aside from the above-described switching control, the control section 31 may set the following phase difference between the switching operations of the two sustaining pulse generating sections 1Y and 1X; the phase difference is larger than 0 and smaller than 180°. See FIG. 9. Assume, for example, the case where the secondary windings 2bY and 2bX of the two transformers 2Y and 2X are connected to each other with opposite polarities. See FIG. 7.

In both of the two sustaining pulse generating sections 1Y and 1X, the first high-side main switching devices Q1Y and Q1X and the second low-side main switching devices Q4Y and Q4Y maintain the ON states, and then, the potential of the scan electrode Y is maintained at its positive peak value Vt, and the potential of the sustain electrode X is maintained at its negative peak value −Vt. See the interval A shown in FIG. 9. Accordingly, the sustaining voltage pulse Vp is maintained at its positive peak value 2Vt. Here, the peak value Vt depends on the potential Vs of the common input terminal 1T of the sustaining pulse generating sections 1Y and 1X and the winding ratios of the transformers 2Y and 2X.

After that state is maintained for the predetermined time equivalent to the pulse width of the sustaining voltage pulse, the control section 31 turns off the first high-side main switching device Q1Y and the second low-side main switching device Q4Y of the first sustaining pulse generating section 1Y. In the first sustaining pulse generating section 1Y at that time, the current is substantially equal to zero, and accordingly, no switching losses occur. On the other hand, as for the second sustaining pulse generating section 1X, the ON and OFF states of the four main switching devices Q1X-Q4X are maintained as they are. Under the switching conditions, only the inductor LY connected to the first transformer 2Y resonates with the panel capacitance Cp of the PDP 20. Thereby, the potential of the scan electrode Y falls from its positive peak value Vt. See the interval B shown in FIG. 9. Accordingly, the sustaining pulse voltage Vp falls from its positive peak value 2Vt.

The potential of the scan electrode Y reaches its negative peak value −Vt, and then, the sustaining voltage pulse Vp reaches zero. At that time, the control section 31 turns off the first high-side main switching device Q1X and the second low-side main switching device Q4X of the second sustaining pulse generating section 1X. In the second sustaining pulse generating section 1X, the current is substantially equal to zero, and accordingly, no switching losses occur.

The control section 31 next turns on the first low-side main switching device Q2Y and the second high-side main switching device Q3Y of the first sustaining pulse generating section 1Y. On the other hand, as for the second sustaining pulse generating section 1X, the ON and OFF states of the four main switching devices Q1X-Q4Y are maintained as they are. Under the switching conditions, only the inductor LX connected to the second transformer 2X resonates with the panel capacitance Cp. The potential of the sustain electrode X rises from its negative peak value −Vt due to the resonance. See the interval C shown in FIG. 9. Thus, the polarity of the sustaining voltage pulse Vp changes from the positive to the negative.

The potential of the sustain electrode X reaches its positive peak value Vt, and then, the sustaining voltage pulse Vp reaches its negative peak value −2Vt. At that time, the control section 31 turns on the first low-side main switching device Q2X and the second high-side main switching device Q3X of the second sustaining pulse generating section 1X. Here, the voltages across the switching device Q2X and Q3X are substantially equal to zero, and accordingly, no switching losses occur. Under the switching conditions, the potential of the sustain electrode X is fixed at its positive peak value Vt, and thereby, the sustaining voltage pulse Vp is fixed at its negative peak value −2Vt. See the interval D shown in FIG. 9.

Similarly, when changing the polarity of the sustaining voltage pulse Vp from the negative to the positive, the control section 31 delays the switching operation of the second sustaining pulse generating section 1X with respect to the switching operation of the first sustaining pulse generating section 1Y. Under such a switching control, the two inductors LY and LX alternately resonate with the panel capacitance Cp of the PDP 20 at every rise and fall of the sustaining voltage pulse Vp. Power is efficiently exchanged between the panel capacitance Cp and the two inductors LY and LX due to those resonances. As a result, the reactive power caused by the charging and discharging of the panel capacitance Cp is reduced.

At the end of the sustain period, the control section 31 may further regenerate all the energy left in the two inductors LY and LX in the PFC converter 40 by a switching control similar to that of the control section 30 according to Embodiment 1. See the interval VI shown in FIGS. 8 and 9. Thereby, the efficiency of the application of the sustaining voltage pulse is improved.

The PDP driver according to Embodiment 2 of the invention comprises the two sustaining pulse generating sections 1Y and 1X as described above. During the sustain period, the power required for the charging and discharging of the panel capacitance Cp is supplied to the PDP 20 through both of the two sustaining pulse generating sections 1Y and 1X. In particular, for a fixed sustaining voltage pulse Vp, the current flowing inside each of the sustaining pulse generating sections 1Y and 1X may be half of the current flowing inside the sustaining pulse generating section 1 according to Embodiment 1. Accordingly, the circuit elements included in the sustaining pulse generating sections 1Y and 1X can have smaller current capacities. As a result, the sustaining pulse generating sections 1Y and 1X are easy to miniaturize.

The PDP driver according to Embodiment 2 of the invention further comprises the transformers 2Y and 2X on the output sides of the two sustaining pulse generating sections 1Y and 1X, respectively. In addition, the inductors LY and LX are connected to the secondary windings 2bY and 2bX of the transformers 2Y and 2X, respectively, similarly to Embodiment 1. The transformers 2Y and 2X and the inductors LY and LX produce the effects similar to those of the transformer 2 and the inductor L according to Embodiment 1.

The secondary winding 2bY and 2bX of the two transformers 2Y and 2X are connected in series to the panel capacitance Cp of the PDP 20, in particular, in the PDP driver according to Embodiment 2 of the invention. See FIGS. 6 and 7. In that case, for a fixed sustaining voltage pulse Vp, each secondary voltage of the transformers 2Y and 2X may be half of the secondary voltage of the transformer 2 according to Embodiment 1. Accordingly, the PDP driver is further easier to miniaturize since the withstand voltages of the transformers 2Y and 2X can be low.

For the PDP driver according to Embodiment 2 of the invention, each current and voltage of the sustaining pulse generating sections 1Y and 1X is half of the current and voltage of the sustaining pulse generating section 1 according to Embodiment 1, respectively, as described above. In that case, the power consumption of each of the sustaining pulse generating sections 1Y and 1X is substantially equal to ¼ of the power consumption of the sustaining pulse generating section 1 according to Embodiment 1. In other words, the total power consumption of the two sustaining pulse generating sections 1Y and 1X is substantially equal to ½ of the power consumption of the sustaining pulse generating section 1 according to Embodiment 1. Thus, the PDP driver according to Embodiment 2 has an advantage in power reduction over the PDP driver according to Embodiment 1.

### EMBODIMENT 3

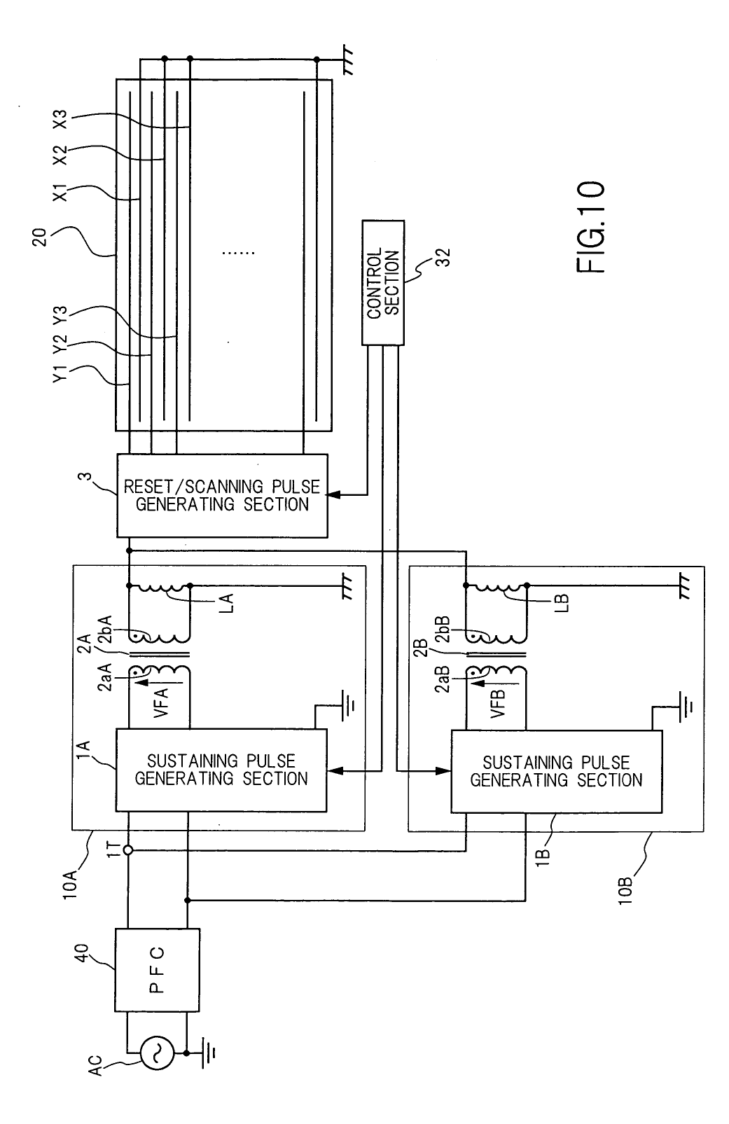

FIG. 10 is the block diagram which shows the configuration of plasma display according to Embodiment 3 of the invention. In FIG. 10, the components similar to the components shown in FIG. 1 are marked with the same reference symbols as the reference symbols shown in FIG. 1. Furthermore, for the details of the similar components, the explanation about Embodiment 1 is cited.

This plasma display comprises a PFC converter 40, a PDP driver, a PDP 20, and a control section 32. The PDP driver includes a first driver section 10A, a second driver section 10B, and a reset/scanning pulse generating section 3. The first driver section 10A includes a first sustaining pulse generating section 1A, a first transformer 2A, and a first inductor LA. The second driver section 10Ba includes a second sustaining pulse generating section 1B, a second transformer 2B, and a second inductor LB.

In this plasma display, each of the secondary windings 2bA and 2bB of the two transformers 2A and 2B is connected in parallel to the PDP 20 as follows, in contrast to the plasma display according to Embodiment 2 (cf. FIG. 6). The output terminals of the first sustaining pulse generating section 1A are connected to both ends of the primary winding 2aA of the first transformer 2A. The output terminals of the second sustaining pulse generating section 1B are connected to both ends of the primary winding 2aB of the second transformer 2B. The one end of each of the secondary windings 2bA and 2bB of the two transformers 2A and 2B is connected to the reset/scanning pulse generating section 3, and the other ends of the secondary windings 2bA and 2bB are grounded. On the other hand, the sustain electrodes X1, X2, X3, . . . of the PDP 20 are grounded. As their ground conductor, a common ground conductor, for example, the frame of the PDP 20 (not shown) is used. Alternatively, both secondary windings 2bA and 2bB of the two transformers 2A and 2B may be connected directly to the sustain electrodes X1, X2, X3, . . . with leading wires. The reset/scanning pulse generating section 3 separates the secondary windings 2bA and 2bB of the two transformers 2A and 2B from the scan electrodes Y1, Y2, Y3, . . . during the reset and address periods, and connects the secondary windings 2bA and 2bB to the scan electrodes Y1, Y2, Y3, . . . during the sustain period.

Aside from FIG. 10, the one end of each of the secondary windings 2bA and 2bB of the two transformers 2A and 2B may be connected to the sustain electrodes X1, X2, X3, . . . of the PDP 20 through a separation switch, and the other ends of the secondary windings 2bA and 2bB may be grounded. In that case, the separation switch connects the sustain electrodes X1, X2, X3, . . . to the secondary windings 2bA and 2bB of the two transformers 2A and 2B during the sustain period; the separation switch separates the sustain electrodes from the secondary windings 2bA and 2bB and grounds the sustain electrodes during the reset/address periods. On the other hand, the reset/scanning pulse generating section 3 grounds the scan electrodes Y1, Y2, Y3, . . . during the sustain period.

The two inductors LA and LB are connected in parallel to the secondary windings 2bA and 2bB of the transformers 2A and 2B, respectively. The inductors LA and LB are preferably the magnetizing inductances of the transformers 2A and 2B, respectively. Alternatively, the inductors LA and LB may be elements (auxiliary inductors) separate from the transformers 2A and 2B. In that case, the inductances of the auxiliary inductors are preferably smaller enough than the magnetizing inductances of the transformers 2A and 2B.

The control section 32 controls the switching operations of the two sustaining pulse generating sections 1A and 1B, the reset/scanning pulse generating section 3, and an address electrode driver section (not shown), according to the ADS scheme. The control section 32 in particular synchronizes the primary voltage pulses VFA and VFB of the two sustaining pulse generating sections 1A and 1B. The control section 32 further determines, based on the video signal, address electrodes to which addressing voltage pulses are to be applied and sub-fields in which the addressing voltage pulses are to be applied. As a result, the image corresponding to the video signal is reproduced on the PDP 20.

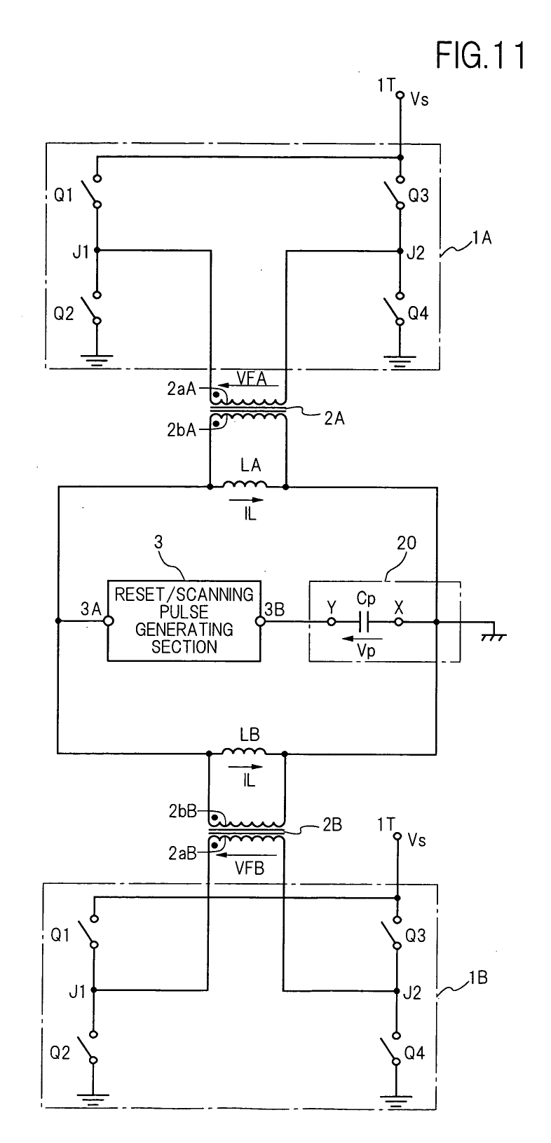

FIG. 11 is the equivalent circuit diagram of the first and second driver sections 10A and 10B and the PDP 20. Here, the equivalent circuit of the PDP 20 is represented only by a sustain electrode X, a scan electrode Y, and the capacitance between the electrodes X and Y, that is, the panel capacitance Cp, similarly to the circuit shown in FIG. 2. The path of the current flowing inside the PDP 20 at the discharge in the discharge cells is omitted. The two sustaining pulse generating sections 1A and 1B both have the circuitry in common with the sustaining pulse generating section 1 according to Embodiment 1, and in particular include a full-bridge inverter. See FIG. 2. In particular, the characteristics of the common circuit elements are substantially equal between the two sustaining pulse generating sections 1A and 1B. Similarly, the two transformers 2A and 2B and the two inductors LA and LB have substantially equal characteristics, respectively. Alternatively, each sustaining pulse generating section may include a half-bridge inverter similarly to the sustaining pulse generating section according to Embodiment 1.

In FIG. 11, the circuit elements similar to the circuit elements shown in FIG. 2 are marked with the same reference symbols as the reference symbols shown in FIG. 2. Furthermore, for the details of those similar circuit elements, the explanation about Embodiment 1 is cited.

The secondary windings 2bA and 2bB of the two transformers 2A and 2B are connected to each other, for example, with the same polarity as shown in FIG. 11. In that case, the control section 32 maintains the switching operations of the two sustaining pulse generating sections 1A and 1B substantially in phase. In other words, the control section 32 makes the ON and OFF states of the main switching devices of the first sustaining pulse generating section 1A coincide with the ON and OFF states of the equivalents of the second sustaining pulse generating section 1B.

Aside from the example shown in FIG. 11, the secondary windings 2bA and 2bB of the two transformers 2A and 2B may be connected to each other with opposite polarities. In that case, the control section 32 maintains the switching operations of the two sustaining pulse generating sections 1A and 1B substantially in opposite phase.

Each of the two sustaining pulse generating sections 1A and 1B performs the switching operation in common with the switching operation of the sustaining pulse generating section 1 according to Embodiment 1. Accordingly, during the sustain period, the potential changes of the scan electrode Y of the PDP 20 are similar to the potential changes according to Embodiment 1. See FIG. 5. In other words, the sustaining voltage pulse Vp is similar to that according to Embodiment 1. At the rises and falls of the sustaining voltage pulse Vp, in particular, the two inductors LA and LB simultaneously resonate with the panel capacitance Cp of the PDP 20. Power is efficiently exchanged between the panel capacitance Cp and the two inductors LA and LB due to the resonances. As a result, the reactive power caused by the charging and discharging of the panel capacitance Cp is reduced.

At the end of the sustain period, the control section 32 may further regenerate all the energy left in the two inductors LA and LB in the PFC converter 40 by a switching control similar to that of the control section 30 according to Embodiment 1. Thereby, the efficiency of the application of the sustaining voltage pulse is improved.

The PDP driver according to Embodiment 3 of the invention comprises the two sustaining pulse generating sections 1A and 1B as described above. During the sustain period, the power required for the charging and discharging of the panel capacitance Cp is supplied to the PDP 20 through both of the two sustaining pulse generating sections 1A and 1B. In particular, for a fixed sustaining voltage pulse Vp, the current flowing inside each of the sustaining pulse generating sections 1A and 1B may be half of the current flowing inside the sustaining pulse generating section 1 according to Embodiment 1. Accordingly, the circuit elements included in the sustaining pulse generating sections 1A and 1B can have smaller current capacities. As a result, the sustaining pulse generating sections 1A and 1B are easy to miniaturize.

The PDP driver according to Embodiment 3 of the invention further comprises the transformers 2A and 2B on the output sides of the two sustaining pulse generating sections 1A and 1B, respectively. In addition, the inductors LA and LB are connected to the secondary windings 2bA and 2bB of the transformers 2A and 2B, respectively, similarly to Embodiment 1. The transformers 2A and 2B and the inductors LA and LB produce the effects similar to those of the transformer 2 and the inductor L according to Embodiment 1.

The PDP driver according to Embodiment 3 of the invention the two driver sections 10A and 10B are put together on the same side with respect to the PDP 20, in contrast to the device according to Embodiment 2. See FIG. 10. In that case, for example, effective heat and noise control measures are easier since the heat and noise sources included in the two driver sections 10A and 10B are placed within the limited range.

### EMBODIMENT 4

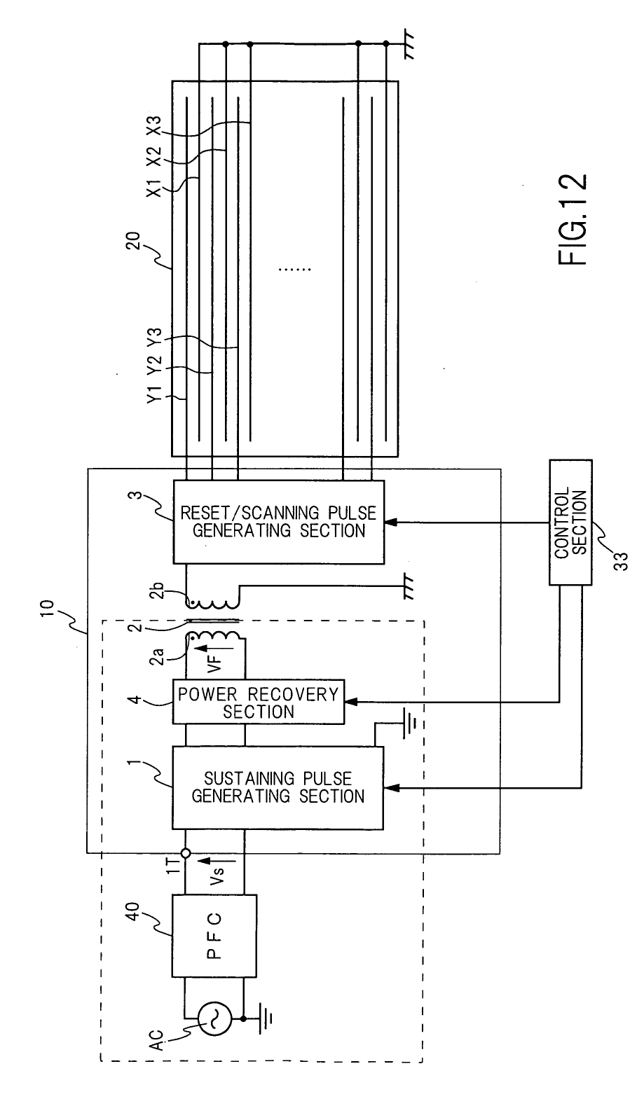

In the plasma display according to Embodiment 4 of the invention, the PDP driver 10 includes a power recovery section 4 on the primary side of the transformer 2 instead of the inductor L in contrast to the plasma display according to Embodiment 1. See FIG. 12. Except for that point, both the plasma displays have similar configuration. See also FIG. 1. In FIG. 12, the components similar to the components shown in FIG. 1 are marked with the same reference symbols as the reference symbols shown in FIG. 1. Furthermore, for the details of the similar components, the explanation about Embodiment 1 is cited.

The power recovery section 4 is connected to the primary winding 2a of the transformer 2 and includes an inductor and a switching section. The switching section is turned on, for example, at every rise and fall of the primary voltage pulses VF sent from the sustaining pulse generating section 1, and connects the inductor to the primary winding 2a of the transformer 2. The inductor then resonates with the panel capacitance of the PDP 20 through the transformer 2.

The control section 33 controls the switching operations of the sustaining pulse generating section 1, the reset/scanning pulse generating section 3, and an address electrode driver section (not shown) under the ADS scheme, in a manner similar to that of the control section 30 according to Embodiment 1. The control section 33 further controls the switching operation of the power recovery section 4, thereby synchronizing it with the switching operation of the sustaining pulse generating section 1 during the sustain period.

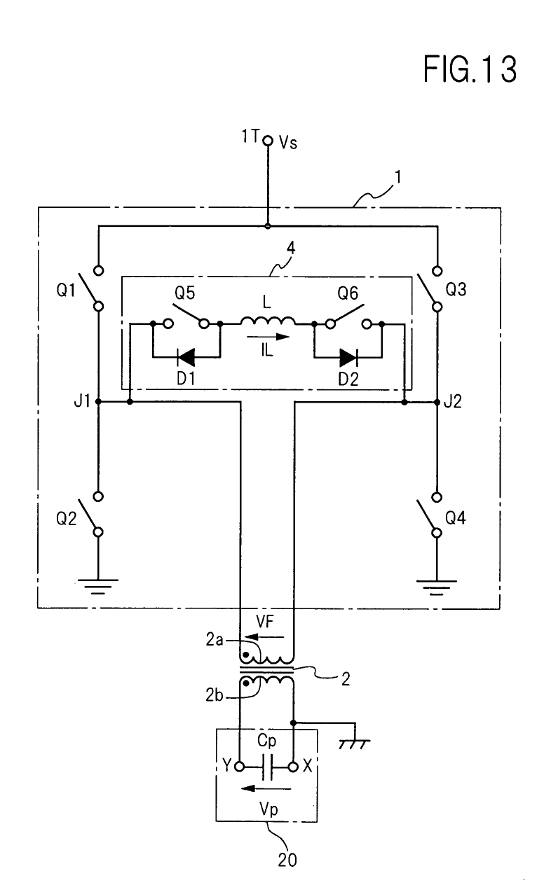

FIG. 13 is the equivalent circuit diagram of the sustaining pulse generating section 1, the power recovery section 4, the transformer 2, and the PDP 20. In FIG. 13, the components similar to the components shown in FIG. 2 are marked with the same reference symbols as the reference symbols shown in FIG. 2. Furthermore, for the details of those similar components, the explanation about Embodiment 1 is cited.

The reset/scanning pulse generating section 3 is connected to the position shown in FIG. 2, and simply short-circuits between the secondary winding 2b and the scan electrode Y of the transformer 2 during the sustain period. The reset/scanning pulse generating section 3 is omitted in FIG. 13.

The power recovery section 4 includes two recovery switching devices Q5, Q6, two diodes D1, D2, and an inductor L. The two recovery switching devices Q5 and Q6 are preferably MOSFETs, or alternatively, may be IGBTs or bipolar transistors. The two diodes D1 and D2 are connected in parallel to the recovery switching devices Q5 and Q6, respectively. Thereby, the parallel connection of the recovery switching device and the diode has polarity. When the recovery switching devices Q5 and Q6 are MOSFETs, the diode D1 and D2 may be the body diodes of the recovery switching devices Q5 and Q6. The inductor L is preferably an element separate from the transformer 2, or alternatively, may be the leakage inductance of the transformer 2. The two recovery switching devices Q5 and Q6 are connected to the inductor L in series. The series connection is connected in parallel to the primary winding 2a of the transformer 2. The terminals with the same polarities of the parallel connections of the recovery switching device and the diode (Q5 and D1, Q6 and D2) are connected to each other through the inductor L (or directly). In FIG. 13, for example, the anodes of the two diodes D1 and D2 are connected to each other through the inductor L. Thus, the two recovery switching devices Q5 and Q6 and the two diodes D1 and D2 constitute a two-way switch.

The configuration of the two-way switch is not limited to the example shown in FIG. 13; the two-way switch may have any configuration that can reverse the current IL flowing through the inductor L. For example, switching devices may be substituted for the two diodes D1 and D2. In that case, the control section 33 controls the turn-on and off of those switching devices to coincide with the turn-on and off of the original diodes D1 and D2. Alternatively, the two-way switch may be two series connections of a switching device and a diode; the two series connections are connected in parallel to each other with opposite polarities.

The control section 33 (cf. FIG. 12) changes the polarity of the voltage across the panel capacitance Cp, that is, the sustaining voltage pulse Vp from the positive to the negative by the ON-OFF control over the main switching devices Q1-Q4 and the recovery switching devices Q5 and Q6 as follows.

The first high-side main switching device Q1 and the second low-side main switching device Q4 maintain the ON states and other switching devices Q2, Q3, Q5, and Q6 maintain the OFF states. At that time, the potential of the scan electrode Y, that is, the sustaining voltage pulse Vp is maintained at the positive peak value. Here, the peak value depends on the potential Vs of the input terminal 1T of the sustaining pulse generating section 1 and the winding ratio of the transformer 2. When discharges successively occur in the discharge cell of the PDP 20, the power required for maintenance of the discharging current is supplied from the PFC converter 40 to the PDP 20 through the input terminal 1T and the transformer 2.

After that state is maintained for the predetermined time equivalent to the pulse width of the sustaining voltage pulse, the control section 33 turns off the first high-side main switching device Q1 and the second low-side main switching device Q4 and turns on the first recovery switching device Q5. At the two main switching devices Q1 and Q4, at that time, the current is substantially equal to zero, and accordingly, no switching losses occur. The switching conditions brings a loop into conduction; the loop includes the primary winding 2a of the transformer 2 the first recovery switching device Q5 the inductor L the second diode D2 the primary winding 2a of the transformer 2 in order. The arrows represent the direction of current. See FIG. 13. At that time, the inductor L resonates with the panel capacitance Cp through the transformer 2. The resonance current IL flows through the above-described loop in the directions of the arrows. The potential of the scan electrode Y further falls from its positive peak value. The sustaining voltage pulse Vp then falls since the sustain electrode X is maintained at the ground potential.

The potential of the scan electrode Y, that is, the sustaining voltage pulse Vp reaches its negative peak value. At the same time, the second diode D2 is turned off since the resonance current IL is reduced substantially to zero. At that time, the control section 33 turns off the first recovery switching device Q5 and turns on the first low-side main switching device Q2 and the second high-side main switching device Q3. The current is substantially equal to zero in the first recovery switching device Q5, and accordingly, no switching losses occur. The voltage across each of the two main switching devices Q2 and Q3 is equal to zero, and accordingly, no switching losses occur. Thus, the sustaining voltage pulse Vp is clamped at its negative peak value. When discharges successively occur in the discharge cell of the PDP 20, the power required for maintenance of the discharging current is supplied from the PFC converter 40 to the PDP 20 through the input terminal 1T and the transformer 2.

Similarly, the control section 33 changes the polarity of the sustaining pulse voltage Vp from the negative to the positive by the ON-OFF control over the main switching devices Q1-Q4 and the recovery switching devices Q5 and Q6.

When the polarity of the sustaining voltage pulse Vp is reversed, the inductor L of the power recovery section 4 resonates with the panel capacitance Cp of the PDP 20 as described above. The resonance reverses the polarity of the sustaining voltage pulse Vp with almost no dissipation. As a result, the reactive power caused by the charging and discharging of the panel capacitance Cp of the PDP 20 is reduced.

As described-above, the PDP driver according to Embodiment 4 of the invention comprises the transformer 2 on the output side of the sustaining pulse generating section 1, similarly to the driver according to Embodiment 1. The transformer 2 produces the effects similar to those of the transformer 2 according to Embodiment 1.

Furthermore, the power recovery section 4 reduces the reactive power caused by the charging and discharging of the panel capacitance in the PDP driver according to Embodiment 4 of the invention. In the power recovery section 4, in particular, the ON times of the recovery switching devices Q5 and Q6 accurately coincide with the pulse rise and fall times of the sustaining voltage pulses Vp, as described above. In other words, no current flows through the inductor L except those periods. Thus, the resonance period of the inductor L and the panel capacitance Cp is reliably limited to the pulse rise and fall times of the sustain pulse voltage Vp.

### EMBODIMENT 5

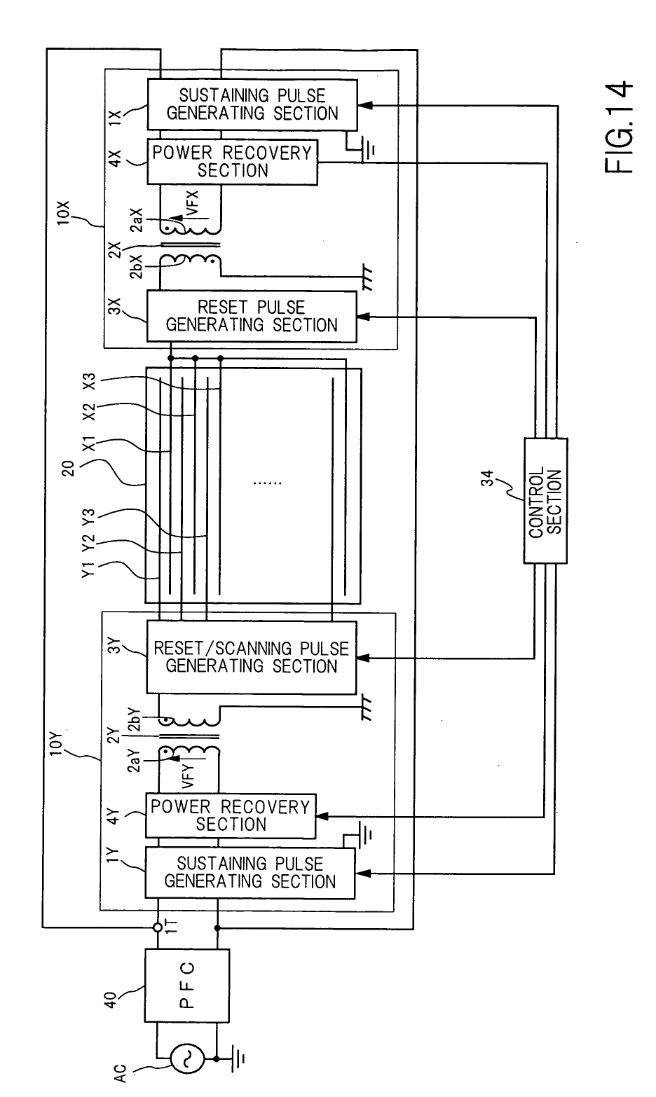

In the plasma display according to Embodiment 5 of the invention, the two driver sections 10Y and 10X include the respective power recovery sections 4Y and 4X on the primary sides of the transformers 2Y and 2X, instead of the inductors LY and LX, in contrast to the plasma display according to Embodiment 2. See FIG. 14. Except for that point, both of the plasma displays have the similar configuration. See FIG. 6. In FIG. 14, the components similar to the components shown in FIG. 6 are marked with the same reference symbols as the reference symbols shown in FIG. 6. Furthermore, for the details of the similar components, the explanation about Embodiment 2 is cited.

In the driver sections 10Y and 10X, the configurations of the sustaining pulse generating sections 1Y and 1X, the power recovery sections 4Y and 4X, and the transformers 2Y and 2X are similar to the configuration of the sustaining pulse generating section 1, the power recovery section 4, and the transformer 2 according to Embodiment 4. In particular, the characteristics of the circuit elements corresponding to each other are substantially equal.

The control section 34 controls the switching operations of the two sustaining pulse generating sections 1Y and 1X, the reset/scanning pulse generating section 3Y, the reset pulse generating section 3X, and an address electrode driver section (not shown) under the ADS scheme, similarly to the control section 31 according to Embodiment 2.

During the sustain period, the control section 34 further controls the switching operations of the power recovery section 4Y and 4X in synchronization with the switching operations of the sustaining pulse generating sections 1Y and 1X. In addition, the control section 34 synchronizes the two primary voltage pulses VFY and VFX sent from the two sustaining pulse generating sections 1Y and 1X.

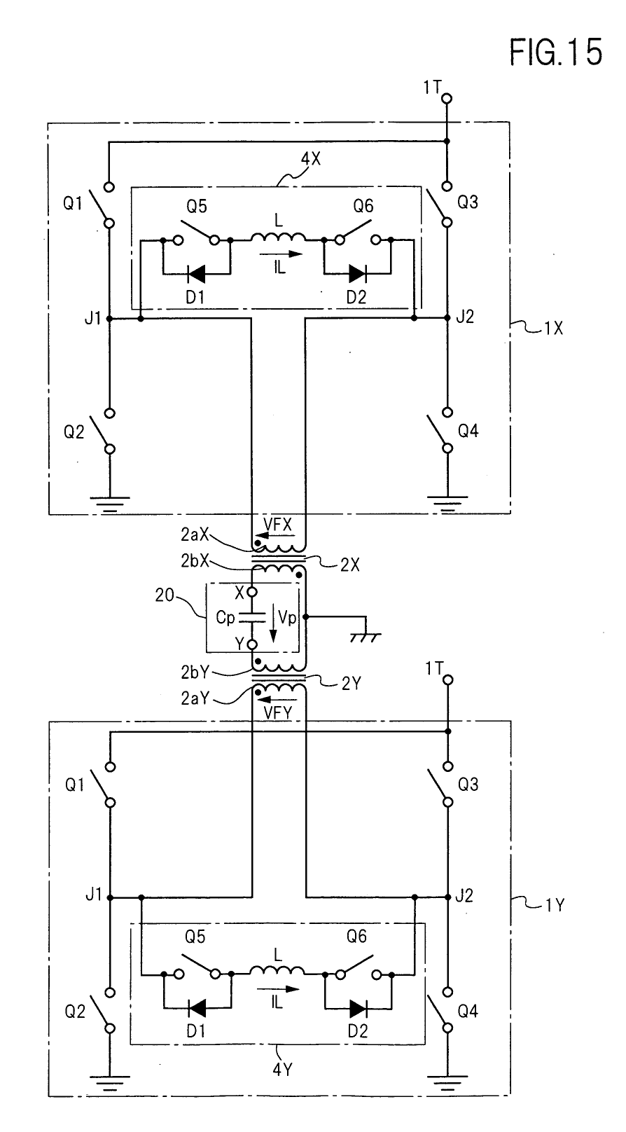

FIG. 15 is the equivalent circuit diagram of the two sustaining pulse generating sections 1Y and 1X, the two power recovery sections 4Y and 4X, the two transformers 2Y and 2X, and the PDP 20. In FIG. 15, the components similar to the components shown in FIG. 7 are marked with the same reference symbols as the reference symbols shown in FIG. 7. Furthermore, for the details of the similar components, the explanation about Embodiment 2 is cited.

The reset/scanning pulse generating section 3Y is connected to the position shown in FIG. 7 and simply short-circuits between the secondary winding 2bY of the first transformer 2Y and the scan electrode Y during the sustain period. The reset pulse generating section 3X is connected to the position shown in FIG. 7 and simply short-circuits between the secondary winding 2bX of the second transformer 2X and the sustain electrode X during the sustain period. The reset/scanning pulse generating section 3Y and the reset pulse generating section 3X are omitted in FIG. 15.

The secondary windings 2bY and 2bX of the two transformers 2Y and 2X are connected to each other, for example, with opposite polarities as shown in FIG. 15. In that case, the control section 34 maintains the switching operations of the two sustaining pulse generating sections 1Y and 1X and the switching operations of the two power recovery sections 4Y and 4X substantially in phase.

Aside from the example shown in FIG. 15, the secondary windings 2bY and 2bX of the two transformers 2Y and 2X may be connected to each other with the same polarity. In that case, the control section 34 maintains the switching operations of the two sustaining pulse generating sections 1Y and 1X and the switching operations of the power recovery sections 4Y and 4X substantially in opposite phase.

The two sustaining pulse generating sections 1Y and 1X and the two power recovery sections 4Y and 4X perform the switching operations in common with the switching operations of the sustaining pulse generating section 1 and the power recovery section 4 according to Embodiment 4. Accordingly, the potential changes of the scan and sustain electrodes Y and X of the PDP 20 are maintained in opposite phase. Therefore, the sustaining voltage pulse Vp applied between the scan and sustain electrodes Y and X is similar to that according to Embodiment 4. In particular, the inductors L of the power recovery sections 4Y and 4X simultaneously resonate with the panel capacitance Cp of the PDP 20 at every rise and fall of the sustaining voltage pulse Vp. Power is efficiently exchanged between the inductors L and the panel capacitance Cp due to those resonances. As a result, the reactive power caused by the charging and discharging of the panel capacitance Cp is reduced.

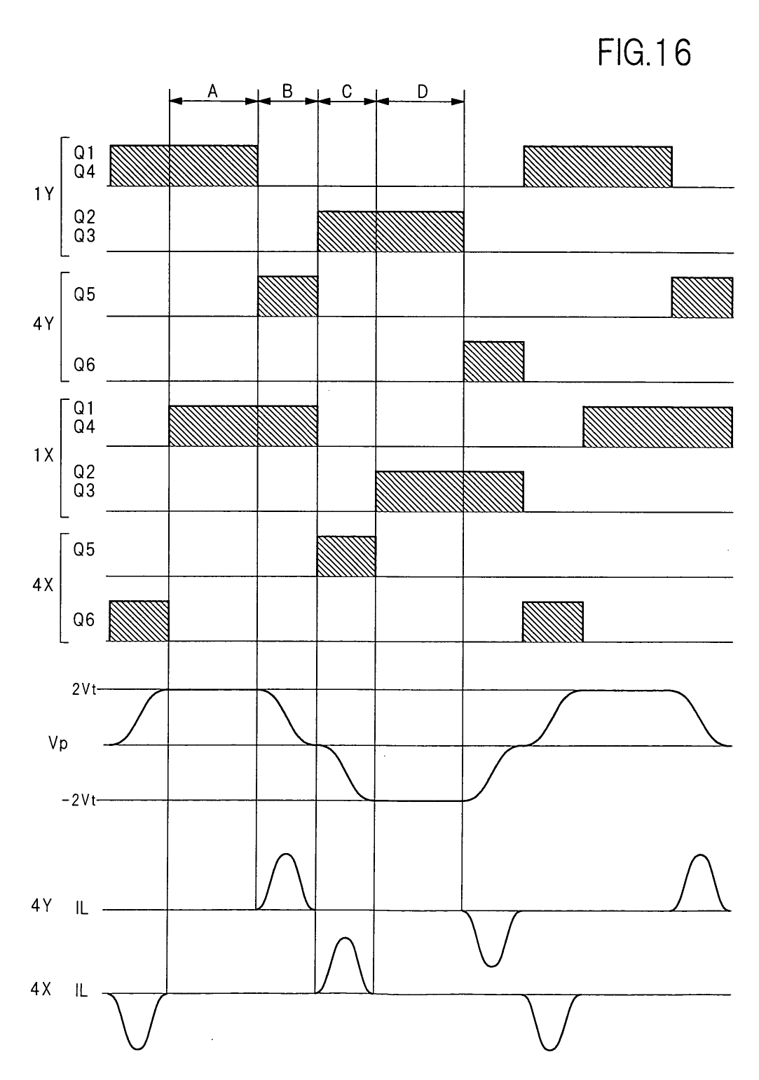

Aside from the above-described switching control, the control section 34 may set the following phase difference between the switching operations of the two sustaining pulse generating sections 1Y and 1X; the phase difference is larger than 0° and smaller than 180°. See FIG. 16.

Assume, for example, the case where the secondary windings 2bY and 2bX of the two transformers 2Y and 2X are connected to each other with opposite polarities. See FIG. 15. In each of the two sustaining pulse generating sections 1Y and 1X, the first high-side main switching device Q1 and the second low-side main switching device Q4 maintain the ON states and other switching devices Q2, Q3, Q5, and Q6 maintain the OFF states. At that time, the potential of the scan electrode Y is maintained at its positive peak value Vt, and the potential of the sustain electrode X is maintained at its negative peak value −Vt. See the interval A shown in FIG. 16. Accordingly, the sustaining voltage pulse Vp is maintained at its positive peak value 2Vt. Here, the peak value Vt depends on the potential Vs of the input terminal 1T of the sustaining pulse generating sections 1Y and 1X and the winding ratios of the transformers 2Y and 2X.

After that state is maintained for the predetermined time equivalent to the pulse width of the sustaining voltage pulse, the control section 34 turns off the first high-side main switching device Q1 and the second low-side main switching device Q4 of the first sustaining pulse generating section 1Y. In the first sustaining pulse generating section 1Y at that time, the current is substantially equal to zero, and accordingly, no switching losses occur. On the other hand, as for the second sustaining pulse generating section 1X, the ON and OFF states of the four main switching devices Q1-Q4 are maintained as they are. The control section 34 further turns on the first recovery switching device Q5 of the first power recovery section 4Y. Under the switching conditions, only the inductor L of the first power recovery section 4Y resonates with the panel capacitance Cp of the PDP 20. The resonance current IL flows through the inductor L of the first power recovery section 4Y and the potential of the scan electrode Y falls from its positive peak value Vt. See the interval B shown in FIG. 16. Accordingly, the sustain pulse voltage Vp falls from its positive peak value 2Vt.

The potential of the scan electrode Y reaches its negative peak value −Vt, and then, the sustaining voltage pulse Vp reaches zero. At the same time, the resonance current IL is reduced substantially to zero, and accordingly, the second diode D2 is turned off in the first power recovery section 4Y. At that time, the control section 34 turns off the first high-side main switching device Q1 and the second low-side main switching device Q4 of the second sustaining pulse generating section 1X. In the second sustaining pulse generating section 1X, the current is substantially equal to zero, and accordingly, no switching losses occur. The control section 34 further turns off the first recovery switching device Q5 of the first power recovery section 4Y. At that time, the resonance current IL is substantially equal to zero, and accordingly, no switching losses occur. The control section 34 next turns on the first low-side main switching device Q2 and the second high-side main switching device Q3 of the first sustaining pulse generating section 1Y. On the other hand, as for the second sustaining pulse generating section 1X, the ON and OFF states of the four main switching devices Q1-Q4 are maintained as they are. The control section 34 further turns on the first recovery switching device Q5 of the second power recovery section 4X. Under the switching conditions, only the inductor L of the second power recovery section 4X resonates with the panel capacitance Cp. The resonance current IL flows through the inductor L of the second power recovery section 4X and the potential of the sustain electrode X rises from its negative peak value −Vt. See the interval C shown in FIG. 16. Thus, the polarity of the sustaining voltage pulse Vp changes from the positive to the negative.

The potential of the sustain electrode X reaches its positive peak value Vt, and then, the sustaining voltage pulse Vp reaches its negative peak value −2Vt. At the same time, the resonance current IL is reduced substantially to zero, and accordingly, the second diode D2 is turned off in the second power recovery section 4X. At that time, the control section 34 turns off the first recovery switching device Q5 of the second power recovery section 4X. Here, the resonance current IL is substantially equal to zero, and accordingly, no switching losses occur. The control section 34 further turns on the first low-side main switching device Q2 and the second high-side main switching device Q3 of the second sustaining pulse generating section 1X. The voltages across the switching device Q2 and Q3 are substantially equal to zero, and accordingly, no switching losses occur. Under the switching conditions, the potential of the sustain electrode X is fixed at its positive peak value Vt, and thereby, the sustaining voltage pulse Vp is fixed at its negative peak value −2Vt. See the interval D shown in FIG. 16.

Similarly, when changing the polarity of the sustaining voltage pulse Vp from the negative to the positive, the control section 34 delays the switching operations of the second sustaining pulse generating section 1X and the second power recovery section 4X with respect to the switching operations of the first sustaining pulse generating section 1Y and the first power recovery section 4Y.

Under such a switching control, the inductors L of the two power recovery sections 4Y and 4X alternately resonate with the panel capacitance Cp of the PDP 20 at every rise and fall of the sustaining voltage pulse Vp. Power is efficiently exchanged between the panel capacitance Cp and the two inductors L due to those resonances. As a result, the reactive power caused by the charging and discharging of the panel capacitance Cp is reduced.

The PDP driver according to Embodiment 5 of the invention comprises the two sustaining pulse generating sections 1Y and 1X and, on their output sides, the two transformers 2Y and 2X, similarly to Embodiment 2. They produce the effects similar to those according to Embodiment 2. In particular, the secondary winding 2bY and 2bX of the two transformers 2Y and 2X are connected in series to the panel capacitance Cp of the PDP 20, similarly to those according to Embodiment 2. See FIG. 15. Accordingly, the PDP driver according to Embodiment 5 has an advantage in power reduction over the PDP driver according to Embodiment 4, similarly to the PDP driver according to Embodiment 2.

Furthermore, the power recovery sections 4Y and 4X reduce the reactive power caused by the charging and discharging of the panel capacitance in the PDP driver according to Embodiment 5 of the invention, similarly to the driver according to Embodiment 4. Accordingly, the resonance period of the inductor L and the panel capacitance Cp is reliably limited to the pulse rise and fall times of the sustain pulse voltage Vp.

### EMBODIMENT 6

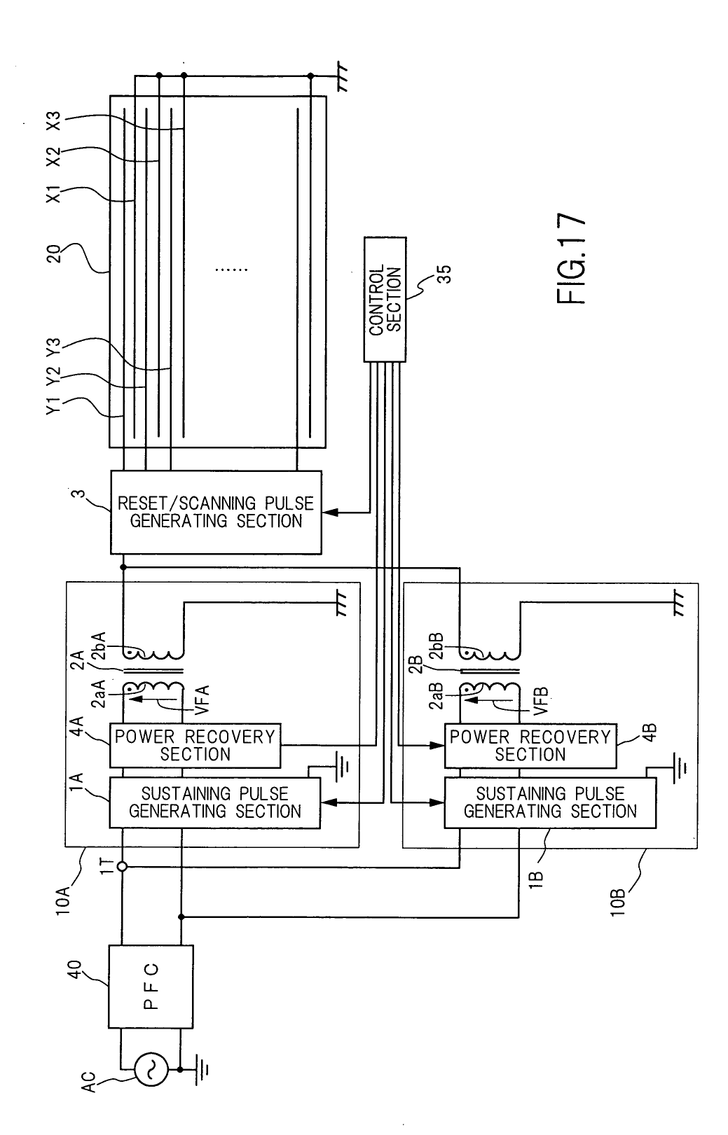

In the plasma display according to Embodiment 6 of the invention, the two driver sections 10A and 10B include the respective power recovery sections 4A and 4B on the primary sides of the transformers 2A and 2B, instead of the inductors LA and LB, in contrast to the plasma display according to Embodiment 3. See FIG. 17. Except for that point, both of the plasma displays have the similar configuration. See FIG. 10. In FIG. 17, the components similar to the components shown in FIG. 10 are marked with the same reference symbols as the reference symbols shown in FIG. 10. Furthermore, for the details of the similar components, the explanation about Embodiment 3 is cited.

In the driver sections 10A and 10B, the configurations of the sustaining pulse generating sections 1A and 1B, the power recovery sections 4A and 4B, and the transformers 2A and 2B are similar to the configuration of the sustaining pulse generating section 1, the power recovery section 4, and the transformer 2 according to Embodiment 4. In particular, the characteristics of the circuit elements corresponding to each other are substantially equal.

The control section 35 controls the switching operations of the two sustaining pulse generating sections 1A and 1B, the reset/scanning pulse generating section 3, and an address electrode driver section (not shown) under the ADS scheme, similarly to the control section 32 according to Embodiment 3. During the sustain period, the control section 35 further controls the switching operations of the power recovery section 4A and 4B in synchronization with the switching operations of the sustaining pulse generating sections 1A and 1B. In addition, the control section 35 synchronizes the two primary voltage pulses VFA and VFB sent from the two sustaining pulse generating sections 1A and 1B.

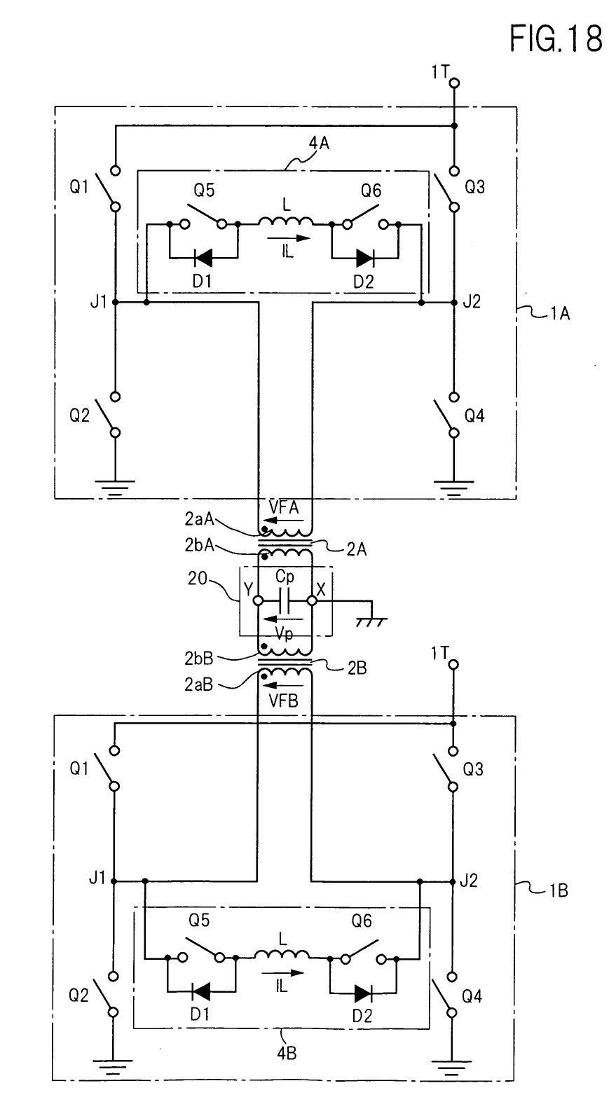

FIG. 18 is the equivalent circuit diagram of the two sustaining pulse generating sections 1A and 1B, the two power recovery sections 4A and 4B, the two transformers 2A and 2B, and the PDP 20. In FIG. 18, the components similar to the components shown in FIG. 11 are marked with the same reference symbols as the reference symbols shown in FIG. 11. Furthermore, for the details of the similar components, the explanation about Embodiment 3 is cited.

The reset/scanning pulse generating section 3 is connected to the position shown in FIG. 11 and simply short-circuits between the two secondary windings 2bA, 2bB of the two transformers 2A, 2B and the scan electrode Y during the sustain period. The reset/scanning pulse generating section 3Y is omitted in FIG. 18.

The secondary windings 2bA and 2bB of the two transformers 2A and 2B are connected to each other, for example, with the same polarity as shown in FIG. 18. In that case, the control section 35 maintains the switching operations of the two sustaining pulse generating sections 1A and 1B and the switching operations of the two power recovery sections 4A and 4B substantially in phase.

Aside from the example shown in FIG. 18, the secondary winding 2bA and 2bB of the two transformers 2A and 2B may be connected to each other with opposite polarities. In that case, the control section 35 maintains the switching operations of the two sustaining pulse generating sections 1A and 1B and the switching operations of the power recovery sections 4A and 4B substantially in opposite phase.

The two sustaining pulse generating sections 1A and 1B and the two power recovery sections 4A and 4B perform the switching operations in common with the switching operations of the sustaining pulse generating section 1 and the power recovery section 4 according to Embodiment 4. Accordingly, the potential changes of the scan and sustain electrodes Y and X of the PDP 20 are maintained in opposite phase. Therefore, the sustaining voltage pulse Vp applied between the scan electrode Y and the sustain electrode X is similar to that according to Embodiment 4. In particular, the inductors L of the power recovery sections 4A and 4B simultaneously resonate with the panel capacitance Cp of the PDP 20 at every rise and fall of the sustaining voltage pulse Vp. Power is efficiently exchanged between the inductors L and the panel capacitance Cp due to those resonances. As a result, the reactive power caused by the charging and discharging of the panel capacitance Cp is reduced.

The PDP driver according to Embodiment 6 of the invention comprises the two sustaining pulse generating sections 1A and 1B and, on their output sides, the two transformers 2A and 2B, similarly to Embodiment 3. They produce the effects similar to those according to Embodiment 3.

Furthermore, the power recovery sections 4A and 4B reduce the reactive power caused by the charging and discharging of the panel capacitance in the PDP driver according to Embodiment 6 of the invention, similarly to the driver according to Embodiment 4. Accordingly, the resonance period of the inductor L and the panel capacitance Cp is reliably limited to the pulse rise and fall times of the sustain pulse voltage Vp.

### EMBODIMENT 7

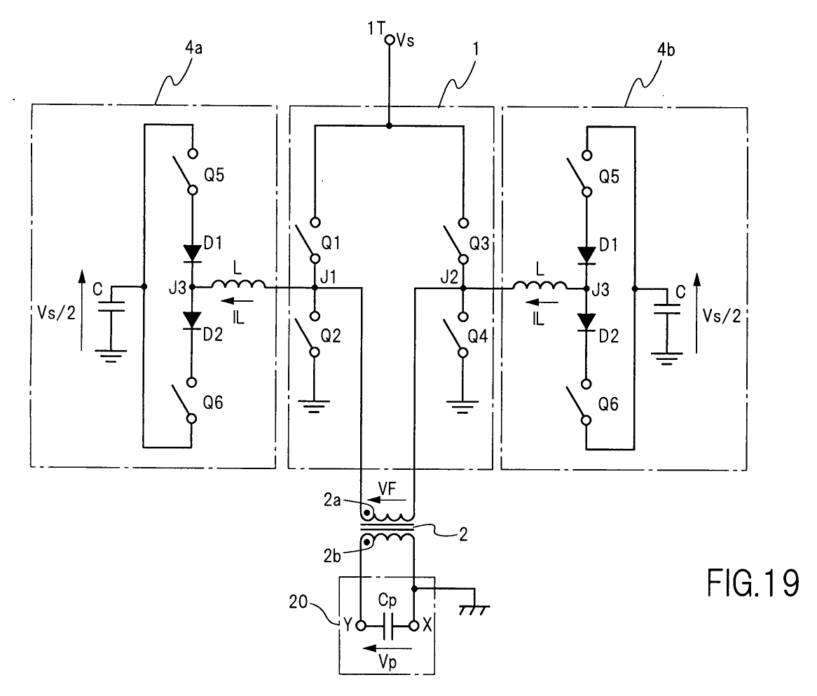

In the PDP driver according to Embodiment 4 of the invention, the concrete circuitry of the power recovery section 4 is not limited to that shown in FIG. 13, but can vary widely. In the PDP driver according to Embodiment 7 of the invention, its power recovery section 4 comprises the following configuration. See FIG. 19. Here, the components other than the power recovery section 4 are similar to those according to Embodiment 4. See FIG. 13. In FIG. 19, the components similar to the components shown in FIG. 13 are marked with the same reference symbols as the reference symbols shown in FIG. 13. Furthermore, for the details of the similar components, the explanation about Embodiment 4 is cited.

The power recovery section 4 includes two similar circuit parts 4a and 4b. Each of the parts 4a and 4b includes a capacitor C, a high-side recovery switching device Q5, a low-side recovery switching device Q6, a high-side diode D1, a low-side diode D2, and an inductor L. The capacitance of the capacitor C is larger enough than the panel capacitance Cp of the PDP 20. The voltage across the capacitor C is maintained substantially equal to the value Vs/2 half of the DC voltage Vs applied to the input terminal 1T of the sustaining pulse generating section 1. The two recovery switching devices Q5 and Q6 are preferably MOSFETs, or alternatively, may be IGBTs or bipolar transistors. The inductor L is preferably the element separate from the transformer 2, or alternatively, may be the leakage inductance of the transformer 2.

The one end of the capacitor C is grounded, and the other end is connected to one end each of the recovery switching devices Q5 and Q6. The other end of the high-side recovery switching device Q5 is connected to the anode of the high-side diode D1. The cathode of the high-side diode D1 is connected to the anode of the low-side diode D2. The cathode of the low-side diode D2 is connected to the other end of the low-side recovery switching device Q6. The inductor L is connected between the node J1 (or J2) of the series connection of the two main switching devices Q1 and Q2 (or, Q3 and Q4) and the node J3 of the high- and low-side diodes D1 and D2.

The control section 33 (cf. FIG. 12) changes the polarity of the sustaining voltage pulse Vp from the positive to the negative by the ON-OFF control over the main switching devices Q1-Q4 and the recovery switching devices Q5 and Q6 as follows.

When the first high-side main switching device Q1 and the second low-side main switching device Q4 maintain the ON states, the potential of the scan electrode Y, that is, the sustain pulse voltage Vp is maintained at its positive peak value. The sustain electrode X is maintained at the ground voltage. Here, that peak value depends on the potential Vs of the input terminal 1T of the sustaining pulse generating section 1 and the winding ratio of the transformer 2. When discharges successively occur in the PDP 20, the power required for maintenance of the discharging current is supplied from the PFC converter 40 to the PDP 20 through the input terminal 1T and the transformer 2.

After that state is maintained for the predetermined time equivalent to the pulse width of the sustaining voltage pulse, the control section 33 turns off the first high-side main switching device Q1 and turns on the low-side recovery switching device Q6 of the first part 4a of the power recovery section 4. At the first main switching device Q1, the current is substantially equal to zero, and accordingly, no switching losses occur. A loop is brought into conduction in the sustaining pulse generating section 1 and the first part 4a of the power recovery section 4; the loop includes the ground terminal the capacitor C the low-side recovery switching device Q6 the low-side diode D2 the inductor L the primary winding 2a of the transformer 2 the second low-side main switching device Q4 the ground terminal. The arrows represent the direction of the current. See FIG. 19. At that time, the inductor L resonates with the panel capacitance Cp through the transformer 2. The resonance current IL flows through the above-described loop in the directions of the arrows. The potential of the scan electrode Y, that is, the sustaining voltage pulse Vp further falls.

When the resonance current IL is reduced substantially to zero, the low-side diode D2 is turned off. At the same time, the sustaining pulse voltage Vp reaches zero. Then, the control section 33 turns off the low-side recovery switching device Q6 and turns on the first low-side main switching device Q2. The voltage across the first low-side main switching device Q2 is equal to zero, and accordingly, no switching losses occur. Thus, the sustaining voltage pulse Vp is clamped at zero.

The control section 33 next turns off the second low-side main switching device Q4 and turns on the high-side recovery switching device Q5 in the second part 4b of the power recovery section 4. The voltage across the second low-side main switching device Q4 is equal to zero, and accordingly, no switching losses occur. A loop is brought into conduction in the sustaining pulse generating section 1 and the second part 4b of the power recovery section 4; the loop includes the ground terminal the first low-side main switching device Q2 the primary winding 2a of the transformer 2 the inductor L the high-side diode D1 the high-side recovery switching device Q5 the capacitor C the ground terminal. The arrows represent the direction of the current. See FIG. 19. At that time, the inductor L resonates with the panel capacitance Cp through the transformer 2. The resonance current IL flows through the above-described loop in the directions of the arrows. The sustaining pulse voltage Vp further falls.

When the resonance current IL is reduced substantially to zero, the high-side diode D1 is turned off. At the same time, the sustaining pulse voltage Vp reaches its negative peak value. Then, the control section 33 turns off the high-side recovery switching device Q5 and turns on the second high-side main switching device Q3. Here, the voltage across the second high-side main switching device Q3 is equal to zero, and accordingly, no switching losses occur. Thus, the sustaining voltage pulse Vp is clamped at its negative peak value. When discharges successively occur in the PDP 20, the power required for maintenance of the discharging current is supplied from the PFC converter 40 to the PDP 20 through the input terminal 1T and the transformer 2.

Similarly, the control section 33 changes the polarity of the sustaining pulse voltage Vp from the negative to the positive by the ON-OFF control over the main switching devices Q1-Q4 and the recovery switching devices Q5 and Q6.

When the polarity of the sustaining voltage pulse Vp changes into the negative from the positive, in the power recovery section 4, the capacitor C of the first part 4a recovers power from the panel capacitance Cp, and on the other hand, the capacitor C of the second part 4b supplies power to the panel capacitance Cp. Power flows in reverse when the polarity of the sustaining voltage pulse Vp changes from the negative to the positive. Thus, at every rise and fall of the sustaining voltage pulse Vp, the inductors L of the power recovery section 4 resonate with the panel capacitance Cp of the PDP 20 and the capacitors C of the power recovery section 4 efficiently exchanges power with the panel capacitance Cp. As a result, the reactive power caused by the charging and discharging of the panel capacitance is reduced. In other words, in the PDP driver according to Embodiment 7 of the invention, the power recovery section 4 functions and produces the effects similarly to that according to Embodiment 4.

### EMBODIMENT 8

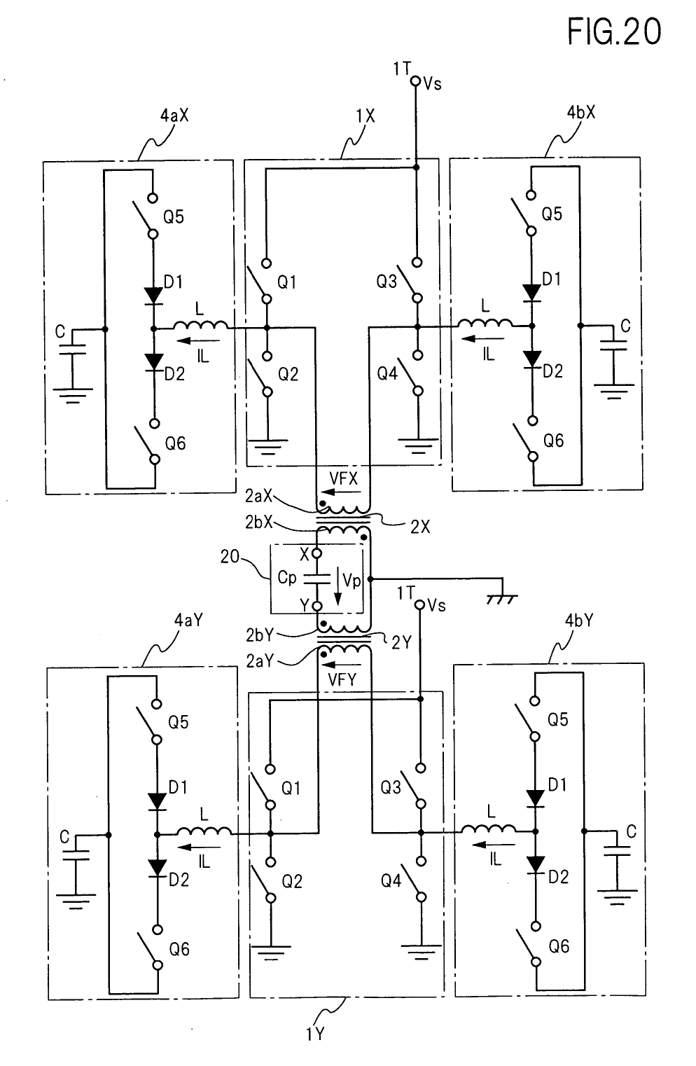

In the PDP driver according to Embodiment 5 of the invention (cf. FIG. 14), the concrete circuitry of the two power recovery sections 4Y and 4X are not limited to those shown in FIG. 15, but can vary widely. In the PDP driver according to Embodiment 8 of the invention, the two power recovery sections 4Y and 4X each comprise a configuration similar to that according to Embodiment 7. See FIGS. 19 and 20. Here, the other components except for the power recovery sections 4Y and 4X are similar to those according to Embodiment 5. See FIGS. 14 and 15. In FIG. 20, the components similar to the components shown in FIGS. 15 and 19 are marked with the same reference symbols as the reference symbols shown in FIGS. 15 and 19. Furthermore, for the details of the similar components, the explanation about Embodiment 5 and 7 is cited.

The secondary windings 2bY and 2bX of the two transformers 2Y and 2X are connected to each other, for example, with opposite polarities as shown in FIG. 20. In that case, the control section 34 (cf. FIG. 14) maintains the switching operations of the two sustaining pulse generating sections 1Y and 1X and the switching operations of the two power recovery sections 4Y and 4X substantially in phase.

Aside from the example shown in FIG. 20, the secondary windings 2bY and 2bX of the two transformers 2Y and 2X may be connected to each other with the same polarity. In that case, the control section 34 maintains the switching operations of the two sustaining pulse generating sections 1Y and 1X and the switching operations of the power recovery sections 4Y and 4X substantially in opposite phase.

The two sustaining pulse generating sections 1Y and 1X and the two power recovery sections 4Y and 4X perform the switching operations in common with the switching operations of the sustaining pulse generating section 1 and the power recovery section 4 according to Embodiment 7. Accordingly, the potential changes of the scan and sustain electrodes Y and X of the PDP 20 are maintained in opposite phase. Therefore, the sustaining voltage pulse Vp applied between the scan electrode Y and the sustain electrode X is similar to that according to Embodiment 7. In particular, the inductors L of the power recovery sections 4Y and 4X simultaneously resonate with the panel capacitance Cp of the PDP 20 at every rise and fall of the sustaining voltage pulse Vp. Power is efficiently exchanged between the capacitors C of the power recovery sections 4Y and 4X and the panel capacitance Cp due to those resonances. As a result, the reactive power caused by the charging and discharging of the panel capacitance Cp is reduced.

Aside from the above-described, the control section 34 may delay the phase of the switching operations of the second sustaining pulse generating section 1X and the second power recovery section 4X with respect to the phase of the switching operations of the first sustaining pulse generating section 1Y and the first power recovery section 4Y. See FIG. 16. Thereby, the inductors L of the power recovery sections 4Y and 4X alternately resonate with the panel capacitance Cp of the PDP 20 at every rise and fall of the sustaining voltage pulse Vp. Power is efficiently exchanged between the capacitors C of the power recovery sections 4Y and 4X and the panel capacitance Cp due to those resonances. As a result, the reactive power caused by the charging and discharging of the panel capacitance Cp is reduced.

In the PDP driver according to Embodiment 8 of the invention as described above, the power recovery sections 4Y and 4X functions and produces the effects similarly to that according to Embodiment 5.

Also in the PDP driver according to Embodiment 6 of the invention (cf. FIG. 17), the concrete circuitry of the two power recovery sections 4A and 4B are not limited to those shown in FIG. 18, but can vary widely. For example, the two power recovery sections 4A and 4B may each have the configuration similar to that according to Embodiment 7. See FIG. 19. Here, the other components except for the power recovery sections 4A and 4B are similar to those according to Embodiment 6. See FIGS. 17 and 18. The control section 35 (cf. FIG. 17) in particular maintains the switching operations of the two sustaining pulse generating sections 1A and 1B, and the switching operations of the two power recovery sections 4A and 4B in phase (or opposite phase). Thereby, the two power recovery sections 4A and 4B function and produce the effects similarly to those according to Embodiment 6.

### EMBODIMENT 9

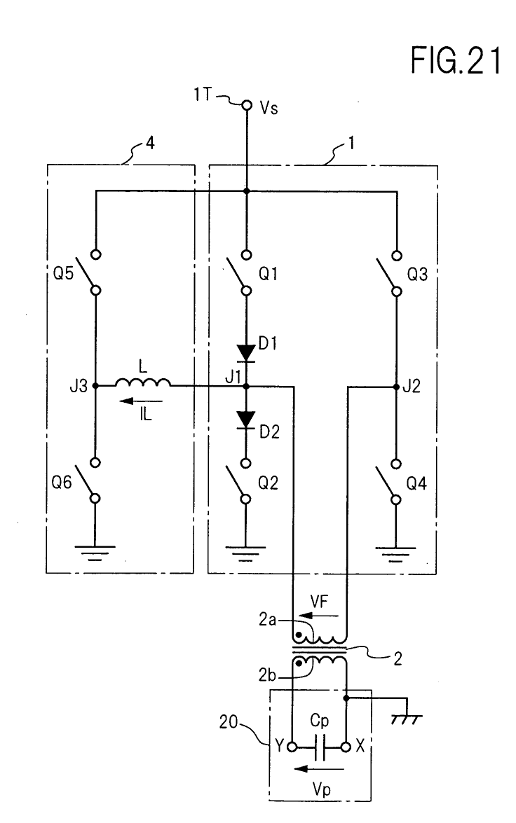

In the PDP driver according to Embodiment 4 of the invention (cf. FIG. 12), the power recovery section 4 includes the following circuitry instead of that shown in FIG. 13. See FIG. 21. Here, the other components except for the power recovery section 4 are similar to those according to Embodiment 4. See FIGS. 12 and 13. In FIG. 21, the components similar to the components shown in FIG. 13 are marked with the same reference symbols as the reference symbols shown in FIG. 13. Furthermore, for the details of the similar components, the explanation about Embodiment 4 is cited.

The sustaining pulse generating section 1 further includes two diodes D1 and D2. The anode and cathode of the high-side diode D1 are connected to the first high-side main switching device Q1 and the anode of the low-side diode D2, respectively. The cathode of the low-side diode D2 is connected to the first low-side main switching device Q2. The node J1 of the two diodes D1 and D2 is connected to the primary winding 2a of the transformer 2.

The power recovery section 4 includes two recovery switching devices Q5 and Q6 and an inductor L. The two recovery switching devices Q5 and Q6 are preferably MOSFETs, or alternatively, may be IGBTs or bipolar transistors.

The inductor L is preferably an element separate from the transformer 2, or alternatively, may be the leakage inductance of the transformer 2. The two recovery switching devices Q5 and Q6 are connected in series between the input terminal 1T and the ground terminal. The inductor L is connected between the node J1 of the two diodes D1 and D2 and the node J3 of the two recovery switching devices Q5 and Q6.

The control section 33 (cf. FIG. 12) changes the polarity of the voltage across the panel capacitance Cp, that is, the sustaining voltage pulse Vp from the positive to the negative by the ON-OFF control over the main switching devices Q1-Q4 and the recovery switching devices Q5 and Q6 as follows.

The first high-side main switching device Q1 and the second low-side main switching device Q4 maintain the ON states and other switching devices Q2, Q3, Q5, and Q6 maintain the OFF states. At that time, the potential of the scan electrode Y, that is, the sustaining voltage pulse Vp is maintained at the positive peak value. Here, the peak value depends on the potential Vs of the input terminal 1T of the sustaining pulse generating section 1 and the winding ratio of the transformer 2. When discharges successively occur in the discharge cell of the PDP 20, the power required for maintenance of the discharging current is supplied from the PFC converter 40 to the PDP 20 through the input terminal 1T and the transformer 2.

After that state is maintained for the predetermined time equivalent to the pulse width of the sustaining voltage pulse, the control section 33 turns off the first high-side main switching device Q1 and turns on the low-side recovery switching device Q6. At the first high-side main switching device Q1, at that time, the current is substantially equal to zero, and accordingly, no switching losses occur. The switching conditions brings a loop into conduction; the loop includes the ground terminal the low-side recovery switching device Q6 the inductor L the primary winding 2a of the transformer 2 the second low-side main switching device Q4 the ground terminal in order. The arrows represent the direction of current. See FIG. 21. At that time, the inductor L resonates with the panel capacitance Cp through the transformer 2. The resonance current IL flows through the above-described loop in the directions of the arrows. Furthermore, the sustaining voltage pulse Vp falls. Here, the two diodes D1 and D2 prevent the resonance current IL from flowing through the body diodes of the first high- and low-side main switching devices Q1 and Q2 (not shown).

The sustaining voltage pulse Vp reaches its negative peak value. At the same time, the resonance current IL is reduced substantially to zero. At that time, the control section 33 turns off the second low-side main switching device Q4 and the low-side recovery switching device Q6, and turns on the first low-side main switching device Q2 and the second high-side main switching device Q3. The current is substantially equal to zero in the second low-side main switching device Q4 and the low-side recovery switching device Q6, and accordingly, no switching losses occur. The voltage across each of the two main switching devices Q2 and Q3 is equal to zero, and accordingly, no switching losses occur. Thus, the sustaining voltage pulse Vp is clamped at its negative peak value. When discharges successively occur in the discharge cell of the PDP 20, the power required for maintenance of the discharging current is supplied from the PFC converter 40 to the PDP 20 through the input terminal 1T and the transformer 2.

After the lapse of the predetermined time equivalent to the pulse width of the sustaining voltage pulse, the control section 33 further changes the polarity of the sustaining pulse voltage Vp from the negative to the positive as follows. The control section 33 turns off the first low-side main switching device Q2 and turns on the high-side recovery switching device Q5. At the first low-side main switching device Q2, at that time, the current is substantially equal to zero, and accordingly, no switching losses occur. The switching conditions brings a loop into conduction; the loop includes the high-side recovery switching device Q5 the inductor L the primary winding 2a of the transformer 2 the second high-side main switching device Q3 the high-side recovery switching device Q5 in order. The arrows represent the direction of current. See FIG. 21. At that time, the inductor L resonates with the panel capacitance Cp through the transformer 2. The resonance current IL flows through the above-described loop in the directions of the arrows. Furthermore, the sustaining voltage pulse Vp rises. Here, the two diodes D1 and D2 prevent the resonance current IL from flowing through the body diodes of the first high- and low-side main switching devices Q1 and Q2 (not shown).

The sustaining voltage pulse Vp reaches its positive peak value. At the same time, the resonance current IL is reduced substantially to zero. At that time, the control section 33 turns off the second high-side main switching device Q3 and the high-side recovery switching device Q5, and turns on the first high-side main switching device Q1 and the second low-side main switching device Q4. The current is substantially equal to zero in the second high-side main switching device Q3 and the high-side recovery switching device Q5, and accordingly, no switching losses occur. The voltage across each of the two main switching devices Q1 and Q4 is equal to zero, and accordingly, no switching losses occur. Thus, the sustaining voltage pulse Vp is clamped at its positive peak value.

When the polarity of the sustaining voltage pulse Vp is reversed, the inductor L of the power recovery section 4 resonates with the panel capacitance Cp of the PDP 20 as described above. The resonance reverses the polarity of the sustaining voltage pulse Vp with almost no dissipation. As a result, the reactive power caused by the charging and discharging of the panel capacitance Cp of the PDP 20 is reduced.

Thus, in the PDP driver according to Embodiment 9 of the invention, the power recovery section 4 functions and produces the effects similarly to that according to Embodiment 4.

### EMBODIMENT 10

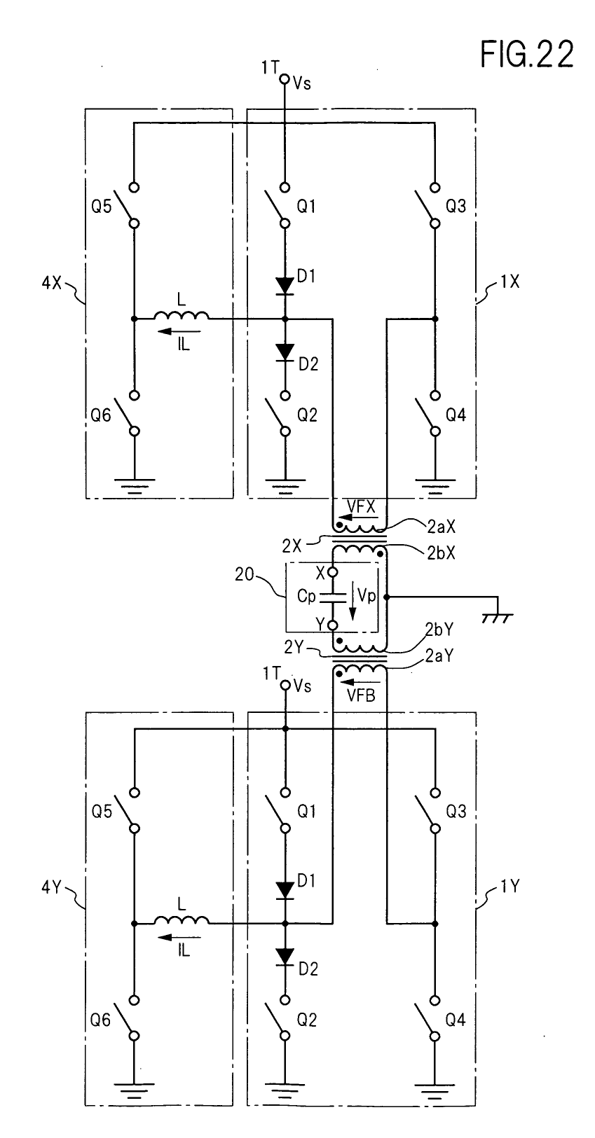

In the PDP driver according to Embodiment 5 of the invention (cf. FIG. 14), the power recovery sections 4Y and 4X each include the circuitry similar to that according to Embodiment 9, instead of that shown in FIG. 15. See FIGS. 21 and 22. Here, the other components except for the power recovery sections 4Y and 4X are similar to those according to Embodiment 5. See FIGS. 14 and 15. In FIG. 22, the components similar to the components shown in FIGS. 15 and 21 are marked with the same reference symbols as the reference symbols shown in FIGS. 15 and 21. Furthermore, for the details of the similar components, the explanation about Embodiments 5 and 9 is cited.

The secondary windings 2bY and 2bX of the two transformers 2Y and 2X are connected to each other, for example, with opposite polarities as shown in FIG. 22. In that case, the control section 34 (cf. FIG. 14) maintains the switching operations of the two sustaining pulse generating sections 1Y and 1X and the switching operations of the two power recovery sections 4Y and 4X substantially in phase.

Aside from the example shown in FIG. 22, the secondary winding 2bY and 2bX of the two transformers 2Y and 2X may be connected to each other with the same polarity. In that case, the control section 34 maintains the switching operations of the two sustaining pulse generating sections 1Y and 1X and the switching operations of the power recovery sections 4Y and 4X substantially in opposite phase.

The two sustaining pulse generating sections 1Y and 1X and the two power recovery sections 4Y and 4X perform the switching operations in common with the switching operations of the sustaining pulse generating section 1 and the power recovery section 4 according to Embodiment 9. Accordingly, the potential changes of the scan and sustain electrodes Y and X of the PDP 20 are maintained in opposite phase. Therefore, the sustaining voltage pulse Vp applied between the scan and sustain electrodes Y and X is similar to that according to Embodiment 9. In particular, the inductors L of the power recovery sections 4Y and 4X simultaneously resonate with the panel capacitance Cp of the PDP 20 at every rise and fall of the sustaining voltage pulse Vp. Power is efficiently exchanged between the inductors L and the panel capacitance Cp due to those resonances. As a result, the reactive power caused by the charging and discharging of the panel capacitance Cp is reduced.

Aside from the above-described, the control section 34 may delay the phase of the switching operations of the second sustaining pulse generating section 1X and the second power recovery section 4X with respect to the phase of the switching operations of the first sustaining pulse generating section 1Y and the first power recovery section 4Y. See FIG. 16. Thereby, the inductors L of the power recovery sections 4Y and 4X alternately resonate with the panel capacitance Cp of the PDP 20 at every rise and fall of the sustaining voltage pulse Vp. Power is efficiently exchanged between the two inductors L and the panel capacitance Cp due to those resonances. As a result, the reactive power caused by the charging and discharging of the panel capacitance Cp is reduced.

In the PDP driver according to Embodiment 10 of the invention as described above, the power recovery sections 4Y and 4X function and produce the effects similarly to those according to Embodiment 5.

Also in the PDP driver according to Embodiment 6 of the invention (cf. FIG. 17), similarly to the driver according to Embodiment 5, the two power recovery sections 4A and 4B each include the circuitry similar to that according to Embodiment 9, instead of that shown in FIG. 18. See FIG. 21. Here, the other components except for the power recovery sections 4A and 4B are similar to those according to Embodiment 6. See FIGS. 17 and 18. The control section 35 (cf. FIG. 17) in particular maintains the switching operations of the two sustaining pulse generating sections 1A and 1B, and the switching operations of the two power recovery sections 4A and 4B in phase (or opposite phase). Thereby, the two power recovery sections 4A and 4B function and produce the effects similarly to those according to Embodiment 6.

### EMBODIMENT 11

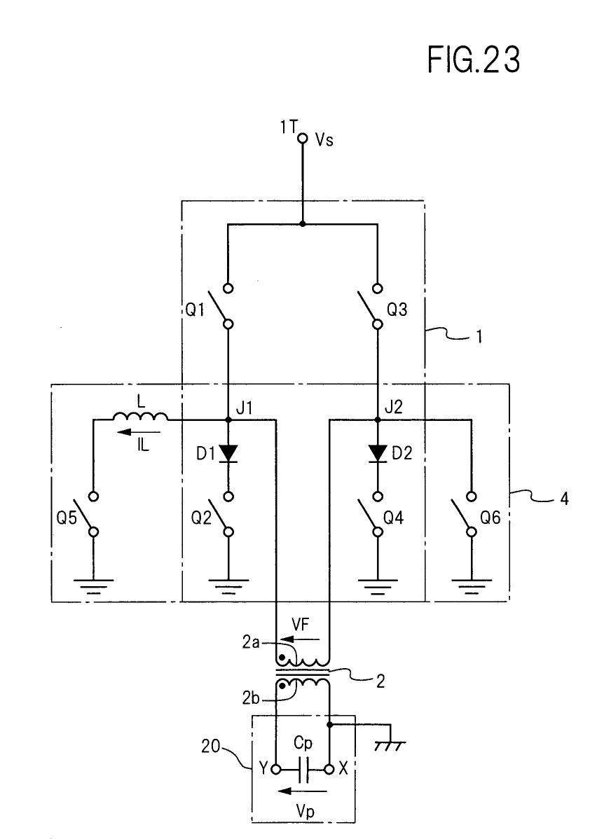

In the PDP driver according to Embodiment 4 of the invention (cf. FIG. 12), the power recovery section 4 includes the following circuitry instead of that shown in FIG. 13. See FIG. 23. Here, the other components except for the power recovery section 4 are similar to those according to Embodiment 4. See FIGS. 12 and 13. In FIG. 23, the components similar to the components shown in FIG. 13 are marked with the same reference symbols as the reference symbols shown in FIG. 13. Furthermore, for the details of the similar components, the explanation about Embodiment 4 is cited.

The sustaining pulse generating section 1 further includes two diodes D1 and D2. The anode and cathode of the first diode D1 are connected to the first high- and low-side main switching devices Q1 and Q2, respectively. The anode and cathode of the second diode D2 are connected to the second high- and low-side main switching devices Q3 and Q4, respectively. The primary winding 2a of the transformer 2 is connected between the node J1 of the first diode D1 and the first high-side main switching device Q1 and the node J2 of the second diode D2 and the second high-side main switching device Q3.

The power recovery section 4 includes two recovery switching devices Q5 and Q6 and an inductor L. The two recovery switching devices Q5 and Q6 are preferably MOSFETs, or alternatively, may be IGBTs or bipolar transistors. The inductor L is preferably an element separate from the transformer 2, or alternatively, may be the leakage inductance of the transformer 2. The first recovery switching device Q5 and the inductor L are connected in series between one end of the primary winding 2a of the transformer 2 and the ground terminal. The second recovery switching device Q6 is connected between the other end of the primary winding 2a of the transformer 2 and the ground terminal.

The control section 33 (cf. FIG. 12) changes the polarity of the voltage across the panel capacitance Cp, that is, the sustaining voltage pulse Vp from the positive to the negative by the ON-OFF control over the main switching devices Q1-Q4 and the recovery switching devices Q5 and Q6 as follows.

The first high-side main switching device Q1 and the second low-side main switching device Q4 maintain the ON states and other switching devices Q2, Q3, Q5, and Q6 maintain the OFF states. At that time, the potential of the scan electrode Y, that is, the sustaining voltage pulse Vp is maintained at the positive peak value. Here, the peak value depends on the potential Vs of the input terminal 1T of the sustaining pulse generating section 1 and the winding ratio of the transformer 2. When discharges successively occur in the discharge cell of the PDP 20, the power required for maintenance of the discharging current is supplied from the PFC converter 40 to the PDP 20 through the input terminal 1T and the transformer 2.

After that state is maintained for the predetermined time equivalent to the pulse width of the sustaining voltage pulse, the control section 33 turns off the first high-side main switching device Q1 and the second low-side main switching device Q4, and turns on both the two recovery switching devices Q5 and Q6. At the two main switching devices Q1 and Q4, at that time, the current is substantially equal to zero, and accordingly, no switching losses occur. The switching conditions brings a loop into conduction; the loop includes the ground terminal the first recovery switching device Q5 the inductor L the primary winding 2a of the transformer 2 the second recovery switching device Q6 the ground terminal in order. The arrows represent the direction of current. See FIG. 23. At that time, the inductor L resonates with the panel capacitance Cp through the transformer 2. The resonance current IL flows through the above-described loop in the directions of the arrows. Furthermore, the sustaining voltage pulse Vp falls. Here, the two diodes D1 and D2 prevent the resonance current IL from flowing through the body diodes of the two low-side main switching devices Q2 and Q4 (not shown).

The sustaining voltage pulse Vp reaches its negative peak value. At the same time, the resonance current IL is reduced substantially to zero. At that time, the control section 33 turns off both the two recovery switching devices Q5 and Q6, and turns on the first low-side main switching device Q2 and the second high-side main switching device Q3. The current is substantially equal to zero in the two recovery switching devices Q5 and Q6, and accordingly, no switching losses occur. The voltage across each of the two main switching devices Q2 and Q3 is equal to zero, and accordingly, no switching losses occur. Thus, the sustaining voltage pulse Vp is clamped at its negative peak value. When discharges successively occur in the discharge cell of the PDP 20, the power required for maintenance of the discharging current is supplied-from the PFC converter 40 to the PDP 20 through the input terminal 1T and the transformer 2.

Similarly, the control section 33 changes the polarity of the sustaining voltage pulse Vp from the negative to the positive by the ON-OFF control over the main switching devices Q1-Q4 and the recovery switching devices Q5 and Q6.

When the polarity of the sustaining voltage pulse Vp is reversed, the inductor L of the power recovery section 4 resonates with the panel capacitance Cp of the PDP 20 as described above. The resonance reverses the polarity of the sustaining voltage pulse Vp with almost no dissipation. As a result, the reactive power caused by the charging and discharging of the panel capacitance Cp of the PDP 20 is reduced.

Thus, in the PDP driver according to Embodiment 11 of the invention, the power recovery section 4 functions and produces the effects similarly to that according to Embodiment 4.

### EMBODIMENT 12

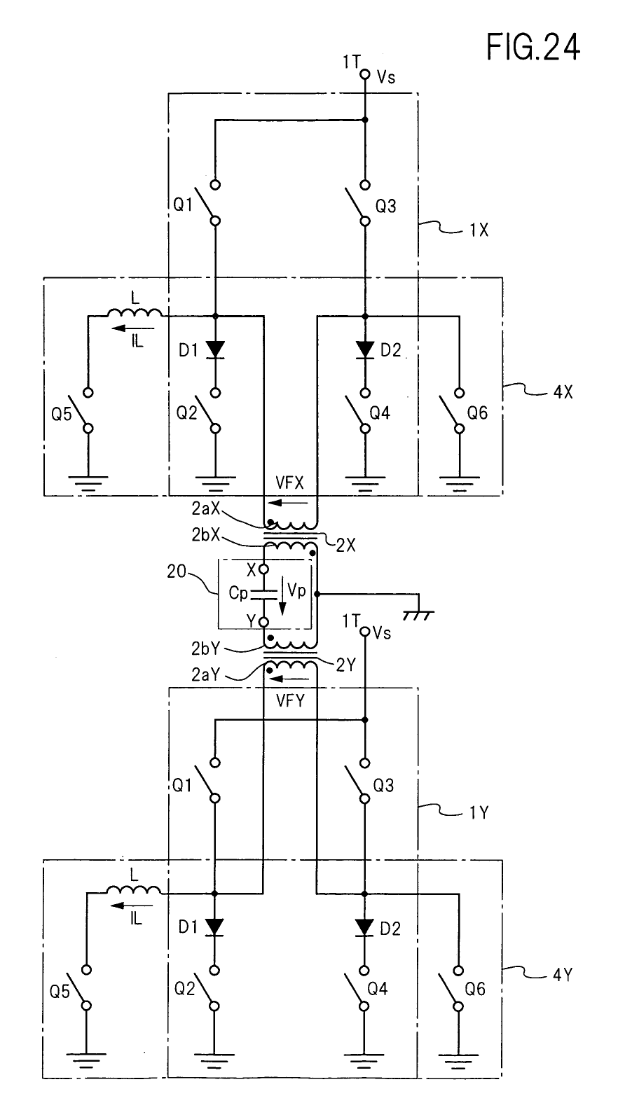

In the PDP driver according to Embodiment 5 of the invention (cf. FIG. 14), the power recovery sections 4Y and 4X each include the circuitry similar to that according to Embodiment 11, instead of that shown in FIG. 15. See FIGS. 23 and 24. Here, the other components except for the power recovery sections 4Y and 4X are similar to those according to Embodiment 5. See FIGS. 14 and 15. In FIG. 24, the components similar to the components shown in FIGS. 15 and 23 are marked with the same reference symbols as the reference symbols shown in FIGS. 15 and 23. Furthermore, for the details of the similar components, the explanation about Embodiments 5 and 11 is cited.

The secondary windings 2bY and 2bX of the two transformers 2Y and 2X are connected to each other, for example, with opposite polarities as shown in FIG. 24. In that case, the control section 34 (cf. FIG. 14) maintains the switching operations of the two sustaining pulse generating sections 1Y and 1X and the switching operations of the two power recovery sections 4Y and 4X substantially in phase.

Aside from the example shown in FIG. 24, the secondary winding 2bY and 2bX of the two transformers 2Y and 2X may be connected to each other with the same polarity. In that case, the control section 34 maintains the switching operations of the two sustaining pulse generating sections 1Y and 1X and the switching operations of the power recovery sections 4Y and 4X substantially in opposite phase.

The two sustaining pulse generating sections 1Y and 1X and the two power recovery sections 4Y and 4X perform the switching operations in common with the switching operations of the sustaining pulse generating section 1 and the power recovery section 4 according to Embodiment 11. Accordingly, the potential changes of the scan and sustain electrodes Y and X of the PDP 20 are maintained in opposite phase. Therefore, the sustaining voltage pulse Vp applied between the scan and sustain electrodes Y and X is similar to that according to Embodiment 11. In particular, the inductors L of the power recovery sections 4Y and 4X simultaneously resonate with the panel capacitance Cp of the PDP 20 at every rise and fall of the sustaining voltage pulse Vp. Power is efficiently exchanged between the inductors L and the panel capacitance Cp due to those resonances. As a result, the reactive power caused by the charging and discharging of the panel capacitance Cp is reduced.

Aside from the above-described, the control section 34 may delay the phase of the switching operations of the second sustaining pulse generating section 1X and the second power recovery section 4X with respect to the phase of the switching operations of the first sustaining pulse generating section 1Y and the first power recovery section 4Y. See FIG. 16. Thereby, the inductors L of the power recovery sections 4Y and 4X alternately resonate with the panel capacitance Cp of the PDP 20 at every rise and fall of the sustaining voltage pulse Vp. Power is efficiently exchanged between the two inductors L and the panel capacitance Cp due to those resonances. As a result, the reactive power caused by the charging and discharging of the panel capacitance Cp is reduced.

In the PDP driver according to Embodiment 12 of the invention as described above, the power recovery sections 4Y and 4X function and produce the effects similarly to those according to Embodiment 5.

Also in the PDP driver according to Embodiment 6 of the invention (cf. FIG. 17), similarly to the driver according to Embodiment 5, the two power recovery sections 4A and 4B each include the circuitry similar to that according to Embodiment 11, instead of that shown in FIG. 18. See FIG. 23. Here, the other components except for the power recovery sections 4A and 4B are similar to those according to Embodiment 6. See FIGS. 17 and 18. The control section 35 (cf. FIG. 17) in particular maintains the switching operations of the two sustaining pulse generating sections 1A and 1B, and the switching operations of the two power recovery sections 4A and 4B in phase (or opposite phase). Thereby, the two power recovery sections 4A and 4B function and produce the effects similarly to those according to Embodiment 6.

### EMBODIMENT 13

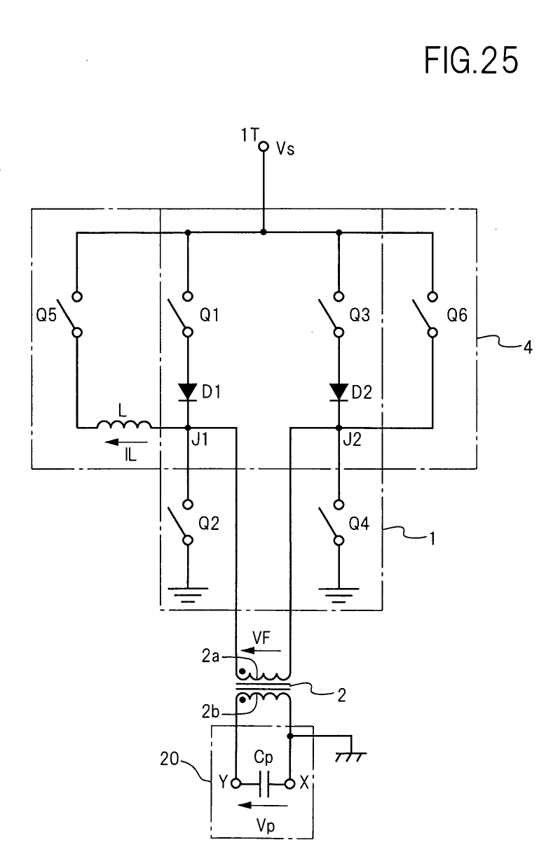

In the PDP driver according to Embodiment 11 of the invention, one end each of the two recovery switching devices Q5 and Q6 of the power recovery section 4 is grounded. See FIG. 23. Alternatively, one end each of the two recovery switching devices Q5 and Q6 may be connected to the input terminal 1T. See FIG. 25. At that time, the primary winding 2a of the transformer 2 is connected between the node J1 of the first diode D1 and the first low-side main switching device Q2 and the node J2 of the second diode D2 and the second low-side main switching device Q4. The two diodes D1 and D2 prevent the resonance current IL from flowing through the body diodes of the two high-side main switching devices Q1 and Q3 (not shown).

In FIG. 25, the components similar to the components shown in FIG. 23 are marked with the same reference symbols as the reference symbols shown in FIG. 23. Furthermore, for the details of the similar components, the explanation about Embodiments 4 and 11 is cited.

The control section 33 (cf. FIG. 12) controls the switch operations of the sustaining pulse generating section 1 and the power recovery section 4, similarly to the control section 33 according to Embodiment 11. Thereby, when the polarity of the sustaining voltage pulse Vp is reversed, the inductor L of the power recovery section 4 resonates with the panel capacitance Cp of the PDP 20. The resonance reverses the polarity of the sustaining voltage pulse Vp with almost no dissipation. As a result, the reactive power caused by the charging and discharging of the panel capacitance Cp of the PDP 20 is reduced.

Thus, in the PDP driver according to Embodiment 13 of the invention, the power recovery section 4 functions and produces the effects similarly to that according to Embodiment 4.

### EMBODIMENT 14

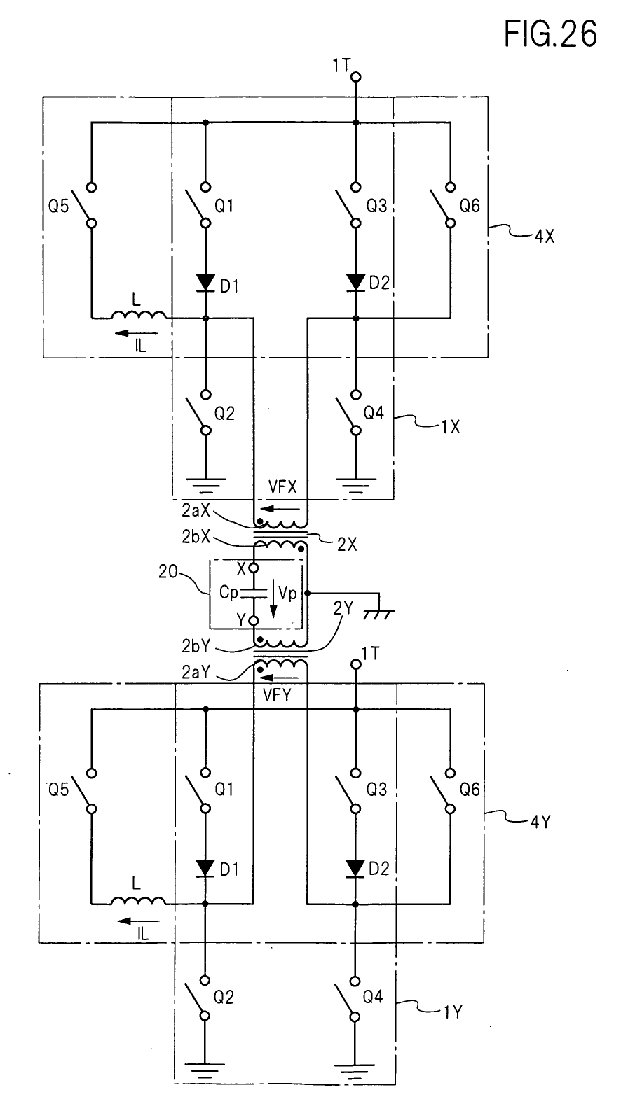

In the PDP driver according to Embodiment 5 of the invention (cf. FIG. 14), the power recovery sections 4Y and 4X each include the circuitry similar to that according to Embodiment 13, instead of that shown in FIG. 15. See FIGS. 25 and 26. Here, the other components except for the power recovery sections 4Y and 4X are similar to those according to Embodiment 5. See FIGS. 14 and 15. In FIG. 26, the components similar to the components shown in FIGS. 15 and 25 are marked with the same reference symbols as the reference symbols shown in FIGS. 15 and 25. Furthermore, for the details of the similar components, the explanation about Embodiments 5 and 13 is cited.

The secondary windings 2bY and 2bX of the two transformers 2Y and 2X are connected to each other, for example, with opposite polarities as shown in FIG. 26. In that case, the control section 34 (cf. FIG. 14) maintains the switching operations of the two sustaining pulse generating sections 1Y and 1X and the switching operations of the two power recovery sections 4Y and 4X substantially in phase.

Aside from the example shown in FIG. 26, the secondary winding 2bY and 2bX of the two transformers 2Y and 2X may be connected to each other with the same polarity. In that case, the control section 34 maintains the switching operations of the two sustaining pulse generating sections 1Y and 1X and the switching operations of the power recovery sections 4Y and 4X substantially in opposite phase.

The two sustaining pulse generating sections 1Y and 1X and the two power recovery sections 4Y and 4X perform the switching operations in common with the switching operations of the sustaining pulse generating section 1 and the power recovery section 4 according to Embodiment 13. Accordingly, the potential changes of the scan and sustain electrodes Y and X of the PDP 20 are maintained in opposite phase. Therefore, the sustaining voltage pulse Vp applied between the scan and sustain electrodes Y and X is similar to that according to Embodiment 13. In particular, the inductors L of the power recovery sections 4Y and 4X simultaneously resonate with the panel capacitance Cp of the PDP 20 at every rise and fall of the sustaining voltage pulse Vp. Power is efficiently exchanged between the inductors L and the panel capacitance Cp due to those resonances. As a result, the reactive power caused by the charging and discharging of the panel capacitance Cp is reduced.

Aside from the above-described, the control section 34 may delay the phase of the switching operations of the second sustaining pulse generating section 1X and the second power recovery section 4X with respect to the phase of the switching operations of the first sustaining pulse generating section 1Y and the first power recovery section 4Y. See FIG. 16. Thereby, the inductors L of the power recovery sections 4Y and 4X alternately resonate with the panel capacitance Cp of the PDP 20 at every rise and fall of the sustaining voltage pulse Vp. Power is efficiently exchanged between the two inductors L and the panel capacitance Cp due to those resonances. As a result, the reactive power caused by the charging and discharging of the panel capacitance Cp is reduced.

In the PDP driver according to Embodiment 14 of the invention as described above, the power recovery sections 4Y and 4X function and produce the effects similarly to those according to Embodiment 5.

Also in the PDP driver according to Embodiment 6 of the invention (cf. FIG. 17), similarly to the driver according to Embodiment 5, the two power recovery sections 4A and 4B each include the circuitry similar to that according to Embodiment 13, instead of that shown in FIG. 18. See FIG. 25. Here, the other components except for the power recovery sections 4A and 4B are similar to those according to Embodiment 6. See FIGS. 17 and 18.

The control section 35 (cf. FIG. 17) in particular maintains the switching operations of the two sustaining pulse generating sections 1A and 1B, and the switching operations of the two power recovery sections 4A and 4B in phase (or opposite phase). Thereby, the two power recovery sections 4A and 4B function and produce the effects similarly to those according to Embodiment 6.

### EMBODIMENT 15

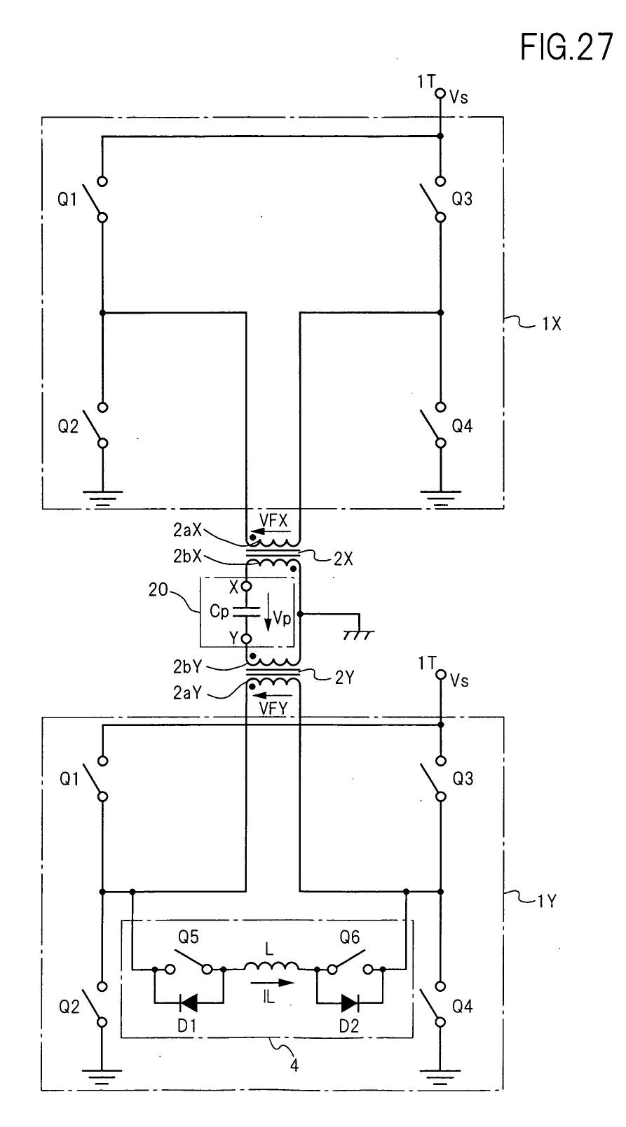

The PDP drivers according to Embodiments 5, 8, 10, 12, and 14 of the invention have the common circuitry except for the concrete circuitry of the two power recovery sections 4Y and 4X. See FIG. 14. In particular, the secondary windings 2bY and 2bX of the two transformers 2Y and 2X are connected in series to the panel capacitance Cp of the PDP 20. See FIGS. 15, 20, 22, 24, and 26. In this configuration, either of the driver sections may be required to include no power recovery section, for example, as follows. See FIG. 27. Thereby, the component count reduces, and the area for mounting is shrunk.

The first driver section 10Y includes a power recovery section 4 on the primary side of the first transformer 2Y. On the other hand, the second driver section 10X includes no power recovery section. The power recovery section 4 has, for example, the circuitry similar to that of the power recovery section according to Embodiment 4. See FIG. 15. Alternatively, the circuitry may be similar to that of the power recovery section according Embodiment 7, 9, 11, or 12.

In FIG. 27, the components similar to the components shown in FIG. 15 are marked with the same reference symbols as the reference symbols shown in FIG. 15. Furthermore, for the details of the similar components, the explanation about Embodiment 4 is cited.

The control section 34 (cf. FIG. 14) sets the following phase difference between the switching operations of the two sustaining pulse generating sections 1Y and 1X; the phase difference is larger than 0° and smaller than 180°.

Assume, for example, the case where the secondary windings 2bY and 2bX of the two transformers 2Y and 2X are connected to each other with opposite polarities. See FIG. 27. Here, the secondary winding 2bY and 2bX of the two transformers 2Y and 2X may be connected to each other with the same polarity. In that case, the control section 34 maintains the switching operation of either of the driver sections substantially in opposite phase with respect to the following switching operation.

In each of the two sustaining pulse generating sections 1Y and 1X, the first high-side main switching device Q1 and the second low-side main switching device Q4 maintain the ON states and other switching devices Q2, Q3, Q5, and Q6 maintain the OFF states. At that time, the potential of the scan electrode Y is maintained at its positive peak value, and the potential of the sustain electrode X is maintained at its negative peak value. Accordingly, the sustaining voltage pulse Vp is maintained in its positive peak value.

After that state is maintained for the predetermined time equivalent to the pulse width of the sustaining voltage pulse, in the first sustaining pulse generating section 1Y, the control section 34 turns off the first high-side main switching device Q1 and the second low-side main switching device Q4, and further turns on the first recovery switching device Q5. In the first sustaining pulse generating section 1Y at that time, the current is substantially equal to zero, and accordingly, no switching losses occur. On the other hand, as for the second sustaining pulse generating section 1X, the ON and OFF states of the four main switching devices Q1-Q4 are maintained as they are. Under the switching conditions, the inductor L of the power recovery section 4 resonates with the panel capacitance Cp of the PDP 20. The resonance current IL flows through the inductor L and the potential of the scan electrode Y falls from its positive peak value. Then, the sustaining pulse voltage Vp falls from its positive peak value.

The potential of the scan electrode Y reaches its negative peak value, and then, the sustaining voltage pulse Vp reaches zero. At that time, the control section 34 turns off the first high-side main switching device Q1 and the second low-side main switching device Q4 of the second sustaining pulse generating section 1X. In the second sustaining pulse generating section 1X, the current is substantially equal to zero, and accordingly, no switching losses occur. The control section 34 next turns on the first low-side main switching device Q2 and the second high-side main switching device Q3 of the second sustaining pulse generating section 1X. On the other hand, the control section 34 maintains the main switching devices Q1-Q4 of the first sustaining pulse generating section 1Y in the OFF states, and maintains the ON and OFF states of the recovery switching devices Q5 and Q6 of the power recovery section 4 as they are. Under the switching conditions, the inductor L of the power recovery section 4 further resonates with the panel capacitance Cp. The resonance current IL further flows through the inductor L and the potential of the scan electrode Y further falls. Thus, the polarity of the sustaining voltage pulse Vp changes from the positive to the negative.

The potential of the scan electrode Y reaches its negative peak value, and then, the sustaining voltage pulse Vp reaches its negative peak value. At the same time, the resonance current IL is reduced substantially to zero, and accordingly, the second diode D2 is turned off in the power recovery section 4. At that time, the control section 34 turns off the first recovery switching device Q5. Here, the resonance current IL is substantially equal to zero, and accordingly, no switching losses occur. The control section 34 further turns on the first low-side main switching device Q2 and the second high-side main switching device Q3 of the first sustaining pulse generating section 1Y. The voltages across the respective switching devices Q2 and Q3 are substantially equal to zero, and accordingly, no switching losses occur. Under the switching conditions, the potential of the scan electrode Y is clamped at its negative peak value, and thereby, the sustaining voltage pulse Vp is clamped at its negative peak value.

Similarly, when changing the polarity of the sustaining voltage pulse Vp from the negative to the positive, the control section 34 sets the phase differences between the switching operations of the two sustaining pulse generating sections 1Y and 1X.

Thus, the inductor L of the single power recovery section 4 resonates with the panel capacitance Cp of the PDP 20 at every rise and fall of the sustaining voltage pulse Vp. Power is efficiently exchanged between the panel capacitance Cp and the inductor L due to the resonance. As a result, the reactive power caused by the charging and discharging of the panel capacitance Cp is reduced.

In the PDP driver according to Embodiment 15 of the invention as described above, the single power recovery section 4 functions and produces the effects similarly to the two power recovery sections 4Y and 4X according to Embodiment 5.

### EMBODIMENT 16

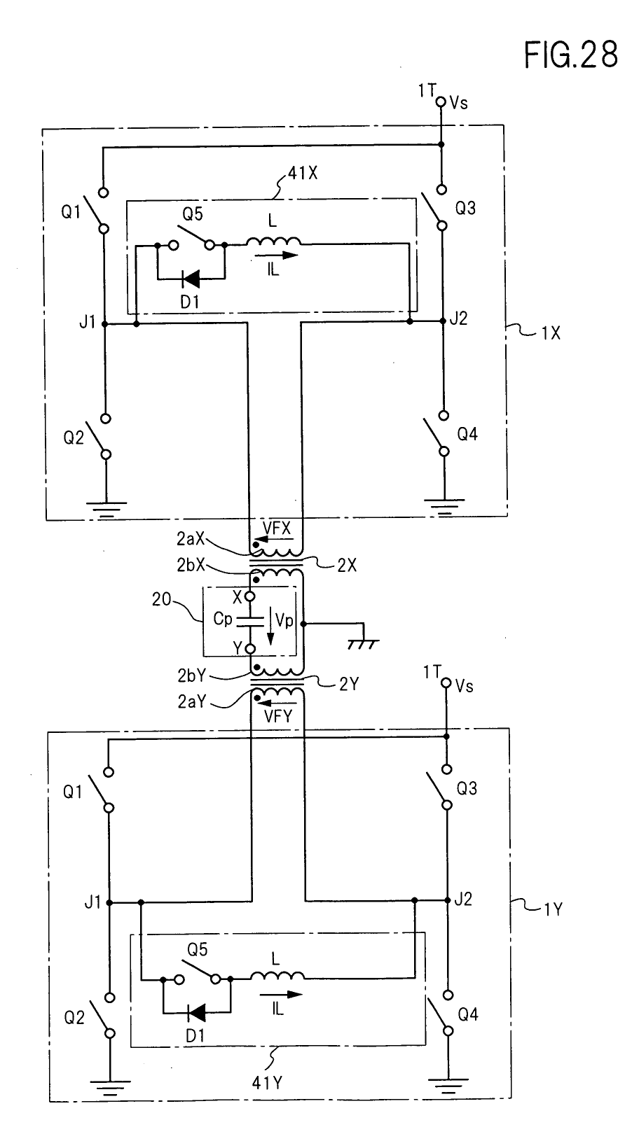

The PDP drivers according to Embodiments 5, 8, 10, 12, and 14 of the invention have the common circuitry except for the concrete circuitry of the two power recovery sections 4Y and 4X. See FIG. 14. In particular, the secondary windings 2bY and 2bX of the two transformers 2Y and 2X are connected in series to the panel capacitance Cp of the PDP 20. See FIGS. 15, 20, 22, 24, and 26. Furthermore, the power recovery sections 4Y and 4X each include the two recovery switching devices Q5 and Q6, from which a two-way switch is constructed. In this configuration, the power recovery section may include a one-way switch, and thereby, a current may be allowed to flow through the inductor L only in one direction, for example, as follows. See FIG. 28. Thus, the component counts are reduced, and then, the area for mounting is shrunk.

Each of power recovery sections 41Y and 41X is, for example, the equivalent of the power recovery section 4 according to Embodiment 4 except for the substitution of the one-way switch Q5 and D1 for the two-way switch Q5, Q6, D1, and D2. See FIG. 15. In other words, each of the power recovery sections 41Y and 41X include only one parallel connection of the recovery switching device Q5 and the diode D1. The parallel connection is connected in series to the inductor L. Thereby, the recovery switching device Q5 can cut off the current only in the reverse bias direction of the diode D1.

Alternatively, the two power recovery sections 41Y and 41X may be the equivalent of the power recovery section according to Embodiment 7, 9 and 11 or 12 except for the substitution of the one-way switch for the two-way switch.

In FIG. 28, the components similar to the components shown in FIG. 15 are marked with the same reference symbols as the reference symbols shown in FIG. 15. Furthermore, for the details of the similar components, the explanation about Embodiment 4 is cited.

The control section 34 (cf. FIG. 14) sets the following phase difference between the switching operations of the two sustaining pulse generating sections 1Y and 1X and the two power recovery sections 41Y and 41X; the phase difference is larger than 0° and smaller than 180°.

Assume, for example, the case where the secondary windings 2bY and 2bX of the two transformers 2Y and 2X are connected to each other with the same polarity. See FIG. 28. At that time, the diodes D1 of the two power recovery sections 41Y and 41X are placed with the same polarity. Furthermore, the control section 34 maintains the switching operations of the two sustaining pulse generating sections 1Y and 1X substantially in phase.

The secondary windings 2bY and 2bX of the two transformers 2Y and 2X may be connected to each other with opposite polarities. At that time, the diodes D1 are placed with the opposite polarities in the two power recovery sections 41Y and 41X. Furthermore, the control section 34 maintains the switching operations of the two sustaining pulse generating sections 1Y and 1X substantially in opposite phase.

In the first sustaining pulse generating section 1Y, the first high-side main switching device Q1 and the second low-side main switching device Q4 maintain the ON states and other switching devices Q2, Q3, and Q5 maintain the OFF states. At that time, the potential of the scan electrode Y is maintained at its positive peak value. In the second sustaining pulse generating section 1X, the first low-side main switching device Q2 and the second high-side main switching device Q3 maintain the ON states and other switching devices Q1, Q4, and Q5 maintain the OFF states. At that time, the potential of the sustain electrode X is maintained at its negative peak value. Accordingly, the sustaining voltage pulse Vp is maintained at its positive peak value.

After that state is maintained for the predetermined time equivalent to the pulse width of the sustaining voltage pulse, the control section 34 turns off the first high-side main switching device Q1 and the second low-side main switching device Q4 of the first sustaining pulse generating section 1Y. In the first sustaining pulse generating section 1Y at that time, the current is substantially equal to zero, and accordingly, no switching losses occur. The control section 34 further turns on the recovery switching device Q5 of the first power recovery section 41Y. On the other hand, as for the second sustaining pulse generating section 1X and the second power recovery section 41X, the ON and OFF states of the main switching devices Q1-Q4 and the recovery switching device Q5 are maintained as they are. Under the switching conditions, the inductor L of the first power recovery section 41Y resonates with the panel capacitance Cp of the PDP 20. The resonance current IL flows through the inductor L and the potential of the scan electrode Y falls from its positive peak value. Then, the sustaining pulse voltage Vp falls from its positive peak value.

The potential of the scan electrode Y reaches its negative peak value, and then, the sustaining voltage pulse Vp reaches zero. At that time, the control section 34 turns off the first low-side main switching device Q2 and the second high-side main switching device Q3 of the second sustaining pulse generating section 1X. In the second sustaining pulse generating section 1X, the current is substantially equal to zero, and accordingly, no switching losses occur. The control section 34 next turns on the first high-side main switching device Q1 and the second low-side main switching device Q4 of the second sustaining pulse generating section 1X. On the other hand, the control section 34 maintains the main switching devices Q1-Q4 of the first sustaining pulse generating section 1Y in the OFF states, and maintains the recovery switching device Q5 of the first power recovery section 41Y in the ON state. Under the switching conditions, the inductor L of the first power recovery section 41Y further resonates with the panel capacitance Cp. The resonance current IL further flows through the inductor L in the same direction and the potential of the scan electrode Y further falls. Thus, the polarity of the sustaining voltage pulse Vp changes into the negative from the positive.

The potential of the scan electrode Y reaches its negative peak value, and then, the sustaining voltage pulse Vp reaches its negative peak value. At the same time, the resonance current IL is reduced substantially to zero. At that time, the control section 34 turns off the first recovery switching device Q5 of the first power recovery section 41Y. Here, the resonance current IL is substantially equal to zero, and accordingly, no switching losses occur. The control section 34 further turns on the first low-side main switching device Q2 and the second high-side main switching device Q3 of the first sustaining pulse generating section 1Y. The voltages across the respective switching devices Q2 and Q3 are substantially equal to zero, and accordingly, no switching losses occur. Under the switching conditions, the potential of the scan electrode Y is clamped at its negative peak value, and thereby, the sustaining voltage pulse Vp is clamped at its negative peak value.

Similarly, when changing the polarity of the sustaining voltage pulse Vp from the negative to the positive, the control section 34 sets the phase differences between the switching operations of the two sustaining pulse generating sections 1Y and 1X. Thus, the inductors L of the two power recovery sections 41Y and 41X alternately resonate with the panel capacitance Cp of the PDP 20 at every rise and fall of the sustaining voltage pulse Vp. Power is efficiently exchanged between the panel capacitance Cp and the inductors L due to these resonances. As a result, the reactive power caused by the charging and discharging of the panel capacitance Cp is reduced. In those resonances, in particular, the resonance currents IL flow through the inductors L only in one direction.

In the PDP driver according to Embodiment 16 of the invention as described above, the two power recovery sections 41Y and 41X function and produce the effects similarly to the two power recovery sections 4Y and 4X according to Embodiment 5.

### EMBODIMENT 17

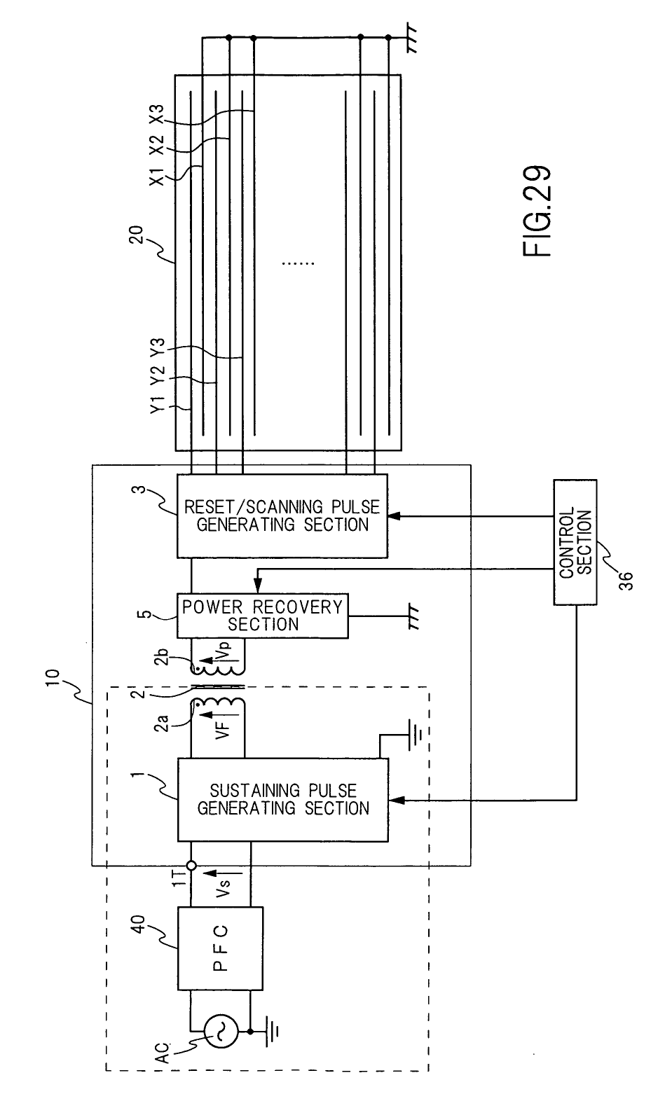

In the plasma display according to Embodiment 17 of the invention, the PDP driver 10 includes a power recovery section 5 on the secondary side of the transformer 2 in contrast to the plasma display according to Embodiment 4. See FIG. 29. Except for that point, both the plasma displays have similar configuration. See FIG. 12. In FIG. 29, the components similar to the components shown in FIG. 12 are marked with the same reference symbols as the reference symbols shown in FIG. 12. Furthermore, for the details of the similar components, the explanation about Embodiments 1 and 4 is cited.

The power recovery section 5 is connected to the secondary winding 2b of the transformer 2 and includes an inductor and a switching section. The switching section is turned on, for example, at every rise and fall of the primary voltage pulse VF sent from the sustaining pulse generating section 1 or the following secondary voltage pulse Vp sent from the transformer 2, and connects the inductor to the scan (or sustain) electrode of the PDP 20. The inductor then resonates with the panel capacitance of the PDP 20.

The control section 36 controls the switching operations of the sustaining pulse generating section 1, the reset/scanning pulse generating section 3, and an address electrode driver section (not shown) under the ADS scheme, similarly to the control section 33 according to Embodiment 4. The control section 36 further controls the switching operation of the power recovery section 5, thereby synchronizing it with the switching operation of the sustaining pulse generating section 1 during the sustain period.

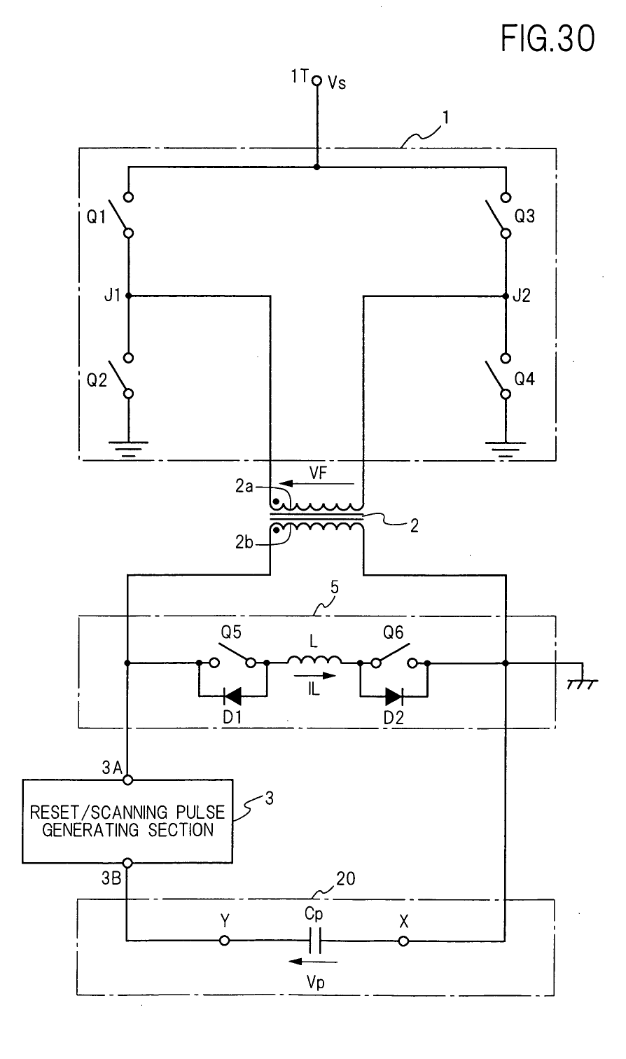

FIG. 30 is the equivalent circuit diagram of the sustaining pulse generating section 1, the transformer 2, the power recovery section 5, and the PDP 20. The power recovery section 5 has the circuitry similar to the circuitry of the power recovery section 4 according to Embodiment 4. See FIG. 13. However, the series connection of the two recovery switching devices Q5 and Q6 and the inductor L are connected in parallel to the secondary winding 2b of the transformer 2. Furthermore, the inductance of the inductor L is preferably smaller enough than the magnetizing inductance of the transformer 2. In FIG. 30, the components similar to the components shown in FIG. 13 are marked with the same reference symbols as the reference symbols shown in FIG. 13. Furthermore, for the details of those similar components, the explanation about Embodiments 1 and 4 is cited.

The control section 36 (cf. FIG. 29) performs the ON-OFF control over the main switching devices Q1-Q4 and the recovery switching devices Q5 and Q6, similarly to the control section 33 according to Embodiment 4 (cf. FIG. 12). Thereby, at every reversal of the polarity of the sustaining voltage pulse Vp, the inductor L of the power recovery section 5 resonates with the panel capacitance Cp of the PDP 20. The resonance reverses the polarity of the sustaining voltage pulse Vp with almost no dissipation. As a result, the reactive power caused by the charging and discharging of the panel capacitance Cp of the PDP 20 is reduced.

The PDP driver according to Embodiment 17 of the invention comprises the transformer 2 on the output side of the sustaining pulse generating section 1, similarly to the driver according to Embodiment 1. The transformer 2 produces the effects similar to those of the transformer 2 according to Embodiment 1.

The power recovery section 5 reduces the reactive power caused by the charging and discharging of the panel capacitance in the PDP driver according to Embodiment 17 of the invention, similarly to the PDP driver according to Embodiment 4. In particular, the resonance period of the inductor L and the panel capacitance Cp is reliably limited to the pulse rise and fall times of the sustain pulse voltage Vp.

The current caused by the above-described resonance does not actually flow through the secondary winding 2b of the transformer 2 in the PDP driver according to Embodiment 17 of the invention, in contrast to the driver according to Embodiment 4. Accordingly, no copper losses of the transformer 2 occur during the resonance period. Furthermore, the effective value of the current flowing through the transformer 2 is reduced, and thereby, the current capacities of the circuit devices of the pulse generating section 1 and the transformer 2 can be small. In addition, the iron loss of the transformer 2 is reduced by its miniaturization. Besides that, the withstand voltages of the recovery switching sections Q5 and Q6 are both reduced.

### EMBODIMENT 18

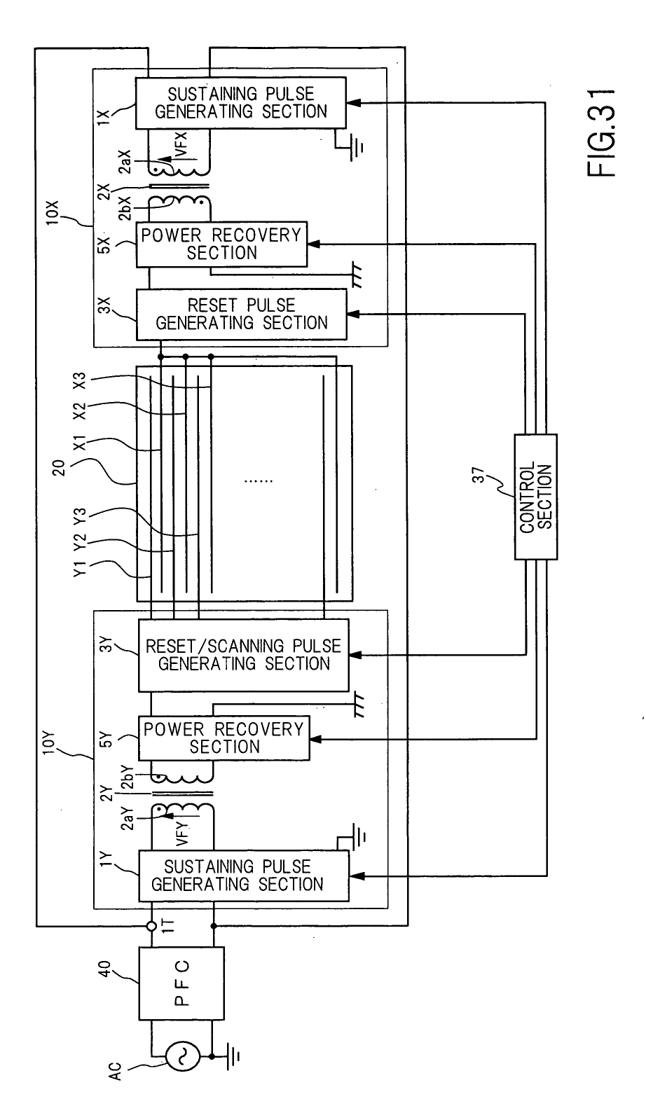

In the plasma display according to Embodiment 18 of the invention, the driver sections 10Y and 10X include power recovery sections 5Y and 5X on the secondary sides of the transformers 2Y and 2X, respectively, in contrast to the plasma display according to Embodiment 5. See FIG. 31. Except for that point, both the plasma displays have similar configuration. See FIG. 14. In FIG. 31, the components similar to the components shown in FIG. 14 are marked with the same reference symbols as the reference symbols shown in FIG. 14. Furthermore, for the details of the similar components, the explanation about Embodiment 5 is cited.

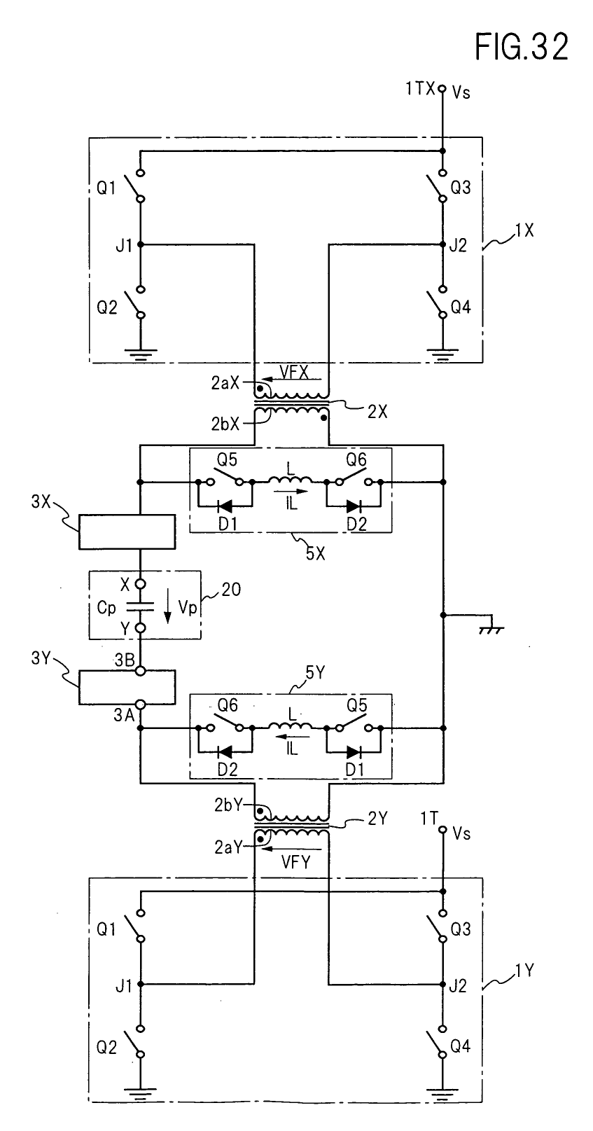

In the driver sections 10Y and 10X, the sustaining pulse generating sections 1Y and 1X, the transformers 2Y and 2X, and the power recovery sections 5Y and 5X are similar in circuitry to the sustaining pulse generating section 1, the transformer 2, and the power recovery section 5 according to Embodiment 17, respectively. See FIGS. 29-32. In particular, the characteristics of the circuit elements corresponding to each other are substantially equal. In FIG. 32, the components similar to the components shown in FIG. 30 are marked with the same reference symbols as the reference symbols shown in FIG. 30. Furthermore, for the details of the similar components, the explanation about Embodiment 5 and 17 is cited.

The reset/scanning pulse generating section 3Y has the circuitry in common with that of the reset/scanning pulse generating section 3 according to Embodiment 1. See FIGS. 3 and 4. Accordingly, for the details, the explanation about FIGS. 3 and 4 and Embodiment 1 is cited.

The reset generating section 3X has the circuitry in common with the reset generating section 3X according to Embodiment 2. See FIG. 7. Accordingly, for the details, the explanation about FIG. 7 and Embodiment 2 is cited.

The control section 37 (cf. FIG. 31) controls the switching operations of the two sustaining pulse generating sections 1Y and 1X, the reset/scanning pulse generating section 3Y, the reset pulse generating section 3X, and an address electrode driver section (not shown) under the ADS scheme, similarly to the control section 34 according to Embodiment 5 (cf. FIG. 14). During the sustain period, in particular, the control section 37 performs the ON-OFF control over the main switching devices Q1-Q4 and the recovery switching devices Q5 and Q6, similarly to the control section 34 according to Embodiment 5. Thereby, at every rise and fall of the sustaining voltage pulse Vp, the inductors L of the two power recovery sections 5Y and 5X resonate with the panel capacitance Cp of the PDP 20.

When the switching operations of the two sustaining pulse generating sections 1Y and 1X and the two power recovery sections 4Y and 4X are maintained in phase (or opposite phase, ) the inductors L of the two power recovery sections 5Y and 5X simultaneously resonate with the panel capacitance Cp of the PDP 20. When the predetermined phase difference (larger than 0° and smaller than 180°) are set between the switching operations of the two sustaining pulse generating sections 1Y and 1X and the two power recovery sections 4Y and 4X, the inductors L of the two power recovery sections 5Y and 5X alternately resonate with the panel capacitance Cp of the PDP 20. See FIG. 16. Any of the resonances reverses the polarity of the sustaining voltage pulse Vp with almost no dissipation. As a result, the reactive power caused by the charging and discharging of the panel capacitance Cp of the PDP 20 is reduced.

The PDP driver according to Embodiment 18 of the invention comprises the transformers 2Y and 2X on the output sides of the sustaining pulse generating sections 1Y and 1X, respectively, similarly to the driver according to Embodiment 1. Each of the transformers 2Y and 2X produces the effects similar to those of the transformer 2 according to Embodiment 1.

The two power recovery sections 5Y and 5X reduce the reactive power caused by the charging and discharging of the panel capacitance in the PDP driver according to Embodiment 18 of the invention, similarly to the PDP driver according to Embodiment 5. In particular, the resonance period of the inductor L and the panel capacitance Cp is reliably limited to the pulse rise and fall times of the sustain pulse voltage Vp.

When the switching operations of the sustaining pulse generating section 1Y and 1X and the power recovery sections 5Y and 5X are maintained in phase (or opposite phase), the current caused by the above-described resonance does not actually flow through any of the secondary windings 2bY and 2bX of the transformers 2Y and 2X in the PDP driver according to Embodiment 18 of the invention, in contrast to the driver according to Embodiment 5. Accordingly, no copper losses of the transformers 2Y and 2X occur during the resonance period. Furthermore, the effective values of the currents flowing through the transformers 2Y and 2X are reduced, and thereby, the current capacities of the circuit devices of the pulse generating sections 1Y and 1X and the transformers 2Y and 2X can be small. In addition, the iron losses of the transformers 2Y and 2X are reduced by their miniaturization. Besides that, the withstand voltages of the recovery switching sections Q5 and Q6 are both reduced.

### EMBODIMENT 19

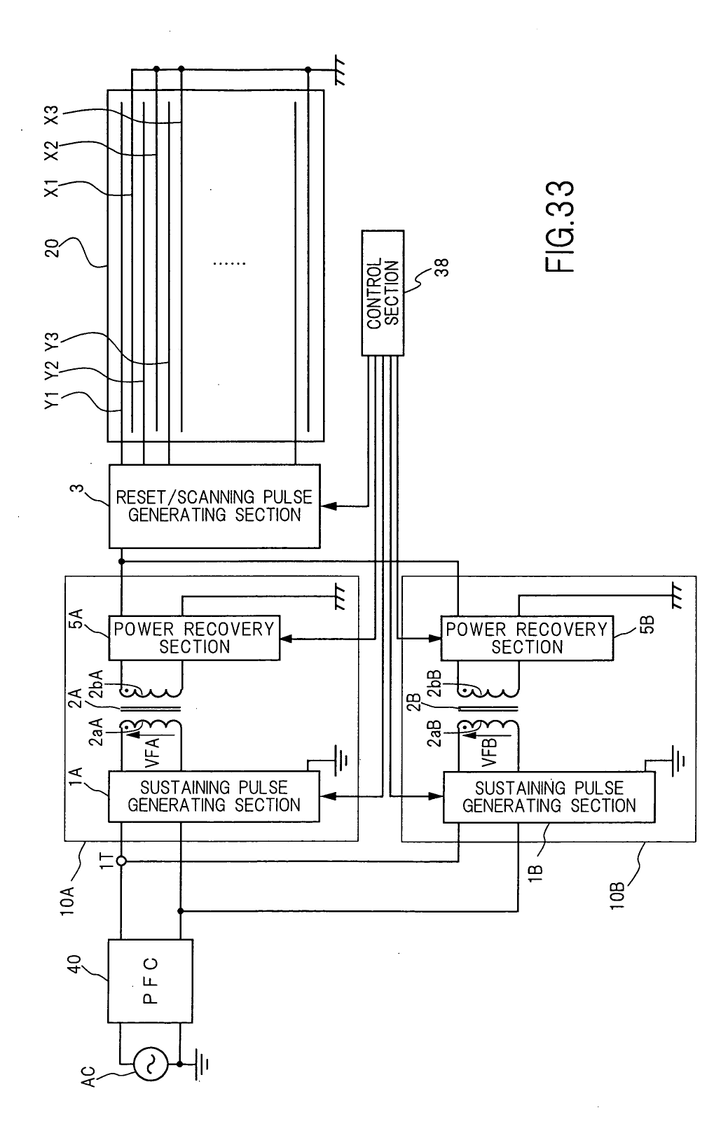

In the plasma display according to Embodiment 19 of the invention, the driver sections 10A and 10B include power recovery sections 5A and 5B on the secondary sides of the transformers 2A and 2B, respectively, in contrast to the plasma display according to Embodiment 6. See FIG. 33. Here, either of the power recovery sections 5A and 5B may be eliminated. Except for the positions of the power recovery sections, both the plasma displays have similar configuration. See FIG. 17. In FIG. 33, the components similar to the components shown in FIG. 17 are marked with the same reference symbols as the reference symbols shown in FIG. 17. Furthermore, for the details of the similar components, the explanation about Embodiment 6 is cited.

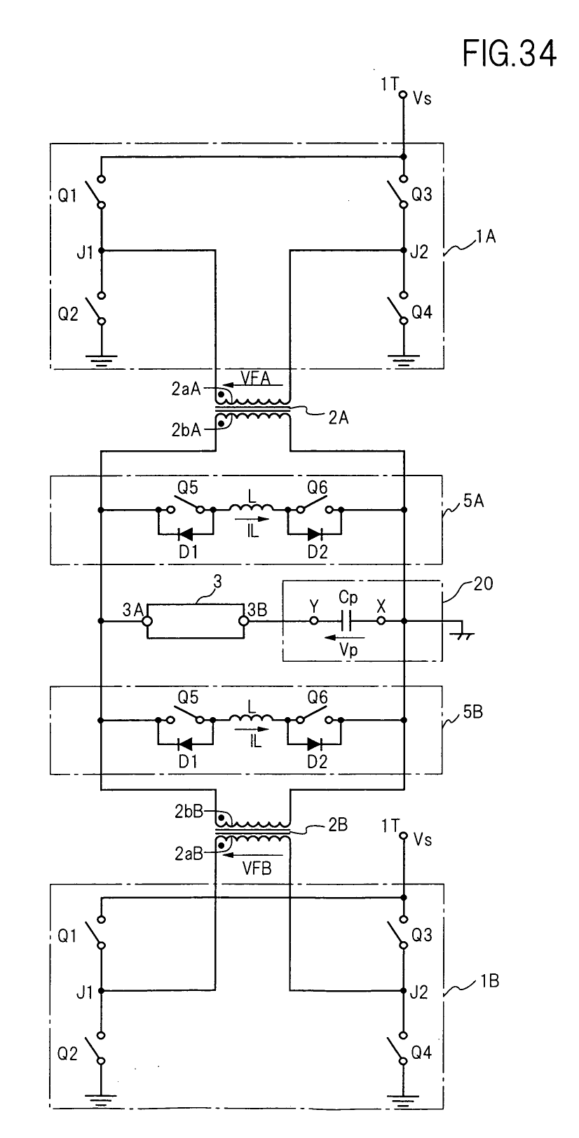

In the driver sections 10A and 10B, the sustaining pulse generating sections 1A and 1B, the transformers 2A and 2B, and the power recovery sections 5A and 5B are similar in circuitry to the sustaining pulse generating section 1, the transformer 2, and the power recovery section 5 according to Embodiment 17, respectively. See FIGS. 29, 30, 33, and 34. In particular, the characteristics of the circuit elements corresponding to each other are substantially equal. In FIG. 34, the components similar to the components shown in FIG. 30 are marked with the same reference symbols as the reference symbols shown in FIG. 30. Furthermore, for the details of the similar components, the explanation about Embodiment 6 and 17 is cited.

The reset/scanning pulse generating section 3 has the circuitry in common with that of the reset/scanning pulse generating section 3 according to Embodiment 1. See FIGS. 3 and 4. Accordingly, for the details, the explanation about FIGS. 3 and 4 and Embodiment 1 is cited.

The control section 38 (cf. FIG. 33) controls the switching operations of the two sustaining pulse generating sections 1A and 1B, the reset/scanning pulse generating section 3, and an address electrode driver section (not shown) under the ADS scheme, similarly to the control section 35 according to Embodiment 6 (cf. FIG. 17). During the sustain period, in particular, the control section 38 performs the ON-OFF control over the main switching devices Q1-Q4 and the recovery switching devices Q5 and Q6, similarly to the control section 35 according to Embodiment 6. Especially, the switching operations of the two sustaining pulse generating sections 1A and 1B and the two power recovery sections 4A and 4B are maintained in phase (or opposite phase). Thereby, the inductors L of the two power recovery sections 5A and 5B simultaneously resonate with the panel capacitance Cp of the PDP 20. The resonance reverses the polarity of the sustaining voltage pulse Vp with almost no dissipation. As a result, the reactive power caused by the charging and discharging of the panel capacitance Cp of the PDP 20 is reduced.

The PDP driver according to Embodiment 19 of the invention comprises the transformers 2A and 2B on the output sides of the sustaining pulse generating sections 1A and 1B, respectively, similarly to the driver according to Embodiment 1. Each of the transformers 2A and 2B produces the effects similar to those of the transformer 2 according to Embodiment 1.

The two power recovery sections 5A and 5B reduce the reactive power caused by the charging and discharging of the panel capacitance in the PDP driver according to Embodiment 19 of the invention, similarly to the PDP driver according to Embodiment 6. In particular, the resonance period of the inductor L and the panel capacitance Cp is reliably limited to the pulse rise and fall times of the sustain pulse voltage Vp.

The current caused by the above-described resonance does not actually flow through any of the secondary windings 2bA and 2bB of the transformers 2A and 2B in the PDP driver according to Embodiment 19 of the invention, in contrast to the driver according to Embodiment 6. That is similar when either of the power recovery sections 5A and 5B are eliminated, since the inductances of the inductors L are smaller enough than the magnetizing inductances of the transformers 2A and 2B. Accordingly, no copper losses occur in both of the transformers 2A and 2B in the resonance periods. Furthermore, the effective values of the currents flowing through the transformers 2A and 2B are reduced, and thereby, the current capacities of the circuit devices of the pulse generating sections 1A and 1B and the transformers 2A and 2B can be small. In addition, the iron losses of the transformers 2A and 2B are reduced by their miniaturization. Besides that, the withstand voltages of the recovery switching sections Q5 and Q6 are both reduced.

### EMBODIMENT 20

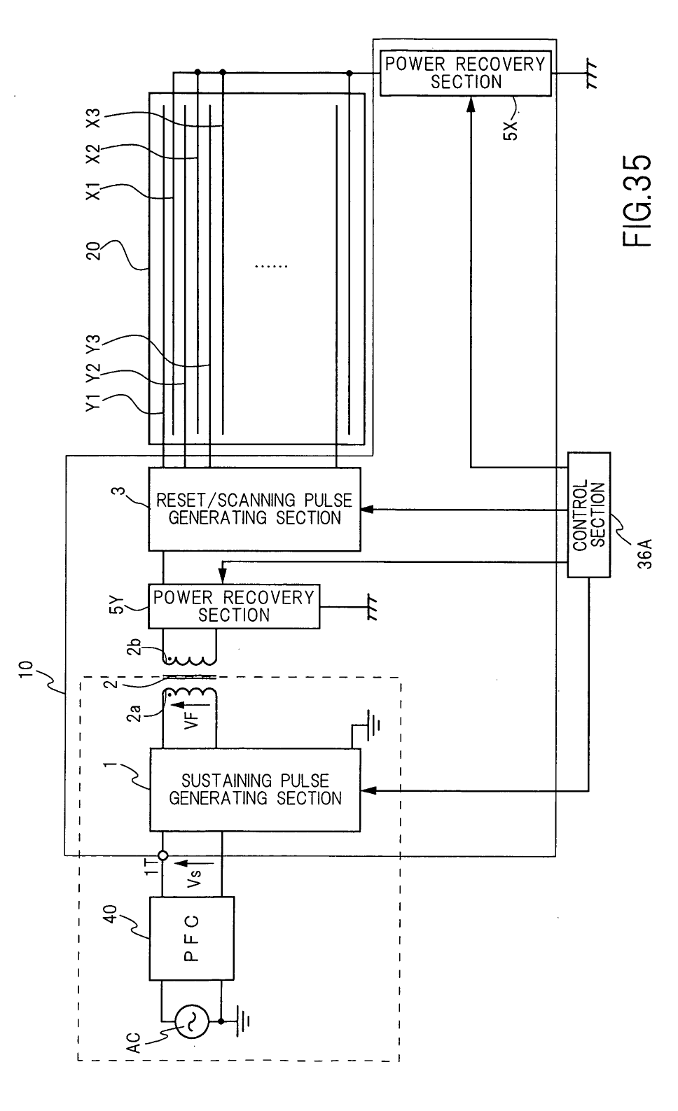

In the plasma display according to Embodiment 20 of the invention, the PDP driver 10 includes the two power recovery sections 5Y and 5X on the secondary side of the transformer 2, similarly to the plasma display according to Embodiment 17. See FIG. 35. Except for the circuitry of the power recovery sections 5Y and 5X, both the plasma displays have similar configuration. See FIG. 29.

The control section 36A controls the switching operations of the sustaining pulse generating section 1, the reset/scanning pulse generating section 3, and an address electrode driver section (not shown) under the ADS scheme, similarly to the control section 36 according to Embodiment 17.

In FIG. 35, the components similar to the components shown in FIG. 29 are marked with the same reference symbols as the reference symbols shown in FIG. 29. Furthermore, for the details of the similar components, the explanation about Embodiment 1 and 4 is cited.

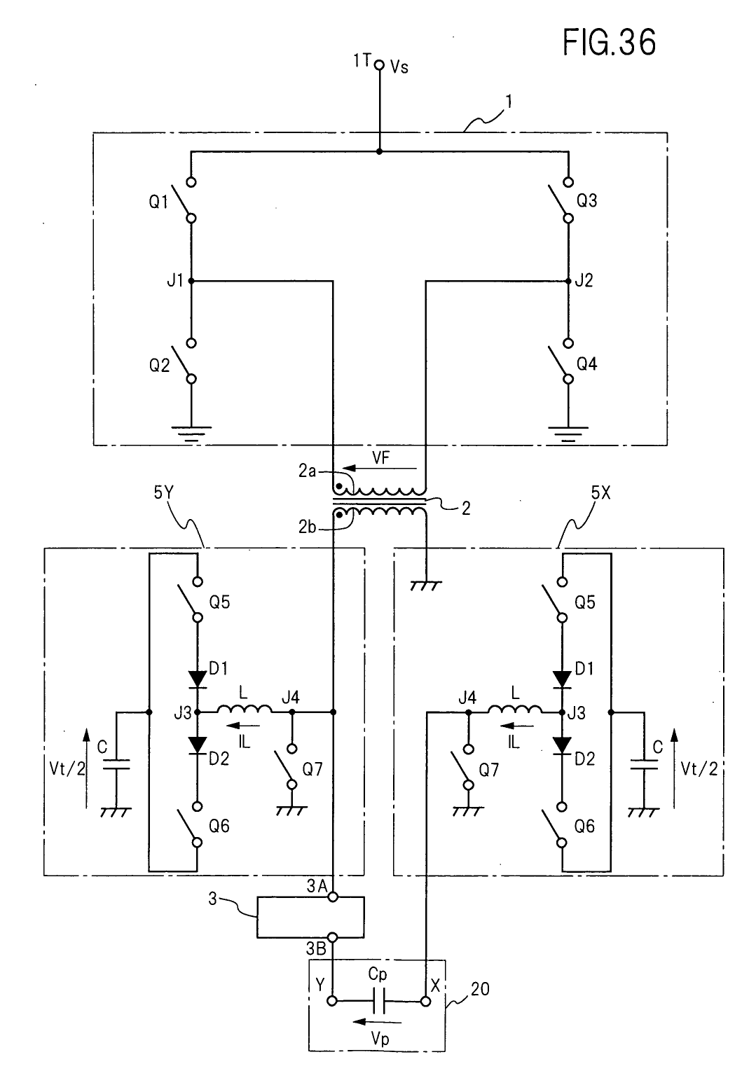

The power recovery section 5Y and 5X have the circuitry similar to the parts 4a and 4b of the power recovery section 4 according to Embodiment 7, respectively. See FIGS. 19 and 36. In FIG. 36, the components similar to the components shown in FIG. 19 are marked with the same reference symbols as the reference symbols shown in FIG. 19. Furthermore, for the details of the similar components, the explanation about Embodiment 1 and 7 is cited.

In the first power recovery section 5Y, one end J4 of the inductor L is connected to the scan electrodes Y1, Y2, Y3, . . . of the PDP 20 through the reset/scanning pulse generating section 3. In the second power recovery section 5X, one end J4 of the inductor L is connected to the sustain electrode X1, X2, X3, . . . of the PDP 20. The one end of the secondary winding 2b of the transformer 2 is connected to the scan electrodes Y1, Y2, Y3, . . . of the PDP 20 through the first power recovery section 5Y and the reset/scanning pulse generating section 3, and the other end of the secondary winding 2b is grounded. Alternatively, the one end of the secondary winding 2b of the transformer 2 may be connected to the sustain electrodes X1, X2, X3, . . . of the PDP 20 through a separation switch and the second power recovery section 5X, and the other end of the secondary winding 2b may be grounded.

In the power recovery section 5Y and 5X, the respective voltages across the capacitors C are maintained substantially equal to a half Vt/2 of the peak value Vt of the sustaining voltage pulse Vp, in contrast to the power recovery sections 4a and 4b according to Embodiment 7. See FIGS. 19 and 36. Here, the peak value Vt depends on the potential Vs of the input terminal 1T of the sustaining pulse generating section 1 and the winding ratio of the transformer 2. Furthermore, a ground switching device Q7 is connected between the node J4 of the inductor L and the scan electrode Y (or, the sustain electrode X) of the PDP 20 and the ground terminal. As that ground conductor, the ground conductor connected to the capacitor C, for example, the frame of the PDP 20 is used.

During the sustain period, the control section 36A controls the switching operations of the power recovery section 5Y and 5X similarly to the control section 33 according to Embodiment 7 (cf. FIG. 12). In other words, the control section 36A performs the ON-OFF control over the main switching devices Q1-Q4, the recovery switching devices Q5 and Q6, and the ground switching device Q7, thereby changing the polarity of the sustaining voltage pulse Vp from the positive to the negative as follows.

During the maintenance of the ON states of the first high-side main switching device Q1 and the second low-side main switching device Q4, the ground switching device Q7 maintains the ON state in the second power recovery section 5X. The other main switching devices Q2 and Q3, the recovery switching devices Q5 and Q6, and the other ground switching device Q7 maintain the OFF states. Thereby, the potential of the scan electrode Y, that is, the sustaining voltage pulse Vp is maintained at the positive peak value Vt. The sustain electrode X is maintained at the ground voltage. When discharges successively occur in the PDP 20, the power required for maintenance of the discharging current is supplied from the PFC converter 40 to the PDP 20 through the input terminal 1T and the transformer 2.

After that state is maintained for the predetermined time equivalent to the pulse width of the sustaining voltage pulse, the control section 36A turns off the first high-side main switching device Q1 and the second low-side main switching device Q4, and turns on the low-side recovery switching device Q6 of the first power recovery section 5Y. At the two main switching devices Q1 and Q4, the current is substantially equal to zero, and accordingly, no switching losses occur. A path is brought into conduction in the first power recovery section 5Y; the path includes the ground terminal the capacitor C the low-side recovery switching device Q6 the low-side diode D2 the inductor L the scan electrode Y of the PDP 20. The arrows represent the direction of the current. See FIG. 36. Here, the reset/scanning pulse generating section 3 short-circuits between its input and output terminals 3A and 3B. On the other hand, the sustain electrode X of the PDP 20 is grounded through the ground switching device Q7 of the second power recovery section 5X. Accordingly, the voltage Vt/2 across the capacitor C is applied across the panel capacitance Cp of the PDP 20. At that time, the inductor L resonates with the panel capacitance Cp. The resonance current IL flows through the above-described path in the directions of the arrows, and then, electricity is discharged from the panel capacitance Cp. Thereby, the potential of the scan electrode Y, that is, the sustaining pulse voltage Vp falls.

When the resonance current IL is reduced substantially to zero, the low-side diode D2 is turned off. At the same time, the sustaining pulse voltage Vp reaches zero. Then, the control section 36A turns off the low-side recovery switching device Q6 and turns on the ground switching device Q7. The voltage across the ground switching device Q7 is equal to zero, and accordingly, no switching losses occur. Thus, the sustaining voltage pulse Vp is clamped at zero.

The control section 36A next turns off the ground switching device Q7 and turns on the high-side recovery switching device Q5 of the second power recovery section 5X. The voltage across the ground switching device Q7 is equal to zero, and accordingly, no switching losses occur. A path is brought into conduction in the second power recovery section 5X; the path includes the sustain electrode X of the PDP 20 the inductor L the high-side diode D2 the high-side recovery switching device Q5 the capacitor C the ground terminal. The arrows represent the direction of the current. See FIG. 36. On the other hand, the scan electrode Y of the PDP 20 is grounded through the ground switching device Q7 of the first power recovery section 5Y. Accordingly, the voltage Vt/2 across the capacitor C is applied across the panel capacitance Cp of the PDP 20. At that time, the inductor L resonates with the panel capacitance Cp. The resonance current IL flows through the above-described path in the directions of the arrows, and electricity is charged into the panel capacitance Cp. Thereby, the potential of the sustain electrode X rises, and then, the sustaining pulse voltage Vp falls.

When the resonance current IL is reduced substantially to zero, the high-side diode D1 is turned off. At the same time, the sustaining pulse voltage Vp reaches its negative peak value −Vt. Then, the control section 36A turns off the high-side recovery switching device Q5 and turns on the ground switching device Q7 of the second power recovery section 5X. On the other hand, as for the first power recovery section 5Y, the control section 36A turns off the ground switching device Q7. Here, the resonance current IL is reduced substantially to zero, and accordingly, no switching losses occur. The control section 36A further turns on the first low-side main switching device Q2 and the second high-side main switching device Q3. Here, the voltage across each of the two main switching devices Q2 and Q3 is equal to zero, and accordingly, no switching losses occur. Thus, the sustaining voltage pulse Vp is clamped at its negative peak value. When discharges successively occur in the PDP 20, the power required for maintenance of the discharging current is supplied from the PFC converter 40 to the PDP 20 through the input terminal 1T and the transformer 2.

Similarly, the control section 36A changes the polarity of the sustaining pulse voltage Vp from the negative to the positive by the ON-OFF control over the main switching devices Q1-Q4, the recovery switching devices Q5 and Q6, and the ground switching device Q7.

Thus, at every rise and fall of the sustaining voltage pulse Vp, the inductors L of the power recovery sections 5Y and 5X alternately resonate with the panel capacitance Cp of the PDP 20, and the capacitors C of the power recovery sections 5Y and 5X efficiently exchange power with the panel capacitance Cp. As a result, the reactive power caused by the charging and discharging of the panel capacitance is reduced.

In the PDP driver according to Embodiment 20 of the invention as described above, the power recovery sections 5Y and 5X function similarly to the power recovery section 4 according to Embodiment 7, and thereby, produce the effects similar to those of Embodiment 17. In particular, the above-described resonance current does not flow through the secondary winding 2b of the transformer 2.

### EMBODIMENT 21

In the plasma display according to Embodiment 21 of the invention, the two secondary windings 2bY and 2bX of the transformers 2Y and 2X are connected in series to the panel capacitance Cp of the PDP 20, and the PDP driver includes the two power recovery sections 5Y and 5X on the secondary sides of the transformers 2Y and 2X, respectively, similarly to the plasma display according to Embodiment 18. See FIG. 31. Except for the circuitry of the power recovery sections 5Y and 5X, both of the plasma displays have similar configuration. For the details of the similar components, the explanation about Embodiment 18 is cited.

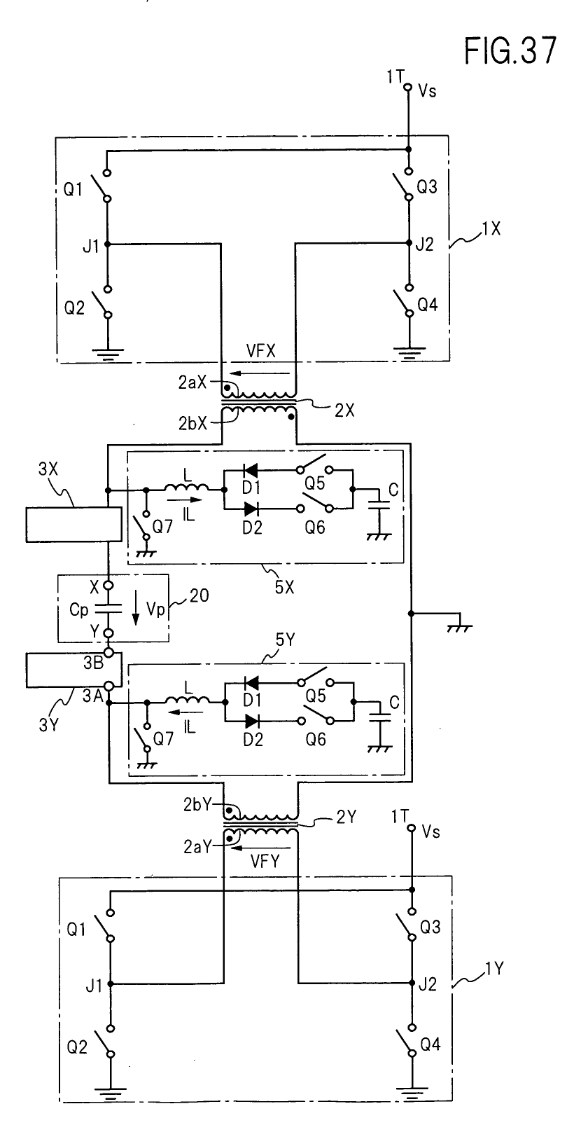

The power recovery sections 5Y and 5X comprise the circuitry similar to the power recovery sections 5Y and 5X according to Embodiment 20, respectively. See FIGS. 36 and 37. However, the second power recovery section 5X is connected to the sustain electrode X of the PDP 20 through (the separation switching device QS6 of) the reset pulse generating section 3X (cf. FIG. 7). In FIG. 37, the components similar to the components shown in FIGS. 32 and 36 are marked with the same reference symbols as the reference symbols shown in FIGS. 32 and 36. Furthermore, for the details of the similar components, the explanation about Embodiment 18 and 20 is cited.

The secondary windings 2bY and 2bX of the two transformers 2Y and 2X are connected to each other, for example, with opposite polarities as shown in FIG. 37. In that case, the control section 37 maintains the switching operations of the two sustaining pulse generating sections 1Y and 1X substantially in phase.

Aside from the example shown in FIG. 37, the secondary windings 2bY and 2bX of the two transformers 2Y and 2X may be connected to each other with the same polarity. In that case, the control section 37 maintains the switching operations of the two sustaining pulse generating sections 1Y and 1X substantially in opposite phase.

The control section 37 further makes the switching operations of the power recovery sections 5Y and 5X coincide with the switching operations of the power recovery sections 5Y and 5X according to Embodiment 20. Thereby, at every rise and fall of the sustaining pulse voltage Vp, the inductors L of the power recovery sections 5Y and 5X alternately resonate with the panel capacitance Cp of the PDP 20, and accordingly, power is efficiently exchanged between the panel capacitance Cp and the capacitors C of the power recovery sections 5Y and 5X. As a result, the reactive power caused by the charging and discharging of the panel capacitance is reduced.

Aside from the above-described switching control, the control section 37 may set a predetermined phase difference (larger than 0° and smaller than 180°) between the switching operations of the two sustaining pulse generating sections 1Y and 1X and the two ground switching devices Q7. See FIG. 16. In such a case, the inductors L of the two power recovery sections 5Y and 5X alternately resonate with the panel capacitance Cp of the PDP 20 at every rise and fall of the sustaining pulse voltage Vp. Power is efficiently exchanged between the panel capacitance Cp and the two capacitors C due to the resonances. As a result, the reactive power caused by the charging and discharging of the panel capacitance Cp is reduced.

In the PDP driver according to Embodiment 21 of the invention as described above, the power recovery sections function and produce the effects, similarly to the power recovery sections according to Embodiment 18. Especially when the switching operations of the two sustaining pulse generating sections 1Y and 1X and the two power recovery sections 5Y and 5X are maintained in phase (or opposite phase), the above-described resonance current does not flow through any of the secondary windings 2bY and 2bX of the two transformers 2Y and 2X.

### EMBODIMENT 22

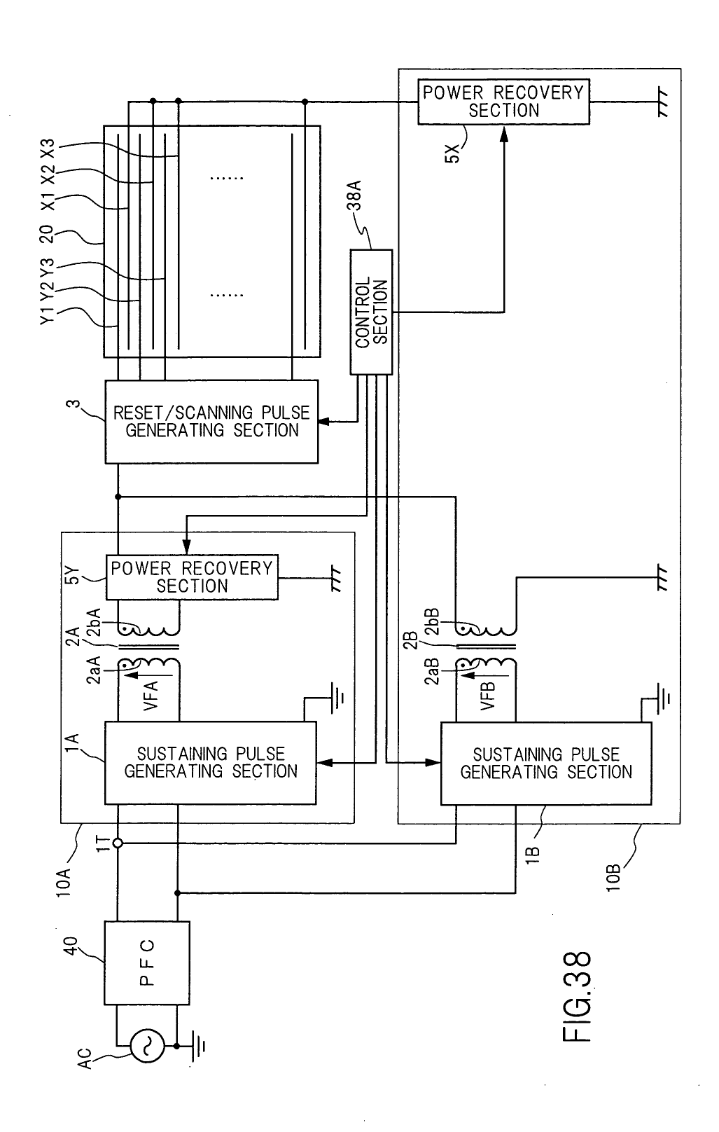

In the plasma display according to Embodiment 22 of the invention, the two secondary windings 2bA and 2bB of the transformers 2A and 2B are connected in parallel to the panel capacitance Cp of the PDP 20, and the PDP driver 10 includes the two power recovery sections 5Y and 5X on the secondary sides of the transformers 2A and 2B, respectively, similarly to the plasma display according to Embodiment 19. See FIG. 38. Except for the circuitry of the power recovery sections 5Y and 5X, both of the plasma displays have similar configuration. See FIG. 33.

The control section 38A controls the switching operations of the two sustaining pulse generating sections 1A and 1B, the reset/scanning pulse generating section 3, and an address electrode driver section (not shown) under the ADS scheme, similarly to the control section 38 according to Embodiment 19. In FIG. 38, the components similar to the components shown in FIG. 33 are marked with the same reference symbols as the reference symbols shown in FIG. 38. Furthermore, for the details of the similar components, the explanation about Embodiment 19 is cited.

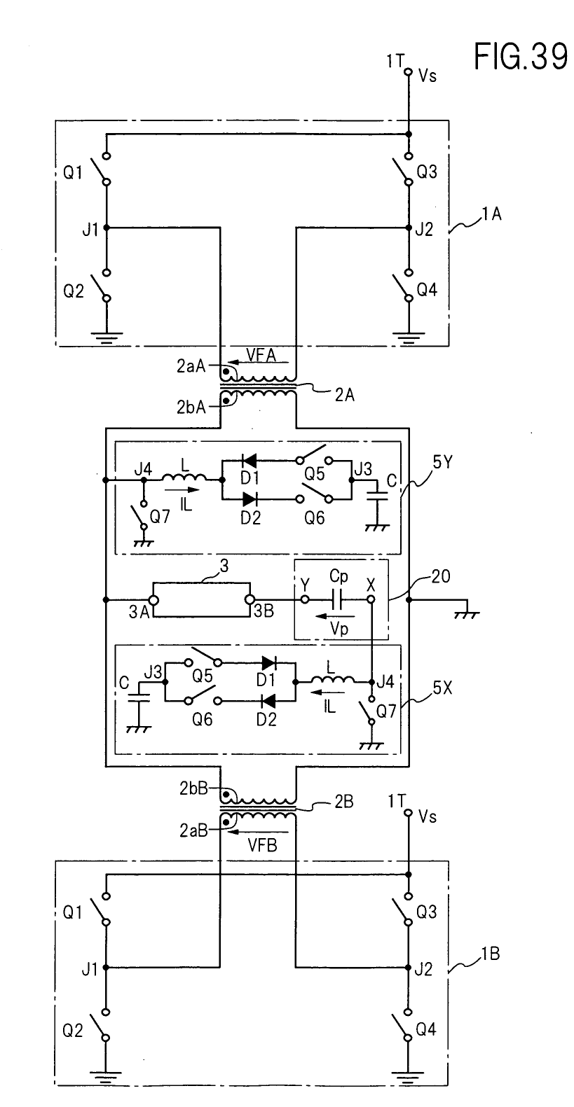

The power recovery sections 5Y and 5X comprise the circuitry similar to the power recovery sections 5Y and 5X according to Embodiment 20, respectively. See FIGS. 36 and 39. In FIG. 39, the components similar to the components shown in FIGS. 34 and 36 are marked with the same reference symbols as the reference symbols shown in FIGS. 34 and 36. Furthermore, for the details of the similar components, the explanation about Embodiment 19 and 20 is cited.

The secondary windings 2bY and 2bX of the two transformers 2Y and 2X are connected to each other, for example, with the same polarity as shown in FIG. 39. In that case, the control section 38A maintains the switching operations of the two sustaining pulse generating sections 1A and 1B and the switching operations of the two power recovery sections 5Y and 5X substantially in phase.

Aside from the example shown in FIG. 39, the secondary windings 2bA and 2bB of the two transformers 2A and 2B may be connected to each other with the opposite polarities. In that case, the control section 38A maintains the switching operations of the two sustaining pulse generating sections 1A and 1B substantially in opposite phase.

The control section 38A further makes the switching operations of the power recovery sections 5Y and 5X coincide with the switching operations of the power recovery sections 5Y and 5X according to Embodiment 20. Thereby, at every rise and fall of the sustaining pulse voltage Vp, the inductors L of the power recovery sections 5Y and 5X alternately resonate with the panel capacitance Cp of the PDP 20, and accordingly, power is efficiently exchanged between the panel capacitance Cp and the capacitors C of the power recovery sections 5Y and 5X. As a result, the reactive power caused by the charging and discharging of the panel capacitance Cp is reduced.

In the PDP driver according to Embodiment 22 of the invention as described above, the power recovery sections function and produce the effects, similarly to the power recovery sections according to Embodiment 19. In particular, the above-described resonance current does not flow through any of the secondary windings 2bY and 2bX of the two transformers 2Y and 2X.

### EMBODIMENT 23

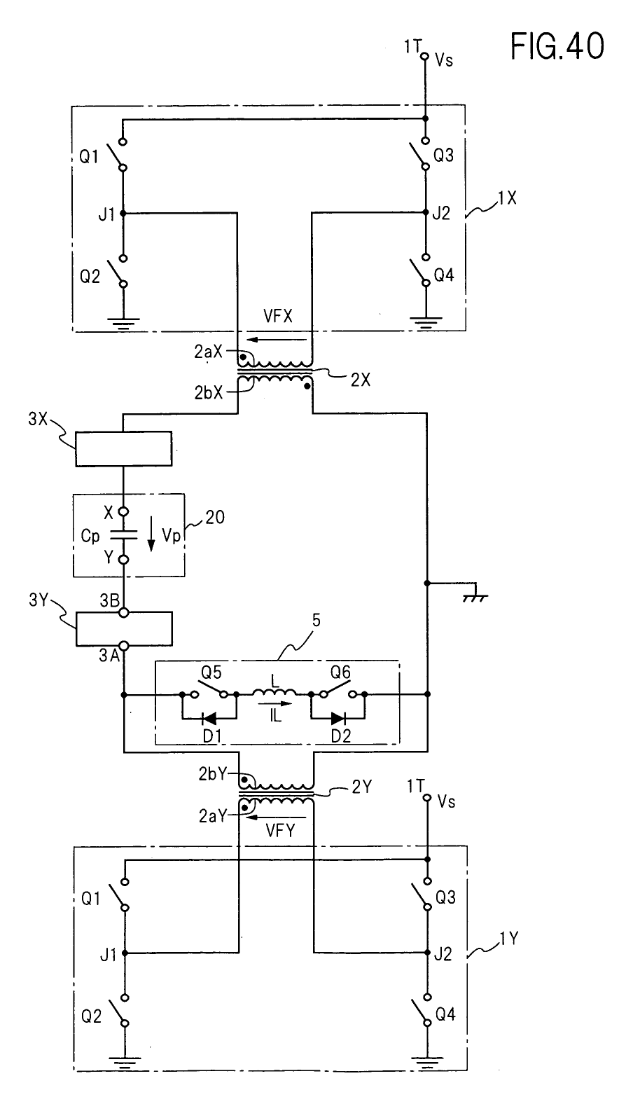

In the PDP driver according to Embodiment 18 of the invention, the secondary windings 2bY and 2bX of the two transformers 2Y and 2X are connected in series to the panel capacitance Cp of the PDP 20. See FIGS. 31 and 32. In this configuration, either of the driver sections may be required to include no power recovery section, for example, as follows. See FIG. 40. There by, the component count reduces, and the area for mounting is shrunk.

The first driver section 10Y includes a power recovery section 5 on the secondary side of the first transformer 2Y. On the other hand, the second driver section 10X includes no power recovery section. The power recovery section 5 is similar in circuitry to, for example, the power recovery section 5 according to Embodiment 17. See FIG. 30.

In FIG. 40, the components similar to the components shown in FIG. 32 are marked with the same reference symbols as the reference symbols shown in FIG. 32. Furthermore, for the details of the similar components, the explanation about Embodiment 18 is cited.

The control section 37 (cf. FIG. 31) sets a predetermined phase difference (larger than 0° and smaller than 180°) between the switching operations of the two sustaining pulse generating sections 1Y and 1X, similarly to the control section 34 according to Embodiment 15. Thereby, at every rise and fall of the sustaining pulse voltage Vp, the inductor L of the power recovery section 5 resonates with the panel capacitance Cp of the PDP 20, similarly to that according to Embodiment 15. Power is efficiently exchanged between the panel capacitance Cp and the inductor L due to that resonance. As a result, the reactive power caused by the charging and discharging of the panel capacitance Cp is reduced.

In the PDP driver according to Embodiment 23 of the invention as described above, the single power recovery section 5 functions and produces the effects similarly to the two power recovery sections 5Y and 5X according to Embodiment 18.

### EMBODIMENT 24

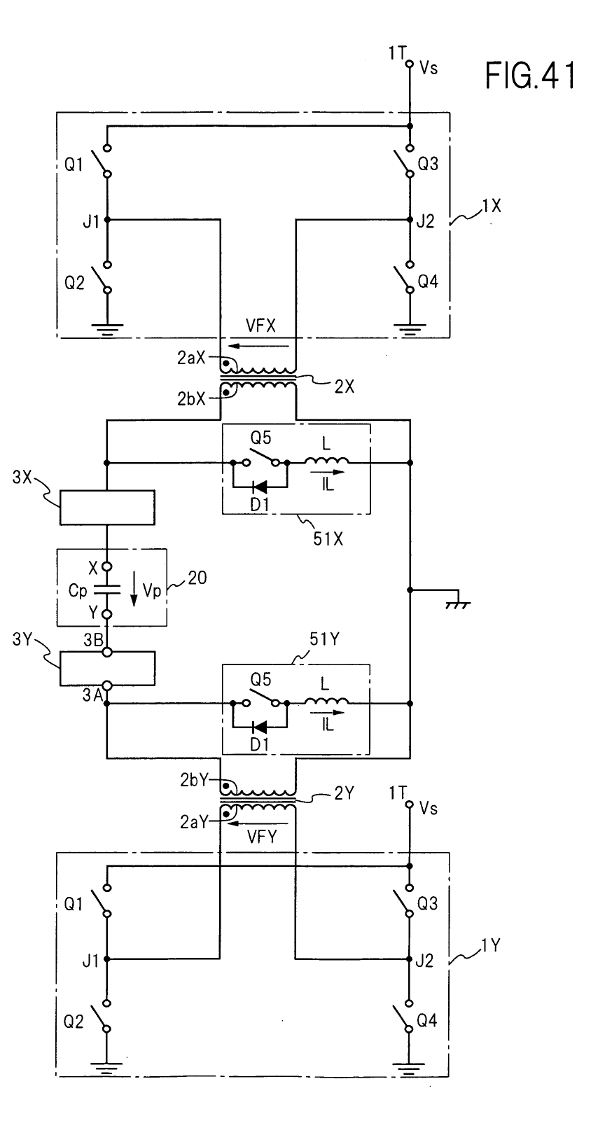

In the PDP driver according to Embodiment 18 of the invention, the secondary windings 2bY and 2bX of the two transformers 2Y and 2X are connected in series to the panel capacitance Cp of the PDP 20. See FIGS. 31 and 32. Furthermore, the power recovery sections 5Y and 5X each include the two recovery switching devices Q5 and Q6, from which a two-way switch is constructed. In this configuration, the power recovery section may include a one-way switch, and thereby, a current may be allowed to flow through the inductor L only in one direction, for example, as follows. See FIG. 41. Thereby, the component counts are reduced, and then, the area for mounting is shrunk.

Each of power recovery sections 51Y and 51X is, for example, the equivalent of the power recovery sections 5Y and 5X according to Embodiment 18 except for the substitution of the one-way switch Q5 and D1 for the two-way switch Q5, Q6, D1, and D2. See FIGS. 32 and 41. In other words, each of the power recovery sections 51Y and 51X include only one parallel connection of the recovery switching device Q5 and the diode D1. The parallel connection is connected in series to the inductor L. Thereby, the recovery switching device Q5 can cut off the current only in the reverse bias direction of the diode D1.

In FIG. 41, the components similar to the components shown in FIG. 32 are marked with the same reference symbols as the reference symbols shown in FIG. 32. Furthermore, for the details of the similar components, the explanation about Embodiment 18 is cited.

The control section 37 (cf. FIG. 31) sets a predetermined phase difference (larger than 0° and smaller than 180°) between the switching operations of the two sustaining pulse generating sections 1Y and 1X. Thereby, the inductors L of the two power recovery sections 5Y and 5X alternately resonate with the panel capacitance Cp of the PDP 20 at every rise and fall of the sustaining pulse voltage Vp, similarly to that according to Embodiment 16. Power is efficiently exchanged between the panel capacitance Cp and the inductors L due to the resonances. As a result, the reactive power caused by the charging and discharging of the panel capacitance Cp is reduced. In the resonances, in particular, the resonance currents IL flow through the inductors L only in one direction.

In the PDP driver according to Embodiment 24 of the invention as described above, the two power recovery sections 51Y and 51X function and produce the effects similarly to the two power recovery sections 5Y and 5X according to Embodiment 18.

The above-described disclosure of the invention in terms of the presently preferred embodiments is not to be interpreted as intended for limiting. Various alterations and modifications will no doubt become apparent to those skilled in the art to which the invention pertains, after having read the disclosure. As a corollary to that, such alterations and modifications apparently fall within the true spirit and scope of the invention. Furthermore, it is to be understood that the appended claims be intended as covering the alterations and modifications.

As described above, the present invention relates to the driver of a capacitive load such as a PDP, and provides a transformer on the output side of the pulse generating section, and thereby, can eliminate DC-DC converters from the input side of the pulse generating section. As such, the invention obviously has industrial applicability.

1. A capacitive load driver that is a device for applying a pulse of a predetermined voltage across a capacitive load, and comprises:
a pulse generating section including a switching device and converting a predetermined DC voltage into a primary voltage pulse by the switching operation of said switching device; and
a transformer including a primary winding connected to said pulse generating section and a secondary winding connected to said capacitive load, and converting said primary voltage pulse into said voltage pulse and causing its magnetizing inductance to resonate with said capacitive load.

2. A capacitive load driver according to claim 1 wherein the magnetizing inductance of said transformer resonates with said capacitive load during the pulse rise and fall times of said voltage pulse or said primary voltage pulse.

3. A capacitive load driver according to claim 1 comprising first and second driver sections each including said pulse generating section and said transformer.

4. A capacitive load driver according to claim 3 comprising a control section holding the switching operations of said first and second driver sections in phase or opposite phase.

5. A capacitive load driver according to claim 3 comprising a control section setting a phase difference between the switching operations of said first and second driver sections within the range from 0° to 180°, when said secondary winding of said transformer is connected to said capacitive load in series.

6. A capacitive load driver according to claim 1 wherein said switching device of said pulse generating section is a wide band-gap semiconductor switching device.

7. A capacitive load driver according to claim 1 wherein said pulse generating section regenerates electric power in the source of said DC voltage by the switching operation of said switching device.

8. A capacitive load driver according to claim 1 wherein said pulse generating section includes high-side and low-side switching devices which are used as said switching devices, said high-side and low-side switching devices are connected in series to each other; and
the primary winding of said transformer is connected to the node of said high-side and low-side switching devices.

9. A capacitive load driver according to claim 8 wherein one of said high-side and low-side switching devices is turned on and allows a regenerating current to flow into the source of said DC voltage at the end of the application of said voltage pulse.

10. A capacitive load driver that is a device for applying a pulse of a predetermined voltage across a capacitive load, and comprises:
a pulse generating section including a switching device and converting a predetermined DC voltage into a primary voltage pulse by the switching operation of said switching device;
a transformer including a primary winding connected to said pulse generating section and a secondary winding connected to said capacitive load, and converting said primary voltage pulse into said voltage pulse; and
an auxiliary inductor that is connected in parallel with said secondary winding of said transformer and resonates with said capacitive load.

11. A capacitive load driver according to claim 10 wherein said auxiliary inductor resonates with said capacitive load during the pulse rise and fall times of said voltage pulse or said primary voltage pulse.

12. A capacitive load driver according to claim 10 wherein the inductance of said auxiliary inductor is smaller than the magnetizing inductance of said transformer.

13. A capacitive load driver according to claim 10 comprising a first driver section including said pulse generating section, said transformer, and said auxiliary inductor; and
a second driver section including said pulse generating section and said transformer.

14. A capacitive load driver according to claim 13 wherein said second driver comprises said auxiliary inductor.

15. A capacitive load driver according to claim 13 comprising a control section holding the switching operations of said first and second driver sections in phase or opposite phase.

16. A capacitive load driver according to claim 3 comprising a control section setting a phase difference between the switching operations of said first and second driver sections within the range from 0° to 180°, when said secondary winding of said transformer is connected to said capacitive load in series.

17. A capacitive load driver according to claim 10 wherein said switching device of said pulse generating section is a wide band-gap semiconductor switching device.

18. A capacitive load driver according to claim 10 wherein said pulse generating section regenerates electric power in the source of said DC voltage by the switching operation of said switching device.

19. A capacitive load driver according to claim 10 wherein said pulse generating section includes high-side and low-side switching devices which are used as said switching devices, said high-side and low-side switching devices are connected in series to each other; and
the primary winding of said transformer is connected to the node of said high-side and low-side switching devices.

20. A capacitive load driver according to claim 19 wherein one of said high-side and low-side switching devices is turned on and allows a regenerating current to flow into the source of said DC voltage at the end of the application of said voltage pulse.

21. A capacitive load driver that is a device for applying a pulse of a predetermined voltage across a capacitive load, and comprises:
a pulse generating section including a switching device and converting a predetermined DC voltage into a primary voltage pulse by the switching operation of said switching device;
a power recovery section including an inductor and a switching section that passes a current caused by the resonance between said inductor and said capacitive load during its ON time; and
a transformer including a primary winding connected to said pulse generating section and a secondary winding connected to said capacitive load, and converting said primary voltage pulse into said voltage pulse.

22. A capacitive load driver according to claim 21 wherein said power recovery section is connected to said primary winding of said transformer.

23. A capacitive load driver according to claim 21 wherein said power recovery section is connected to said secondary winding of said transformer.

24. A capacitive load driver according to claim 21 wherein said switching section makes its ON times coincide with the pulse rise and fall times of said voltage pulse or said primary voltage pulse.

25. A capacitive load driver according to claim 21 wherein said inductor and said switching section are connected in series to each other in said power recovery section.

26. A capacitive load driver according to claim 21 comprising a first driver section including said pulse generating section, said power recovery section, and said transformer; and
a second driver section including said pulse generating section and said transformer.

27. A capacitive load driver according to claim 26 wherein said second driver comprises said power recovery section.

28. A capacitive load driver according to claim 26 comprising a control section holding the switching operations of said first and second driver sections in phase or opposite phase.

29. A capacitive load driver according to claim 26 comprising a control section setting a phase difference between the switching operations of said first and second driver sections within the range from 0° to 180°, when said secondary winding of said transformer is connected to said capacitive load in series.

30. A capacitive load driver according to claim 29 wherein said switching section of said power recovery section allows the current caused by said resonance to flow in one direction.

31. A capacitive load driver according to claim 21 wherein said switching device of said pulse generating section is a wide band-gap semiconductor switching device.

32. A capacitive load driver according to claim 21 wherein said pulse generating section includes high-side and low-side switching devices which are used as said switching devices, said high-side and low-side switching devices are connected in series to each other; and
the primary winding of said transformer is connected to the node of said high-side and low-side switching devices.

33. A plasma display comprising
a rectifier section converting an alternating voltage from an external power supply into a predetermined DC voltage;
a plasma display panel (PDP) driver converting said DC voltage into a pulse of a predetermined voltage; and
a PDP including a discharge cell emitting light by electric discharge of gas with which said discharge cell is filled, and a plurality of electrodes applying said voltage pulse across said discharge cell;
said PDP driver including
a pulse generating section including a switching device and converting said DC voltage into a primary voltage pulse by the switching operation of said switching device; and
a transformer including a primary winding connected to said pulse generating section and a secondary winding connected to said electrodes of said PDP, and converting said primary voltage pulse into said voltage pulse and causing its magnetizing inductance to resonate with the capacitance between said electrodes.

34. A plasma display comprising
a rectifier section converting an alternating voltage from an external power supply into a predetermined DC voltage;
a PDP driver converting said DC voltage into a pulse of a predetermined voltage; and
a PDP including a discharge cell emitting light by electric discharge of gas with which said discharge cell is filled, and a plurality of electrodes applying said voltage pulse across said discharge cell;
said PDP driver including
a pulse generating section including a switching device and converting said DC voltage into a primary voltage pulse by the switching operation of said switching device;
a transformer including a primary winding connected to said pulse generating section and a secondary winding connected to said electrodes of said PDP, and converting said primary voltage pulse into said voltage pulse; and
an auxiliary inductor that is connected in parallel with the said secondary winding of said transformer and resonates with the capacitance between said electrodes.

35. A plasma display comprising
a rectifier section converting an alternating voltage from an external power supply into a predetermined DC voltage;
a PDP driver converting said DC voltage into a pulse of a predetermined voltage; and
a PDP including a discharge cell emitting light by electric discharge of gas with which said discharge cell is filled, and a plurality of electrodes applying said voltage pulse across said discharge cell;
said PDP driver including
a pulse generating section including a switching device and converting said DC voltage into a primary voltage pulse by the switching operation of said switching device;
an power recovery section including an inductor and a switching section that passes a current caused by the resonance between said inductor and the capacitance between said electrodes of said PDP during its ON time; and
a transformer including a primary winding connected to said pulse generating section and a secondary winding connected to said electrodes of said PDP, and converting said primary voltage pulse into said voltage pulse.
